(19) United States
(12) Patent Application Publication
(10) Pub. No.: US 2025/0172789 A1
(43) Pub. Date: May 29, 2025

(54) IMAGING LENS AND IMAGING APPARATUS

(71) Applicant: FUJIFILM Corporation, Tokyo (JP)

(72) Inventors: Masato KONDO, Saitama (JP); Hiroki SAITO, Saitama (JP)

(73) Assignee: FUJIFILM Corporation, Tokyo (JP)

(21) Appl. No.: 18/951,540

(22) Filed: Nov. 18, 2024

(30) Foreign Application Priority Data
Nov. 28, 2023 (JP) 2023-200988

(51) Int. Cl. G02B 13/00

(52) U.S. Cl. CPC G02B 13/0045

(57) ABSTRACT

An imaging lens consists of, in order from an object side to an image side, a front group, a stop, and a rear group. The rear group includes at least one aspherical lens that has a concave surface facing the image side in a paraxial region and that has, on a lens surface on the image side, an inflection point at which a convex or concave shape changes. The imaging lens satisfies a conditional expression: 0.3<Bf/(f×tan ωm)<1.5 related to a back focus Bf of an entire system, a focal length f of the entire system, and a maximum half angle of view ωm. The imaging lens includes at least one lens satisfying a conditional expression: 0<|dN/dT|<15 related to a temperature coefficient (dN/dT)×10⁻⁶ of a refractive index of a lens.

### CROSS-REFERENCE TO RELATED APPLICATIONS

This application claims priority from Japanese Patent Application No. 2023-200988, filed on Nov. 28, 2023, the entire disclosure of which is incorporated herein by reference.

### BACKGROUND

### Technical Field

The disclosed technology relates to an imaging lens and an imaging apparatus.

### Related Art

In the related art, an imaging optical system according to JP2022-099402A has been known as an imaging lens usable in an imaging apparatus such as a digital camera.

### SUMMARY

There has been a demand for an imaging lens that is configured to be reduced in size and that maintains favorable optical performance. A level of such a demand is increasing every year.

An object of the present disclosure is to provide an imaging lens that is configured to be reduced in size and that maintains favorable optical performance, and an imaging apparatus comprising the imaging lens.

According to a first aspect of the present disclosure, there is provided an imaging lens consisting of, in order from an object side to an image side, a front group including one or more lenses, a stop, and a rear group including a plurality of lenses, in which the rear group includes at least one first aspherical lens that has a concave surface facing the image side in a paraxial region and that has, on a lens surface on the image side, an inflection point at which a convex or concave shape changes, and the imaging lens satisfies Conditional Expression (1) represented by

$$0.3 < Bf / ( f \times tan ω m ) < 1.5 \qquad ( 1 )$$

and includes at least one lens satisfying Conditional Expression (2) represented by

$$0 < \vert dN / dT \vert < 15. \qquad ( 2 )$$

A back focus of an entire system as an air conversion distance in a state where an infinite distance object is in focus is denoted by Bf. A focal length of the entire system in the state where the infinite distance object is in focus is denoted by f. A maximum half angle of view in the state where the infinite distance object is in focus is denoted by ωm. A temperature coefficient of a refractive index with respect to a d line at 25° C. for a lens included in the entire system is denoted by (dN/dT)×10⁻⁶. Here, dN/dT is in units of ° C.⁻¹.

According to a second aspect of the present disclosure, in the imaging lens of the first aspect, in a case where a sum of Bf and a distance on the optical axis from a lens surface of the front group closest to the object side to a lens surface of the rear group closest to the image side in the state where the infinite distance object is in focus is denoted by TL, Conditional Expression (3) is satisfied, which is represented by

$$1 \text{.1} < TL / f < 3.5 . \qquad ( 3 )$$

According to a third aspect of the present disclosure, in the imaging lens of the second aspect, Conditional Expression (3-1) is satisfied, which is represented by

$$1.2 < TL / f < 3. \qquad ( 3 - 1 )$$

According to a fourth aspect of the present disclosure, in the imaging lens of the first aspect, Conditional Expression (1-1) is satisfied, which is represented by

$$0.36 < Bf / ( f \times tan ω m ) < 1.2 . \qquad ( 1 - 1 )$$

According to a fifth aspect of the present disclosure, in the imaging lens of the first aspect, in a case where an open F-number in the state where the infinite distance object is in focus is denoted by Fno, Conditional Expression (4) is satisfied, which is represented by

$$1.6 < Fno / tan ω m < 5. \qquad ( 4 )$$

According to a sixth aspect of the present disclosure, in the imaging lens of the fifth aspect, Conditional Expression (4-1) is satisfied, which is represented by

$$2 < Fno / tan ωm < 3.2 . \qquad ( 4 - 1 )$$

According to a seventh aspect of the present disclosure, in the imaging lens of the first aspect, Conditional Expressions (5) and (6) are satisfied, which are represented by

$$0 < d FSt / TL < 0.8 \qquad ( 5 )$$

$$0 < dStR / TL < 0.8 . \qquad ( 6 )$$

A minimum value of a distance on the optical axis from a lens surface of the front group closest to the image side to the stop is denoted by dFSt. A sign of dFSt is positive in a case where the stop is closer to the image side than the lens surface of the front group closest to the image side, and is negative in a case where the stop is closer to the object side than the lens surface of the front group closest to the image side. A minimum value of a distance on the optical axis from the stop to a lens surface of the rear group closest to the object side is denoted by dStR. A sign of dStR is positive in a case where the lens surface of the rear group closest to the object side is closer to the image side than the stop, and is negative in a case where the lens surface of the rear group closest to the object side is closer to the object side than the stop. A sum of Bf and a distance on the optical axis from a lens surface of the front group closest to the object side to a lens surface of the rear group closest to the image side in the state where the infinite distance object is in focus is denoted by TL.

According to an eighth aspect of the present disclosure, in the imaging lens of the first aspect, Conditional Expression (7) is satisfied, which is represented by

$$0.67 < dSt / TL < 0 \text{.93} . \qquad ( 7 )$$

A sum of Bf and a distance on the optical axis from the stop to a lens surface of the rear group closest to the image side in the state where the infinite distance object is in focus is denoted by dSt. A sum of Bf and a distance on the optical axis from a lens surface of the front group closest to the object side to the lens surface of the rear group closest to the image side in the state where the infinite distance object is in focus is denoted by TL.

According to a ninth aspect of the present disclosure, in the imaging lens of the first aspect, in a case where a paraxial curvature radius of a surface, on the object side, of a lens closest to the object side in the front group is denoted by RL1f, and a paraxial curvature radius of a surface, on the image side, of the lens closest to the object side in the front group is denoted by RL1r, Conditional Expression (8) is satisfied, which is represented by

$$- 3 < ( RL 1 r - RL 1 f ) / ( RL 1 r + RL 1 f ) < 0. \qquad ( 8 )$$

According to a tenth aspect of the present disclosure, in the imaging lens of the first aspect, Conditional Expression (9) is satisfied, which is represented by

$$0.02 < dA 1 / TL < 0.6 . \qquad ( 9 )$$

A sum of Bf and a distance on the optical axis from a surface, on the image side, of the first aspherical lens closest to the image side among the first aspherical lenses included in the rear group to a lens surface of the rear group closest to the image side in the state where the infinite distance object is in focus is denoted by dA1. A sum of Bf and a distance on the optical axis from a lens surface of the front group closest to the object side to the lens surface of the rear group closest to the image side in the state where the infinite distance object is in focus is denoted by TL.

According to an eleventh aspect of the present disclosure, in the imaging lens of the tenth aspect, Conditional Expression (9-1) is satisfied, which is represented by

$$0.08 < dA 1 / TL < 0 \text{.35} . \qquad ( 9 - 1 )$$

According to a twelfth aspect of the present disclosure, in the imaging lens of the first aspect, the front group includes at least one lens satisfying Conditional Expression (2).

According to a thirteenth aspect of the present disclosure, in the imaging lens of the twelfth aspect, a lens closest to the object side in the front group satisfies Conditional Expression (2).

According to a fourteenth aspect of the present disclosure, in the imaging lens of the thirteenth aspect, the rear group includes at least one lens satisfying Conditional Expression (2).

According to a fifteenth aspect of the present disclosure, in the imaging lens of the first aspect, in a case where a sum of Bf and a distance on the optical axis from a lens surface of the front group closest to the object side to a lens surface of the rear group closest to the image side in the state where the infinite distance object is in focus is denoted by TL, Conditional Expression (10) is satisfied, which is represented by

$$1.2 < TL / ( f \times tan ω m ) < 3. \qquad ( 10 )$$

According to a sixteenth aspect of the present disclosure, in the imaging lens of the fifteenth aspect, Conditional Expression (10-1) is satisfied, which is represented by

$$1. 7 < TL / ( f \times tan ω m ) < 2.5 . \qquad ( 10 - 1 )$$

According to a seventeenth aspect of the present disclosure, in the imaging lens of the sixteenth aspect, Conditional Expression (3-1) is satisfied, which is represented by

$$1.2 < TL / f < 3. \qquad ( 3 - 1 )$$

According to an eighteenth aspect of the present disclosure, in the imaging lens of the seventeenth aspect, in a case where an open F-number in the state where the infinite distance object is in focus is denoted by Fno, Conditional Expression (4-1) is satisfied, which is represented by

$$2 < Fno / tan ω m < 3.2 . \qquad ( 4 - 1 )$$

According to a nineteenth aspect of the present disclosure, in the imaging lens of the eighteenth aspect, Conditional Expression (1-1) is satisfied, which is represented by

$$0.36 < Bf / ( f \times tan ω m ) < 1.2 . \qquad ( 1 - 1 )$$

According to a twentieth aspect of the present disclosure, in the imaging lens of the nineteenth aspect, in a case where a paraxial curvature radius of a surface, on the object side, of a lens closest to the object side in the front group is denoted by RL1f, and a paraxial curvature radius of a surface, on the image side, of the lens closest to the object side in the front group is denoted by RL1r, Conditional Expression (8-1) is satisfied, which is represented by

$$- 1 < ( RL 1 r - RL 1 f ) / ( RL 1 r + RL 1 f ) < - 0.07 . \qquad ( 8 - 1 )$$

According to a twenty-first aspect of the present disclosure, in the imaging lens of the eighteenth aspect, in a case where a sum of Bf and a distance on the optical axis from the stop to the lens surface of the rear group closest to the image side in the state where the infinite distance object is in focus is denoted by dSt, Conditional Expression (7) is satisfied, which is represented by

$$0.67 < dSt / TL < 0.93 . \qquad ( 7 )$$

According to a twenty-second aspect of the present disclosure, in the imaging lens of the twenty-first aspect, in a case where a sum of Bf and a distance on the optical axis from a surface, on the image side, of the first aspherical lens closest to the image side among the first aspherical lenses included in the rear group to the lens surface of the rear group closest to the image side in the state where the infinite distance object is in focus is denoted by dA1, Conditional Expression (9-1) is satisfied, which is represented by

$$0.08 < dA 1 / TL < 0 \text{.35} . \qquad ( 9 - 1 )$$

According to a twenty-third aspect of the present disclosure, in the imaging lens of the twenty-second aspect, the front group includes at least one lens satisfying Conditional Expression (2).

According to a twenty-fourth aspect of the present disclosure, in the imaging lens of the twenty-third aspect, a lens closest to the object side in the front group satisfies Conditional Expression (2).

According to a twenty-fifth aspect of the present disclosure, in the imaging lens of the first aspect, in a case where a refractive index with respect to a d line and an Abbe number based on the d line for a lens included in the entire system are denoted by Nd and νd, respectively, the front group includes at least one lens satisfying Conditional Expression (11), which is represented by

$$1. 6 < Nd + 0.01 \times vd < 2.6 . \qquad ( 11 )$$

According to a twenty-sixth aspect of the present disclosure, in the imaging lens of the twenty-fifth aspect, a lens closest to the object side in the front group satisfies Conditional Expression (11).

According to a twenty-seventh aspect of the present disclosure, in the imaging lens of the first aspect, in a case where a focal length of a lens closest to the object side in the front group is denoted by fL1, Conditional Expression (12) is satisfied, which is represented by

$$- 1.5 < f / fL 1 < 0. \qquad ( 12 )$$

According to a twenty-eighth aspect of the present disclosure, in the imaging lens of the first aspect, in a case where a paraxial curvature radius of a surface, on the image side, of the first aspherical lens closest to the image side among the first aspherical lenses included in the rear group is denoted by RA1c, and a curvature radius, at a position of a maximum effective diameter, of the surface, on the image side, of the first aspherical lens closest to the image side among the first aspherical lenses included in the rear group is denoted by RA1y, Conditional Expression (13) is satisfied, which is represented by

$$- 100 < RA 1 y / Ra 1 c < 0. \qquad ( 13 )$$

According to a twenty-ninth aspect of the present disclosure, in the imaging lens of the first aspect, in a case where a refractive index with respect to a d line and an Abbe number based on the d line for the first aspherical lens closest to the image side among the first aspherical lenses included in the rear group are denoted by NdA1 and νdA1, respectively, Conditional Expression (14) is satisfied, which is represented by

$$1. 8 < NdA 1 + 0.01 \times vdA 1 < 2.14 . \qquad ( 14 )$$

According to a thirtieth aspect of the present disclosure, in the imaging lens of the first aspect, the rear group includes at least one second aspherical lens that has a convex surface facing the image side in the paraxial region and that has, on the image side, a lens surface in which a refractive power at a position of a maximum effective diameter is shifted in a negative direction compared to a refractive power in the paraxial region.

According to a thirty-first aspect of the present disclosure, in the imaging lens of the thirtieth aspect, in a case where a paraxial curvature radius of a surface, on the image side, of the second aspherical lens is denoted by RA2c, and a curvature radius, at the position of the maximum effective diameter, of the surface, on the image side, of the second aspherical lens is denoted by RA2y, all second aspherical lenses included in the rear group satisfy Conditional Expression (15) represented by

$$- 1 < RA 2 c / RA 2 y < 1. \qquad ( 15 )$$

According to a thirty-second aspect of the present disclosure, in the imaging lens of the thirtieth aspect, Conditional Expression (16) is satisfied, which is represented by

$$0.2 < dA 2 / TL < 0.6 . \qquad ( 16 )$$

A sum of Bf and a distance on the optical axis from a surface, on the image side, of the second aspherical lens closest to the image side among the second aspherical lenses included in the rear group to a lens surface of the rear group closest to the image side in the state where the infinite distance object is in focus is denoted by dA2. A sum of Bf and a distance on the optical axis from a lens surface of the front group closest to the object side to the lens surface of the rear group closest to the image side in the state where the infinite distance object is in focus is denoted by TL.

According to a thirty-third aspect of the present disclosure, in the imaging lens of the thirty-second aspect, a lens that is a second from the image side in the rear group is the second aspherical lens closest to the image side among the second aspherical lenses included in the rear group.

According to a thirty-fourth aspect of the present disclosure, in the imaging lens of the thirty-third aspect, the lens that is the second from the image side in the rear group has, on a lens surface on the image side, the inflection point at which the convex or concave shape changes.

According to a thirty-fifth aspect of the present disclosure, in the imaging lens of the first aspect, a lens closest to the image side in the rear group is the first aspherical lens.

According to a thirty-sixth aspect of the present disclosure, in the imaging lens of the thirty-fifth aspect, the lens closest to the image side in the rear group has a convex surface facing the object side in the paraxial region and has, on a lens surface on the object side, the inflection point at which the convex or concave shape changes.

According to a thirty-seventh aspect of the present disclosure, in the imaging lens of the first aspect, the rear group includes two first aspherical lenses.

According to a thirty-eighth aspect of the present disclosure, in the imaging lens of the thirtieth aspect, the rear group includes two second aspherical lenses.

According to a thirty-ninth aspect of the present disclosure, in the imaging lens of the first aspect, the imaging lens includes at least one cemented lens.

According to a fortieth aspect of the present disclosure, in the imaging lens of the first aspect, a lens closest to the object side in the front group satisfies Conditional Expression (2), and Conditional Expressions (3-2), (4-2), (7), and (9-1) are satisfied, which are represented by

$$1.2 < TL / f < 1.6 \qquad ( 3 - 2 )$$

$$2.5 < Fno / tan ω m < 4 \qquad ( 4 - 2 )$$

$$0.67 < dSt / TL < 0.93 \qquad ( 7 )$$

$$0.08 < dA 1 / TL < 0.35 . \qquad ( 9 - 1 )$$

A sum of Bf and a distance on the optical axis from a lens surface of the front group closest to the object side to a lens surface of the rear group closest to the image side in the state where the infinite distance object is in focus is denoted by TL. An open F-number in the state where the infinite distance object is in focus is denoted by Fno. A sum of Bf and a distance on the optical axis from the stop to the lens surface of the rear group closest to the image side in the state where the infinite distance object is in focus is denoted by dSt. A sum of Bf and a distance on the optical axis from a surface, on the image side, of the first aspherical lens closest to the image side among the first aspherical lenses included in the rear group to the lens surface of the rear group closest to the image side in the state where the infinite distance object is in focus is denoted by dA1.

According to a forty-first aspect of the present disclosure, there is provided an imaging apparatus comprising the imaging lens according to any one of the first to fortieth aspects.

In the present specification, the expressions “consists of” and “consisting of” indicate that a lens substantially not having a refractive power, an optical element other than a lens, such as a stop, a filter, and a cover glass, a mechanism part such as a lens flange, a lens barrel, an imaging element, and a camera shake correction mechanism may be included in addition to the illustrated constituents.

Unless otherwise specified, a curvature radius, a sign of a refractive power, and a surface shape related to a lens including an aspherical surface in a paraxial region are used. For a sign of the curvature radius, a sign of the curvature radius of a surface having a convex shape facing the object side is positive, and a sign of the curvature radius of a surface having a convex shape facing the image side is negative.

The term “entire system” in the present specification means the imaging lens. The term “focal length” used in the conditional expressions is a paraxial focal length. Unless otherwise specified, the term “distance on the optical axis” used in the conditional expressions is a geometrical distance. Unless otherwise specified, values used in the conditional expressions are values based on the d line in the state where the infinite distance object is in focus. The term “group” in the present specification is not limited to a configuration consisting of a plurality of lenses and may be a configuration consisting of only one lens. The term “single lens” means one non-cemented lens.

The terms “d line”, “C line”, and “F line” according to the present specification are bright lines. A wavelength of the d line is 587.56 nanometers (nm). A wavelength of the C line is 656.27 nanometers (nm). A wavelength of the F line is 486.13 nanometers (nm).

According to the present disclosure, an imaging lens that is configured to be reduced in size and that maintains favorable optical performance, and an imaging apparatus comprising the imaging lens can be provided.

### BRIEF DESCRIPTION OF THE DRAWINGS

FIG. 1 is a cross-sectional view that illustrates a configuration of an imaging lens according to one embodiment and that corresponds to an imaging lens of Example 1.

FIG. 2 is a cross-sectional view illustrating a configuration and luminous fluxes in each state of the imaging lens in FIG. 1.

FIG. 3 is a diagram for describing symbols of conditional expressions.

FIG. 4 is a diagram for describing a position of a maximum effective diameter.

FIG. 5 is each aberration diagram of the imaging lens of Example 1.

FIG. 6 is a cross-sectional view illustrating a configuration of an imaging lens of Example 2.

FIG. 7 is each aberration diagram of the imaging lens of Example 2.

FIG. 8 is a cross-sectional view illustrating a configuration of an imaging lens of Example 3.

FIG. 9 is each aberration diagram of the imaging lens of Example 3.

FIG. 10 is a cross-sectional view illustrating a configuration of an imaging lens of Example 4.

FIG. 11 is each aberration diagram of the imaging lens of Example 4.

FIG. 12 is a cross-sectional view illustrating a configuration of an imaging lens of Example 5.

FIG. 13 is each aberration diagram of the imaging lens of Example 5.

FIG. 14 is a cross-sectional view illustrating a configuration of an imaging lens of Example 6.

FIG. 15 is each aberration diagram of the imaging lens of Example 6.

FIG. 16 is a cross-sectional view illustrating a configuration of an imaging lens of Example 7.

FIG. 17 is each aberration diagram of the imaging lens of Example 7.

FIG. 18 is a cross-sectional view illustrating a configuration of an imaging lens of Example 8.

FIG. 19 is each aberration diagram of the imaging lens of Example 8.

FIG. 20 is a cross-sectional view illustrating a configuration of an imaging lens of Example 9.

FIG. 21 is each aberration diagram of the imaging lens of Example 9.

FIG. 22 is a cross-sectional view illustrating a configuration of an imaging lens of Example 10.

FIG. 23 is each aberration diagram of the imaging lens of Example 10.

FIG. 24 is a cross-sectional view illustrating a configuration of an imaging lens of Example 11.

FIG. 25 is each aberration diagram of the imaging lens of Example 11.

FIG. 26 is a cross-sectional view illustrating a configuration of an imaging lens of Example 12.

FIG. 27 is each aberration diagram of the imaging lens of Example 12.

FIG. 28 is a cross-sectional view illustrating a configuration of an imaging lens of Example 13.

FIG. 29 is each aberration diagram of the imaging lens of Example 13.

FIG. 30 is a cross-sectional view illustrating a configuration of an imaging lens of Example 14.

FIG. 31 is each aberration diagram of the imaging lens of Example 14.

FIG. 32 is a cross-sectional view illustrating a configuration of an imaging lens of Example 15.

FIG. 33 is each aberration diagram of the imaging lens of Example 15.

FIG. 34 is a cross-sectional view illustrating a configuration of an imaging lens of Example 16.

FIG. 35 is each aberration diagram of the imaging lens of Example 16.

FIG. 36 is a cross-sectional view illustrating a configuration of an imaging lens of Example 17.

FIG. 37 is each aberration diagram of the imaging lens of Example 17.

FIG. 38 is a cross-sectional view illustrating a configuration of an imaging lens of Example 18.

FIG. 39 is each aberration diagram of the imaging lens of Example 18.

FIG. 40 is a cross-sectional view illustrating a configuration of an imaging lens of Example 19.

FIG. 41 is each aberration diagram of the imaging lens of Example 19.

FIG. 42 is a cross-sectional view illustrating a configuration of an imaging lens of Example 20.

FIG. 43 is each aberration diagram of the imaging lens of Example 20.

FIG. 44 is a cross-sectional view illustrating a configuration of an imaging lens of Example 21.

FIG. 45 is each aberration diagram of the imaging lens of Example 21.

FIG. 46 is a perspective view of a front surface side of an imaging apparatus according to one embodiment.

FIG. 47 is a perspective view of a rear surface side of the imaging apparatus according to one embodiment.

### DESCRIPTION OF EMBODIMENTS

Hereinafter, an embodiment of the present disclosure will be described with reference to the drawings.

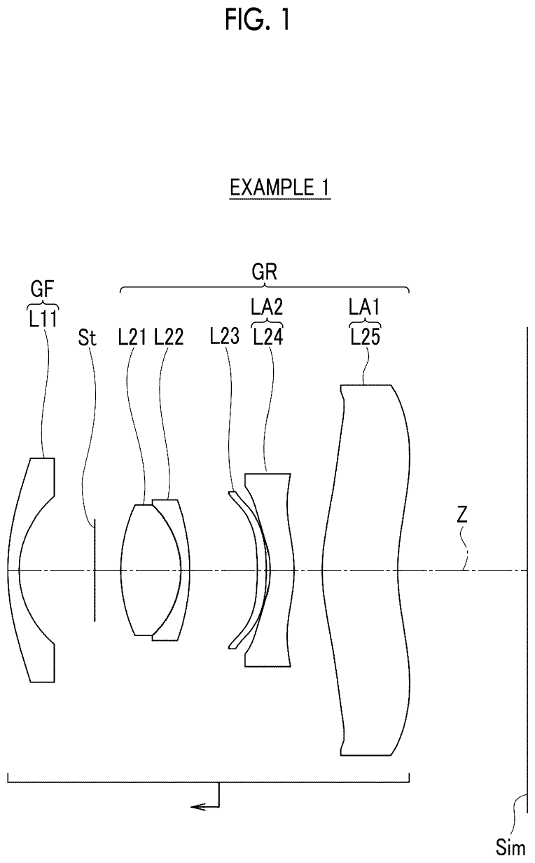

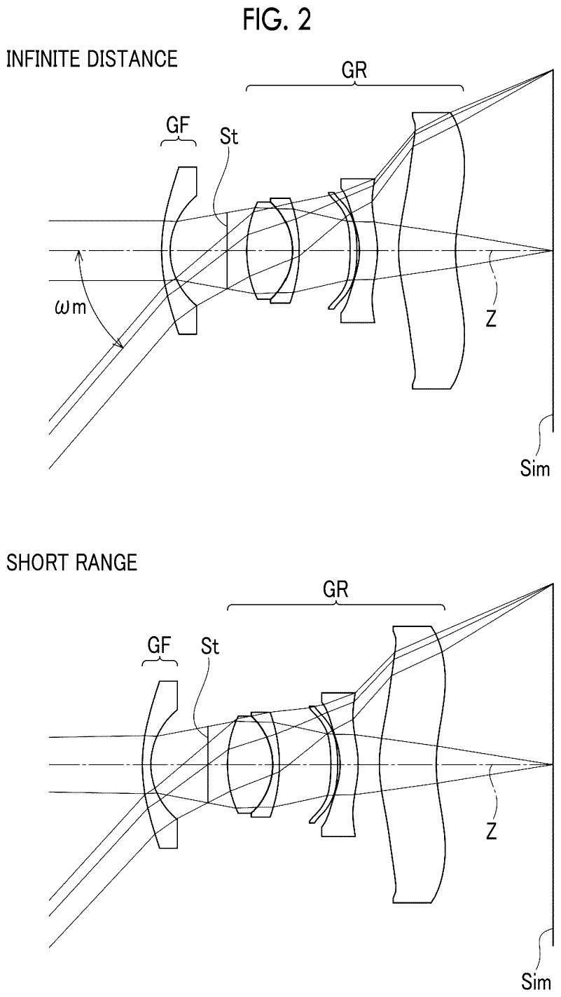

FIG. 1 illustrates a cross-sectional view of a configuration of an imaging lens according to one embodiment of the present disclosure. FIG. 2 is a cross-sectional view of a configuration and luminous fluxes of the imaging lens in FIG. 1. In FIG. 2, a state where an infinite distance object is in focus is illustrated in an upper part labeled “INFINITE DISTANCE”, and a state where a short range object is in focus is illustrated in a lower part labeled “SHORT RANGE”. The state in the lower part of FIG. 2 is a state where an absolute value of an imaging magnification is 0.11 times the original imaging magnification. In FIG. 2, an on-axis luminous flux and a luminous flux at a maximum half angle of view om in the state where the infinite distance object is in focus, and an on-axis luminous flux and a luminous flux at the maximum half angle of view in the state where the short range object is in focus are illustrated as the luminous fluxes. In FIGS. 1 and 2, a left side is an object side, and a right side is an image side. The examples illustrated in FIGS. 1 and 2 correspond to an imaging lens of Example 1 described later. Hereinafter, description will be mainly provided with reference to FIG. 1.

An imaging lens of the present disclosure consists of, along an optical axis Z, in order from the object side to the image side, a front group GF including one or more lenses, an aperture stop St, and a rear group GR including a plurality of lenses. Not disposing the aperture stop St in any of a part closest to the object side or a part closest to the image side in a lens system achieves an advantage in correcting various aberrations.

For example, each group of the imaging lens in FIG. 1 is configured as follows. The front group GF consists of one lens that is a lens L11. The rear group GR consists of five lenses including lenses L21 to L25 in order from the object side to the image side. The aperture stop St in FIG. 1 does not indicate a size or a shape and indicates a position in an optical axis direction. This illustration method of the aperture stop St also applies to other cross-sectional views.

The rear group GR includes at least one first aspherical lens LA1. The first aspherical lens LA1 has a shape in which a concave surface faces the image side in a paraxial region. The expression “has a shape in which a concave surface faces the image side in the paraxial region” means that a lens surface on the image side has a concave shape in the paraxial region. The first aspherical lens LA1 further has, on a lens surface on the image side, an inflection point at which a convex or concave shape changes in the middle of the lens surface from a position on the optical axis to an edge part. The inflection point is a point at which a surface shape changes from a convex shape to a concave shape or from a concave shape to a convex shape, that is, a point at which a sign of a curvature radius changes. Causing the lens surface to have the inflection point enables a refractive power in the edge part of the lens to be determined independently of a refractive power in the paraxial region. Thus, an advantage in controlling a field curvature and controlling an incidence angle of a ray on an image plane Sim is achieved. According to the above, using the first aspherical lens LA1 facilitates correction of the field curvature and prevention of an excessively large incidence angle of a principal ray on the image plane Sim while reducing the lens system in size. While there is a demand in optical design for the lens having such a shape like the first aspherical lens LA1, it is difficult to manufacture the lens. In recent years, it has been realistic to use the lens having such a shape as an imaging lens because of a further increasing demand for reduction in size and improvement in manufacturing technology.

In the example in FIG. 1, the lens L25 corresponds to the first aspherical lens LA1. While the rear group GR includes only one first aspherical lens LA1 in the example in FIG. 1, the rear group GR may be configured to include two first aspherical lenses LA1 in the imaging lens of the present disclosure. Doing so achieves a further advantage in correcting the field curvature.

As in the example in FIG. 1, in a case where a lens closest to the image side in the rear group GR is configured as the first aspherical lens LA1, correction of the field curvature and prevention of an excessively large incidence angle of the principal ray on the image plane Sim are facilitated.

The lens closest to the image side in the rear group GR may be configured to have a shape in which a convex surface faces the object side in the paraxial region, and have, on a lens surface on the object side, the inflection point at which the convex or concave shape changes in the middle of the lens surface from the position on the optical axis to the edge part. The expression “has a shape in which a convex surface faces the object side in the paraxial region” means that a lens surface on the object side has a convex shape in the paraxial region. In a case where the lens closest to the image side in the rear group GR has the above configuration, an advantage in reducing a total optical length is achieved.

The rear group GR preferably includes at least one second aspherical lens LA2. The second aspherical lens LA2 has a shape in which a convex surface faces the image side in the paraxial region. The expression “has a shape in which a convex surface faces the image side in the paraxial region” means that a lens surface on the image side has a convex shape in the paraxial region. A lens surface of the second aspherical lens LA2 on the image side further has a shape in which a refractive power at a position of a maximum effective diameter is shifted in a negative direction compared to the refractive power in the paraxial region. Using the second aspherical lens LA2 having the above shape achieves an advantage in correcting various aberrations while suppressing an increase in the total optical length.

The expression “the refractive power at the position of the maximum effective diameter is shifted in the negative direction compared to the refractive power in the paraxial region” in the present specification has the following meaning based on a sign of the refractive power. In a case where a surface has a negative refractive power in both of the paraxial region and the position of the maximum effective diameter, the expression means that the negative refractive power is stronger at the position of the maximum effective diameter than that in the paraxial region. In a case where a surface has a positive refractive power in both of the paraxial region and the position of the maximum effective diameter, the expression means that the positive refractive power is weaker at the position of the maximum effective diameter than that in the paraxial region. In a case where a surface has refractive powers of different signs between the paraxial region and the position of the maximum effective diameter, the expression means that the refractive power in the paraxial region is positive, and the refractive power at the position of the maximum effective diameter is negative.

In the example in FIG. 1, the lens L24 corresponds to the second aspherical lens LA2. While the rear group GR includes only one second aspherical lens LA2 in the example in FIG. 1, the rear group GR may be configured to include two second aspherical lenses LA2 in the imaging lens of the present disclosure. Doing so achieves an advantage in correcting various aberrations while suppressing an increase in the total optical length.

A lens that is the second from the image side in the rear group GR may be configured as the second aspherical lens LA2 closest to the image side among the second aspherical lenses LA2 included in the rear group GR. Doing so achieves an advantage in correcting various aberrations while suppressing an increase in the total optical length.

The lens that is the second from the image side in the rear group GR may be configured to have, on a lens surface on the image side, the inflection point at which the convex or concave shape changes in the middle of the lens surface from the position on the optical axis to the edge part. Doing so facilitates correction of a spherical aberration and the field curvature at the same time while reducing the lens system in size.

At least one of the aspherical lenses included in the imaging lens may be a compound aspherical lens in which a resin of which a surface in contact with air has an aspherical shape is formed on a spherical surface of a lens made of glass. Doing so enables the aspherical surface to be attached to the lens surface while suppressing a manufacturing cost. Thus, both of reduction in cost and favorable correction of various aberrations can be established. In the present specification, a compound aspherical lens is not regarded as a cemented lens and is regarded as one non-cemented lens, that is, a single lens.

The imaging lens preferably includes at least one cemented lens. Doing so achieves an advantage in correcting a chromatic aberration.

Hereinafter, preferable configurations of the imaging lens of the present disclosure related to conditional expressions will be described. In the following description of conditional expressions, in order to avoid redundancy, the same symbol will be used for the same definition to omit duplicate descriptions of the symbol. Hereinafter, the “imaging lens of the present disclosure” will be simply referred to as the “imaging lens” in order to avoid redundancy.

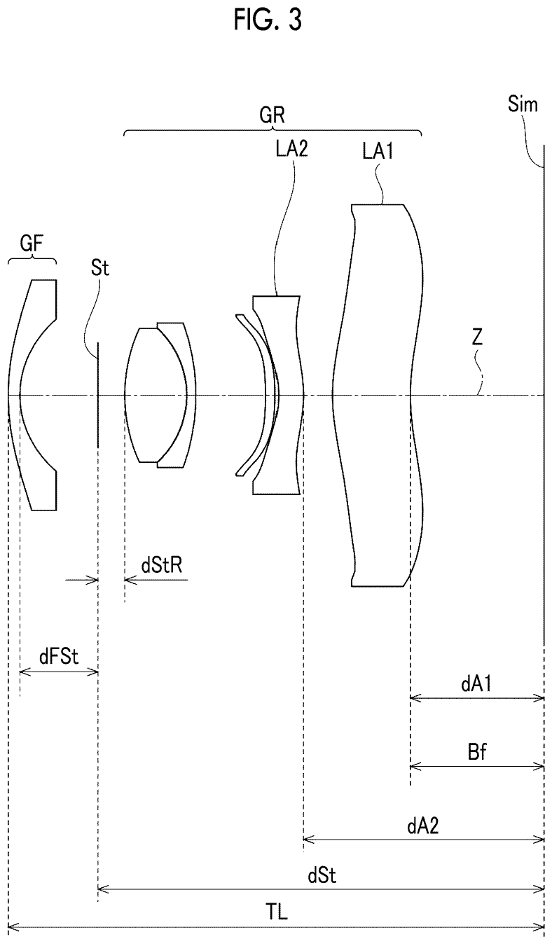

The imaging lens preferably satisfies Conditional Expression (1). A back focus of the entire system as an air conversion distance in a state where an infinite distance object is in focus is denoted by Bf. A focal length of the entire system in the state where the infinite distance object is in focus is denoted by f. Here, tan denotes a tangent. A maximum half angle of view in the state where the infinite distance object is in focus is denoted by ωm. The back focus Bf of the entire system as the air conversion distance is an air conversion distance on the optical axis from a lens surface of the imaging lens closest to the image side to the image plane Sim. For example, the back focus Bf is illustrated in FIG. 3. FIG. 3 is a diagram illustrating the symbols and the like used in the conditional expressions on the cross-sectional view of the imaging lens in FIG. 1. In FIG. 3, symbols of a part of lenses are omitted. Ensuring that a corresponding value of Conditional Expression (1) is not less than or equal to its lower limit prevents an excessively short back focus Bf defined above and thus, facilitates attachment of a mount replacement mechanism. Ensuring that the corresponding value of Conditional Expression (1) is not greater than or equal to its upper limit prevents an excessively long back focus Bf defined above and thus, facilitates reduction in size.

$$0.3 < Bf / ( f \times tan ω m ) < 1.5 \qquad ( 1 )$$

In order to obtain more favorable characteristics, the lower limit value of Conditional Expression (1) is more preferably 0.32, further preferably 0.34, further preferably 0.36, further preferably 0.38, and further preferably 0.4. In order to obtain more favorable characteristics, the upper limit value of Conditional Expression (1) is more preferably 1.4, further preferably 1.3, further preferably 1.2, further preferably 1.1, and further preferably 0.9. For example, the imaging lens more preferably satisfies Conditional Expression (1-1).

$$0.36 < Bf / ( f \times tan ω m ) < 1.2 \qquad ( 1 - 1 )$$

The imaging lens preferably includes at least one lens satisfying Conditional Expression (2). A temperature coefficient of a refractive index with respect to a d line at 25° C. for a lens included in the imaging lens is denoted by (dN/dT)×10⁻⁶. Here, dN/dT is in units of ° C.⁻¹. A lower limit of Conditional Expression (2) is denoted by 0<|dN/dT| because |dN/dT| is an absolute value. Ensuring that a corresponding value of Conditional Expression (2) is not greater than or equal to its upper limit value facilitates suppression of variation in a focusing position of the imaging lens under a change in temperature.

$$0 < \vert dN / dT \vert < 15 \qquad ( 2 )$$

The front group GF preferably includes at least one lens satisfying Conditional Expression (2). More specifically, a lens closest to the object side in the front group GF preferably satisfies Conditional Expression (2). The rear group GR also preferably includes at least one lens satisfying Conditional Expression (2).

In order to obtain more favorable characteristics, an upper limit value of Conditional Expression (2) is more preferably 14, further preferably 13, further preferably 12, further preferably 11, and further preferably 10.

The imaging lens preferably satisfies Conditional Expression (3). A sum of the back focus Bf and a distance on the optical axis from a lens surface of the front group GF closest to the object side to a lens surface of the rear group GR closest to the image side in the state where the infinite distance object is in focus is denoted by TL. TL denotes the total length in the state where the infinite distance object is in focus. For example, the total length TL is illustrated in FIG. 3. Ensuring that a corresponding value of Conditional Expression (3) is not less than or equal to its lower limit value achieves an advantage in suppressing various aberrations. Ensuring that the corresponding value of Conditional Expression (3) is not greater than or equal to its upper limit value achieves an advantage in reducing the entire optical system in size.

$$1 \text{.1} < TL / f < 3.5 \qquad ( 3 )$$

In order to obtain more favorable characteristics, the lower limit value of Conditional Expression (3) is more preferably 1.2, further preferably 1.21, further preferably 1.22, further preferably 1.23, further preferably 1.24, further preferably 1.25, further preferably 1.3, further preferably 1.4, further preferably 1.5, further preferably 1.6, further preferably 1.7, further preferably 1.8, and further preferably 1.9. In order to obtain more favorable characteristics, the upper limit of Conditional Expression (3) is more preferably 3, further preferably 2.9, further preferably 2.85, further preferably 2.8, further preferably 2.75, further preferably 2.7, further preferably 2.65, further preferably 2.6, further preferably 1.6, further preferably 1.55, further preferably 1.5, further preferably 1.48, further preferably 1.46, and further preferably 1.45. For example, the imaging lens more preferably satisfies Conditional Expression (3-1) and further preferably satisfies Conditional Expression (3-2).

$$1.2 < TL / f < 3 \qquad ( 3 ‐ 1 )$$

$$1.2 < TL / f < 1.6 \qquad ( 3 ‐ 2 )$$

The imaging lens preferably satisfies Conditional Expression (4). An open F-number in the state where the infinite distance object is in focus is denoted by Fno. Ensuring that a corresponding value of Conditional Expression (4) is not less than or equal to its lower limit achieves an advantage in suppressing an increase in the number of lenses and suppressing an increase in a size of the lens system while obtaining favorable optical performance. Ensuring that the corresponding value of Conditional Expression (4) is not greater than or equal to its upper limit value facilitates reduction of the open F-number while increasing the angle of view.

$$1. 6 < Fno / tan ω m < 5 \qquad ( 4 )$$

In order to obtain more favorable characteristics, the lower limit value of Conditional Expression (4) is more preferably 1.7, further preferably 1.8, further preferably 1.9, further preferably 2, further preferably 2.1, further preferably 2.5, and further preferably 2.8. In order to obtain more favorable characteristics, the upper limit value of Conditional Expression (4) is more preferably 4, further preferably 3.5, further preferably 3.3, further preferably 3.2, and further preferably 3.1. For example, the imaging lens more preferably satisfies Conditional Expression (4-1) and further preferably satisfies Conditional Expression (4-2).

$$2 < Fno / tan ω m < 3.2 \qquad ( 4 ‐ 1 )$$

$$2.5 < Fno / tan ω m < 4 \qquad ( 4 ‐ 2 )$$

The imaging lens preferably satisfies Conditional Expressions (5) and (6) at the same time. A minimum value of a distance on the optical axis from a lens surface of the front group GF closest to the image side to the aperture stop St is denoted by dFSt. A minimum value of a distance on the optical axis from the aperture stop St to a lens surface of the rear group GR closest to the object side is denoted by dStR. That is, dFSt denotes a minimum spacing between the front group GF and the aperture stop St, and dStR denotes a minimum spacing between the aperture stop St and the rear group GR. The term “minimum” means a minimum in an in-focus state from the state where the infinite distance object is in focus to a state where a nearest object is in focus. A sign of dFSt is positive in a case where the aperture stop St is closer to the image side than the lens surface of the front group GF closest to the image side, and is negative in a case where the aperture stop St is closer to the object side than the lens surface of the front group GF closest to the image side. A sign of dStR is positive in a case where the lens surface of the rear group GR closest to the object side is closer to the image side than the aperture stop St, and is negative in a case where the lens surface of the rear group GR closest to the object side is closer to the object side than the aperture stop St. For example, the minimum spacing dFSt and the minimum spacing dStR are illustrated in FIG. 3. Ensuring that a corresponding value of any of Conditional Expressions (5) and (6) is not less than or equal to its lower limit value facilitates provision of a mechanism for changing an opening diameter of the aperture stop St to any value. Ensuring that the corresponding value of any of Conditional Expressions (5) and (6) is not greater than or equal to its upper limit value achieves an advantage in reducing the lens system in size.

$$0 < dFSt / TL < 0.8 \qquad ( 5 )$$

$$0 < dStR / TL < 0.8 \qquad ( 6 )$$

In order to obtain more favorable characteristics, the lower limit value of Conditional Expression (5) is more preferably 0.001, further preferably 0.003, and further preferably 0.005. In order to obtain more favorable characteristics, the upper limit value of Conditional Expression (5) is more preferably 0.5, further preferably 0.35, and further preferably 0.3.

In order to obtain more favorable characteristics, the lower limit value of Conditional Expression (6) is more preferably 0.001, further preferably 0.003, and further preferably 0.005. In order to obtain more favorable characteristics, the upper limit value of Conditional Expression (6) is more preferably 0.5, further preferably 0.35, and further preferably 0.3.

The imaging lens preferably satisfies Conditional Expression (7). A sum of the back focus Bf and a distance on the optical axis from the aperture stop St to the lens surface of the rear group GR closest to the image side in the state where the infinite distance object is in focus is denoted by dSt. For example, the distance dSt is illustrated in FIG. 3. Ensuring that a corresponding value of Conditional Expression (7) is not less than or equal to its lower limit value facilitates prevention of an excessively large incidence angle of the principal ray on the image plane Sim. Ensuring that the corresponding value of Conditional Expression (7) is not greater than or equal to its upper limit value achieves an advantage in favorably correcting a distortion.

$$0.67 < dSt / TL < 0 \text{.93} \qquad ( 7 )$$

In order to obtain more favorable characteristics, the lower limit value of Conditional Expression (7) is more preferably 0.68, further preferably 0.69, further preferably 0.7, and further preferably 0.71. In order to obtain more favorable characteristics, the upper limit value of Conditional Expression (7) is more preferably 0.89, further preferably 0.85, further preferably 0.84, and further preferably 0.83.

The imaging lens preferably satisfies Conditional Expression (8). A paraxial curvature radius of a surface, on the object side, of the lens closest to the object side in the front group GF is denoted by RL1f. A paraxial curvature radius of a surface, on the image side, of the lens closest to the object side in the front group GF is denoted by RL1r. Conditional Expression (8) defines a shape factor of the lens. Ensuring that a corresponding value of Conditional Expression (8) is not less than or equal to its lower limit value facilitates favorable correction of an astigmatism. Ensuring that the corresponding value of Conditional Expression (8) is not greater than or equal to its upper limit value facilitates favorable correction of the spherical aberration. In addition, ensuring that the corresponding value of Conditional Expression (8) is not greater than or equal to its upper limit value prevents an excessively weak refractive power of the lens closest to the object side in the front group GF and thus, facilitates achievement of a wide angle of view.

$$- 3 < ( RL 1 r - RL 1 f ) / ( RL 1 r + RL 1 f ) < 0 \qquad ( 8 )$$

In order to obtain more favorable characteristics, the lower limit value of Conditional Expression (8) is more preferably −2, further preferably −1.5, further preferably −1, further preferably −0.96, further preferably −0.93, and further preferably −0.9. In order to obtain more favorable characteristics, the upper limit value of Conditional Expression (8) is more preferably −0.04, further preferably −0.06, further preferably −0.07, further preferably −0.08, further preferably −0.09, and further preferably −0.1. For example, the imaging lens more preferably satisfies Conditional Expression (8-1).

$$- 1 < ( RL 1 r - RL 1 f ) / ( RL 1 r + RL 1 f ) < - 0.07 \qquad ( 8 ‐ 1 )$$

The imaging lens preferably satisfies Conditional Expression (9). A sum of Bf and a distance on the optical axis from a surface, on the image side, of the first aspherical lens LA1 closest to the image side among the first aspherical lenses LA1 included in the rear group GR to the lens surface of the rear group GR closest to the image side in the state where the infinite distance object is in focus is denoted by dA1. For example, the distance dA1 is illustrated in FIG. 3. In the imaging lens illustrated in FIG. 3, since the first aspherical lens LA1 is disposed closest to the image side in the rear group GR, Bf and the distance dA1 are equal to each other. However, in a case where the first aspherical lens LA1 is not disposed closest to the image side in the rear group GR, Bf and the distance dA1 are not equal to each other. Ensuring that a corresponding value of Conditional Expression (9) is not less than or equal to its lower limit value facilitates prevention of interference between the surface of the first aspherical lens LA1 on the image side and various optical filters installed near the image plane. Ensuring that the corresponding value of Conditional Expression (9) is not greater than or equal to its upper limit value facilitates correction of the distortion and the field curvature.

$$0.02 < dA 1 / TL < 0.6 \qquad ( 9 )$$

In order to obtain more favorable characteristics, the lower limit value of Conditional Expression (9) is more preferably 0.03, further preferably 0.04, further preferably 0.06, further preferably 0.07, further preferably 0.08, further preferably 0.09, and further preferably 0.1. In order to obtain more favorable characteristics, the upper limit value of Conditional Expression (9) is more preferably 0.55, further preferably 0.5, further preferably 0.45, further preferably 0.4, further preferably 0.35, further preferably 0.34, and further preferably 0.33. For example, the imaging lens more preferably satisfies Conditional Expression (9-1).

$$0.08 < dA 1 / TL < 0 \text{.35} \qquad ( 9 ‐ 1 )$$

The imaging lens preferably satisfies Conditional Expression (10). Ensuring that a corresponding value of Conditional Expression (10) is not less than or equal to its lower limit value achieves an advantage in suppressing various aberrations. Ensuring that the corresponding value of Conditional Expression (10) is not greater than or equal to its upper limit value achieves an advantage in reducing the entire optical system in size.

$$1. 2 < TL / ( f \times tan ω m ) < 3 \qquad ( 10 )$$

In order to obtain more favorable characteristics, the lower limit value of Conditional Expression (10) is more preferably 1.3, further preferably 1.4, further preferably 1.5, further preferably 1.6, further preferably 1.7, further preferably 1.8, and further preferably 1.85. In order to obtain more favorable characteristics, the upper limit value of Conditional Expression (10) is more preferably 2.9, further preferably 2.8, further preferably 2.7, further preferably 2.6, further preferably 2.5, further preferably 2.4, and further preferably 2.35. For example, the imaging lens more preferably satisfies Conditional Expression (10-1).

$$1. 7 < TL / ( f \times tan ω m ) < 2.5 \qquad ( 10 ‐ 1 )$$

The front group GF preferably includes at least one lens satisfying Conditional Expression (11). Particularly, the lens closest to the object side in the front group GF preferably satisfies Conditional Expression (11). A refractive index with respect to the d line and an Abbe number based on the d line for a lens included in the imaging lens are denoted by Nd and νd, respectively. Ensuring that a corresponding value of Conditional Expression (11) is not less than or equal to its lower limit value enables selection of a material other than a material having a low refractive index and a small Abbe number and thus, facilitates correction of a lateral chromatic aberration. Ensuring that the corresponding value of Conditional Expression (11) is not greater than or equal to its upper limit value enables selection of a material other than a material having a high refractive index and a large Abbe number. Thus, a material of which a specific gravity is not large can be selected, and this facilitates reduction in weight.

$$1. 6 < N d + 0.01 \times v d < 2.6 \qquad ( 11 )$$

In order to obtain more favorable characteristics, the lower limit value of Conditional Expression (11) is more preferably 1.7, further preferably 1.8, and further preferably 1.85. In order to obtain more favorable characteristics, the upper limit value of Conditional Expression (11) is more preferably 2.5, further preferably 2.4, and further preferably 2.35.

In a case where a focal length of the lens closest to the object side in the front group GF is denoted by fL1, the imaging lens preferably satisfies Conditional Expression (12). Ensuring that a corresponding value of Conditional Expression (12) is not less than or equal to its lower limit value facilitates correction of the distortion. Ensuring that the corresponding value of Conditional Expression (12) is not greater than or equal to its upper limit value facilitates correction of the field curvature.

$$- 1.5 < f / fL 1 < 0 \qquad ( 12 )$$

In order to obtain more favorable characteristics, the lower limit value of Conditional Expression (12) is more preferably −1.3, further preferably −1.1, further preferably −0.9, and further preferably −0.8. In order to obtain more favorable characteristics, the upper limit value of Conditional Expression (12) is more preferably −0.2, further preferably −0.35, further preferably −0.45, and further preferably −0.55.

The imaging lens preferably satisfies Conditional Expression (13). A paraxial curvature radius of the surface, on the image side, of the first aspherical lens LA1 closest to the image side among the first aspherical lenses LA1 included in the rear group GR is denoted by RA1c. A curvature radius, at the position of the maximum effective diameter, of the surface, on the image side, of the first aspherical lens LA1 closest to the image side among the first aspherical lenses LA1 included in the rear group GR is denoted by RA1y. Ensuring that a corresponding value of Conditional Expression (13) is not less than or equal to its lower limit value facilitates prevention of an excessively large incidence angle of the principal ray on the image plane Sim. Ensuring that the corresponding value of Conditional Expression (13) is not greater than or equal to its upper limit value facilitates suppression of intensity of stray light caused by light reflected by the surface, on the image side, of the first aspherical lens LA1 closest to the image side among the first aspherical lenses LA1 included in the rear group GR.

$$- 100 < RA 1 y / RA 1 c < 0 \qquad ( 13 )$$

In order to obtain more favorable characteristics, the lower limit value of Conditional Expression (13) is more preferably −10, further preferably −6, further preferably −5, further preferably −4, further preferably −3, and further preferably −2. In order to obtain more favorable characteristics, the upper limit value of Conditional Expression (13) is more preferably −0.1, further preferably −0.2, further preferably −0.3, further preferably −0.4, further preferably −0.5, and further preferably −0.6.

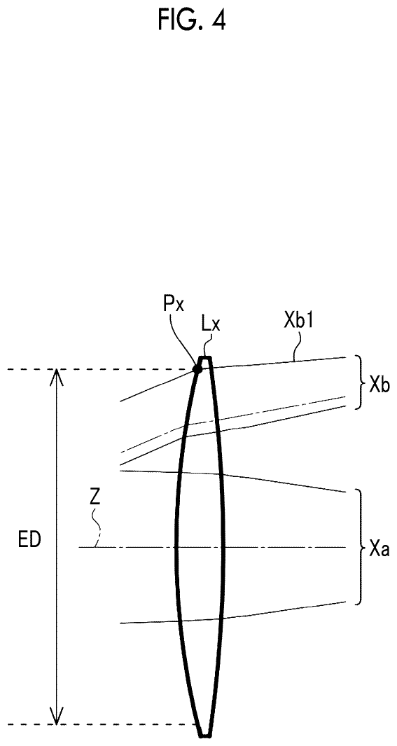

The “position of the maximum effective diameter” in the present specification will be described with reference to FIG. 4. FIG. 4 is a diagram for description. In FIG. 4, a left side is the object side, and a right side is the image side. FIG. 4 illustrates an on-axis luminous flux Xa and an off-axis luminous flux Xb passing through a lens Lx. In the example in FIG. 4, a ray Xb1 that is a ray on an upper side of the off-axis luminous flux Xb is a ray passing through an outermost side. The term “outer side” means an outer side in a diameter direction centered on the optical axis Z, that is, a side away from the optical axis Z. In the present specification, a position of an intersection between the ray passing through the outermost side and a lens surface is a position Px of the maximum effective diameter. Twice a distance from the position Px of the maximum effective diameter to the optical axis Z is an effective diameter ED of a surface of the lens Lx on the object side. While the ray on the upper side of the off-axis luminous flux Xb is the ray passing through the outermost side in the example in FIG. 4, which ray is the ray passing through the outermost side varies depending on the lens system.

The imaging lens preferably satisfies Conditional Expression (14). A refractive index with respect to the d line and an Abbe number based on the d line for the first aspherical lens LA1 closest to the image side among the first aspherical lenses LA1 included in the rear group GR are denoted by NdA1 and νdA1, respectively. Ensuring that a corresponding value of Conditional Expression (14) is not less than or equal to its lower limit value enables selection of a material other than a material having a low refractive index and a small Abbe number and thus, facilitates correction of the lateral chromatic aberration. Ensuring that the corresponding value of Conditional Expression (14) is not greater than or equal to its upper limit value enables selection of a material other than a material having a high refractive index and a large Abbe number. Thus, a material of which a specific gravity is not large can be selected, and this facilitates reduction in weight.

$$1.8 < NdA 1 + 0.01 \times vdA 1 < 2.14 \qquad ( 14 )$$

In order to obtain more favorable characteristics, the lower limit value of Conditional Expression (14) is more preferably 1.85, further preferably 1.9, and further preferably 1.95. In order to obtain more favorable characteristics, the upper limit value of Conditional Expression (14) is more preferably 2.13, further preferably 2.12, and further preferably 2.11.

In a configuration in which the rear group GR includes at least one second aspherical lens LA2, all second aspherical lenses LA2 included in the rear group GR preferably satisfy Conditional Expression (15). A paraxial curvature radius of a surface, on the image side, of the second aspherical lens LA2 is denoted by RA2c. A curvature radius, at the position of the maximum effective diameter, of the surface, on the image side, of the second aspherical lens LA2 is denoted by RA2y. Ensuring that a corresponding value of Conditional Expression (15) is not less than or equal to its lower limit value achieves an advantage in suppressing the astigmatism. Ensuring that the corresponding value of Conditional Expression (15) is not greater than or equal to its upper limit value facilitates suppression of an increase in the total optical length while suppressing various aberrations.

$$- 1 < RA 2 c / RA 2 y < 1 \qquad ( 15 )$$

In order to obtain more favorable characteristics, the lower limit value of Conditional Expression (15) is more preferably −0.9, further preferably −0.8, further preferably −0.7, further preferably −0.6, further preferably −0.5, further preferably −0.4, and further preferably −0.3. In order to obtain more favorable characteristics, the upper limit value of Conditional Expression (15) is more preferably 0.9, further preferably 0.8, further preferably 0.7, further preferably 0.6, further preferably 0.5, further preferably 0.4, and further preferably 0.3.

In a configuration in which the rear group GR includes at least one second aspherical lens LA2, the imaging lens preferably satisfies Conditional Expression (16). A sum of Bf and a distance on the optical axis from the surface, on the image side, of the second aspherical lens LA2 closest to the image side among the second aspherical lenses LA2 included in the rear group GR to the lens surface of the rear group GR closest to the image side is denoted by dA2. The sum of Bf and the distance on the optical axis from the lens surface of the front group GF closest to the object side to the lens surface of the rear group GR closest to the image side in the state where the infinite distance object is in focus is denoted by TL. For example, the distance dA2 is illustrated in FIG. 3. Ensuring that a corresponding value of Conditional Expression (16) is not less than or equal to its lower limit value facilitates suppression of an increase in the total optical length while suppressing various aberrations related to the off-axis luminous flux. Ensuring that the corresponding value of Conditional Expression (16) is not greater than or equal to its upper limit value facilitates correction of the spherical aberration.

$$0.2 < dA 2 / TL < 0.6 \qquad ( 16 )$$

In order to obtain more favorable characteristics, the lower limit value of Conditional Expression (16) is more preferably 0.21, further preferably 0.22, further preferably 0.23, further preferably 0.24, and further preferably 0.25. In order to obtain more favorable characteristics, the upper limit value of Conditional Expression (16) is more preferably 0.58, further preferably 0.56, further preferably 0.54, further preferably 0.52, and further preferably 0.5.

The front group GF preferably includes at least one single lens or cemented lens satisfying Conditional Expression (17). A focal length of one single lens or one cemented lens included in the front group GF is denoted by fLF. Hereinafter, for convenience of description, a single lens or a cemented lens that is included in the front group GF and that satisfies Conditional Expression (17) will be referred to as an LFp lens. Ensuring that a corresponding value of Conditional Expression (17) is not less than or equal to its lower limit value enables the front group GF to include a single lens or a cemented lens having a positive refractive power and thus, achieves an advantage in reducing the total optical length and also facilitates securing of an edge part light quantity. Ensuring that the corresponding value of Conditional Expression (17) is not greater than or equal to its upper limit value prevents an excessively strong positive refractive power of the LFp lens and thus, achieves an advantage in correcting the distortion and the field curvature.

$$0 < f / fLF < 2 \qquad ( 17 )$$

In order to obtain more favorable characteristics, the lower limit value of Conditional Expression (17) is more preferably 0.2. Doing so prevents an excessively weak positive refractive power of the LFp lens and thus, achieves an advantage in reducing the total optical length and also facilitates securing of the edge part light quantity. In order to obtain further favorable characteristics, the lower limit value of Conditional Expression (17) is further preferably 0.3, further preferably 0.4, further preferably 0.45, and further preferably 0.5. In order to obtain more favorable characteristics, the upper limit value of Conditional Expression (17) is more preferably 1.5, further preferably 1.3, further preferably 1.1, further preferably 0.95, and further preferably 0.9.

In a case where a focal length of the front group GF is denoted by fF, the imaging lens preferably satisfies Conditional Expression (18). Ensuring that a corresponding value of Conditional Expression (18) is not less than or equal to its lower limit value prevents an excessively strong negative refractive power of the front group GF and thus, achieves an advantage in reducing the total optical length and also facilitates securing of the edge part light quantity. Ensuring that the corresponding value of Conditional Expression (18) is not greater than or equal to its upper limit value prevents an excessively strong positive refractive power of the front group GF and thus, achieves an advantage in correcting the spherical aberration and the field curvature.

$$- 1.5 < f / fF < 1.5 \qquad ( 18 )$$

In order to obtain more favorable characteristics, the lower limit value of Conditional Expression (18) is more preferably −1.2, further preferably −1, further preferably −0.9, further preferably −0.85, and further preferably −0.8. In order to obtain more favorable characteristics, the upper limit value of Conditional Expression (18) is more preferably 1.2, further preferably 1, further preferably 0.9, further preferably 0.85, and further preferably 0.8.

In a case where a maximum imaging magnification is denoted by 3, the imaging lens preferably satisfies Conditional Expression (19). The maximum imaging magnification is an imaging magnification in imaging the nearest object. Ensuring that a corresponding value of Conditional Expression (19) is not less than or equal to its lower limit value can suppress reduction of an imagable region of the lens system and thus, can secure an added value suitable for the imaging lens. Ensuring that the corresponding value of Conditional Expression (19) is not greater than or equal to its upper limit value can suppress a moving amount of a lens group during focusing and thus, can contribute to reduction of the lens system in size.

$$0.07 < \vert β \vert < 1 \qquad ( 19 )$$

In order to obtain more favorable characteristics, the lower limit value of Conditional Expression (19) is more preferably 0.08, further preferably 0.09, and further preferably 0.1. In order to obtain more favorable characteristics, the upper limit value of Conditional Expression (19) is more preferably 0.6, further preferably 0.35, and further preferably 0.25. The rear group GR preferably includes at least two lenses satisfying Conditional Expression (20). A specific gravity of the lenses included in the rear group GR is denoted by ρr. Ensuring that a corresponding value of Conditional Expression (20) is not less than or equal to its lower limit value enables an easily obtainable material to be used and thus, facilitates implementation of favorable correction of various aberrations. Ensuring that the corresponding value of Conditional Expression (20) is not greater than or equal to its upper limit value achieves an advantage in reducing the rear group GR in weight. The rear group GR more preferably includes at least three lenses satisfying Conditional Expression (20).

$$0.86 < ρ r < 2.2 \qquad ( 20 )$$

In order to obtain more favorable characteristics, the lower limit value of Conditional Expression (20) is more preferably 0.88, further preferably 0.9, and further preferably 0.92. In order to obtain more favorable characteristics, the upper limit value of Conditional Expression (20) is more preferably 2, further preferably 1.8, and further preferably 1.6.

The imaging lens preferably satisfies Conditional Expression (21). Ensuring that a corresponding value of Conditional Expression (21) is not less than or equal to its lower limit value facilitates correction of various aberrations and reduction of the total optical length. Ensuring that the corresponding value of Conditional Expression (21) is not greater than or equal to its upper limit value can secure brightness of the lens system.

$$1.2 < Fno < 3 \qquad ( 21 )$$

In order to obtain more favorable characteristics, the lower limit value of Conditional Expression (21) is more preferably 1.3, further preferably 1.4, and further preferably 1.5. In order to obtain more favorable characteristics, the upper limit value of Conditional Expression (21) is more preferably 2.5, further preferably 2.1, and further preferably 1.9.

The imaging lens preferably satisfies Conditional Expression (22). Setting a surface shape of the lens closest to the object side in the front group GF to satisfy Conditional Expression (22) facilitates suppression of the distortion.

$$- 0.8 < f / RL 1 r < 3 \qquad ( 22 )$$

In order to obtain more favorable characteristics, the lower limit value of Conditional Expression (22) is more preferably −0.5, further preferably 0, further preferably 0.2, further preferably 0.4, further preferably 0.6, further preferably 0.8, and further preferably 1. In order to obtain more favorable characteristics, the upper limit value of Conditional Expression (22) is more preferably 2.7, further preferably 2.4, further preferably 2.1, further preferably 1.8, further preferably 1.7, further preferably 1.6, and further preferably 1.5.

The example illustrated in FIG. 1 is merely an example, and various modifications can be made without departing from the gist of the disclosed technology. For example, positions at which the first aspherical lens LA1 and the second aspherical lens LA2 are disposed may be positions different from those in the example in FIG. 1. The number of first aspherical lenses LA1 and second aspherical lenses LA2 included in the imaging lens may be a number different from that in the example in FIG. 1. The number of lenses included in the front group GF and in the rear group GR may be a number different from that in the example in FIG. 1. The sign of the refractive power of the front group GF may be positive or negative. The sign of the refractive power of the rear group GR may be positive or negative.

While focusing is performed by moving the entire imaging lens in an integrated manner in the example in FIG. 1, the imaging lens of the present disclosure may adopt other focusing methods. In the present specification, the expression “moving in an integrated manner” means moving by the same amount in the same direction at the same time. A bracket under the imaging lens in FIG. 1 indicates a lens group that moves during the focusing, and an arrow provided to the bracket indicates a moving direction during the focusing from the infinite distance object to the short range object.

The imaging lens of the present disclosure may adopt a front focus method. For example, the rear group GR may be configured to consist of, in order from the object side to the image side, a first subsequent lens group and a second subsequent lens group, in which, during the focusing, the front group GF, the aperture stop St, and the first subsequent lens group move in an integrated manner, and the second subsequent lens group is fixed with respect to the image plane Sim. Moving only a part of the lenses during the focusing achieves an advantage in high-speed focusing compared to moving all of the lenses.

The imaging lens of the present disclosure may also adopt an inner focus method. For example, the rear group GR may be configured to consist of, in order from the object side to the image side, the first subsequent lens group and the second subsequent lens group, in which, during the focusing, only the first subsequent lens group moves. Doing so achieves an advantage in high-speed focusing.

The rear group GR may also be configured to consist of, in order from the object side to the image side, the first subsequent lens group, the second subsequent lens group, and a third subsequent lens group, in which, during the focusing, only the second subsequent lens group moves. Doing so also achieves an advantage in high-speed focusing.

In a case where the imaging lens includes only one lens group that moves during the focusing, an advantage in simplifying a drive mechanism is achieved. The imaging lens of the present disclosure may be configured to include two lens groups that move by changing a mutual spacing during the focusing. Doing so achieves an advantage in suppressing fluctuation of aberrations during the focusing.

The preferable configurations and available configurations described above can be combined in any manner without inconsistency and are preferably selectively adopted, as appropriate, in accordance with required specifications.

For example, according to a preferable aspect of the imaging lens of the present disclosure, the imaging lens consists of, in order from the object side to the image side, the front group GF including one or more lenses, the aperture stop St, and the rear group GR including a plurality of lenses, in which at least one first aspherical lens LA1 that has a concave surface facing the image side in the paraxial region and that has, on a lens surface on the image side, the inflection point at which the convex or concave shape changes in the middle of the lens surface from the position on the optical axis to the edge part is disposed in the rear group GR, the imaging lens includes at least one lens satisfying Conditional Expression (2), and Conditional Expression (1) is satisfied.

According to another preferable aspect of the imaging lens of the present disclosure, in the configuration of the preferable aspect, the lens closest to the object side in the front group GF satisfies Conditional Expression (2), and Conditional Expressions (3-2), (4-2), (7), and (9-1) are satisfied.

Next, examples of the imaging lens of the present disclosure will be described with reference to the drawings. Reference numerals provided to the lenses in the cross-sectional view of each example are independently used for each example in order to avoid complication of description and the drawings caused by an increasing number of digits of the reference numerals. Accordingly, even in a case where a common reference numeral is provided in the drawings of different examples, the common reference numeral does not necessarily indicate a common configuration.

### Example 1

A cross-sectional view of a configuration of the imaging lens of Example 1 is illustrated in FIG. 1, and its illustration method and configuration are the same as described above. Thus, duplicate descriptions will be partially omitted. The imaging lens of Example 1 consists of, in order from the object side to the image side, the front group GF, the aperture stop St, and the rear group GR. During the focusing from the infinite distance object to the short range object, the entire imaging lens moves to the object side in an integrated manner.

For the imaging lens of Example 1, Table 1 shows basic lens data, Table 2 shows specifications and a variable surface spacing, and Table 3 shows aspherical coefficients.

The table of the basic lens data is described as follows. A column of “Sn” shows surface numbers in a case where the number is increased by one at a time toward the image side from the surface closest to the object side as a first surface. A column of “R” shows a curvature radius of each surface. A column of “D” shows a surface spacing on the optical axis between each surface and its adjacent surface on the image side. A column of “Nd” shows a refractive index with respect to the d line for each lens. A column of “νd” shows an Abbe number based on the d line for each lens.

A column of “Material” in the table of the basic lens data, including the tables of the examples described later, is described as follows. In the column of “Material”, “Plastic” indicates a lens of which a material is a resin. For a lens of a material other than a resin, a material name is shown in an upper part of a field, and a name of a manufacturing company is shown in a lower part of the field. In the table, the name of the manufacturing company is schematically shown as follows. “OHARA” indicates OHARA INC. “CDGM” indicates Chengdu Guangming Guangdian Co., Ltd. “HIKARI” indicates HIKARI GLASS Co., Ltd. “HOYA” indicates HOYA Corporation. In addition, in the column of “Material”, “(LA1)” indicates a lens corresponding to the first aspherical lens LA1, and “(LA2)” indicates a lens corresponding to the second aspherical lens LA2.

A column of “ED” shows an effective diameter of each surface. A column of “Nd+0.01×νd” shows the corresponding value of Conditional Expression (11) for each lens. A column of “ρr” shows the specific gravity, that is, the corresponding value of Conditional Expression (20), for each lens. A column of “(dN/dT)×10⁻⁶” shows a temperature coefficient of a refractive index with respect to the d line at 25° C., that is, the corresponding value of Conditional Expression (2), for each lens. In the columns of “ED”, “ρr”, and “(dN/dT)×10⁻⁶”, including the tables of the examples described later, a part of surfaces and lenses not related to the conditional expressions is omitted.

In the table of the basic lens data, a sign of the curvature radius of the surface having a convex shape facing the object side is positive, and a sign of the curvature radius of the surface having a convex shape facing the image side is negative. A field of the surface number of the surface corresponding to the aperture stop St has the surface number and a text (St). A value in the lowermost field of the column of D in the table indicates a spacing between the surface closest to the image side in the table and the image plane Sim. The variable surface spacing during the focusing is denoted by a symbol DD, and the surface number of the surface on the object side of this spacing is added after DD in the column of the surface spacing.

Table 2 shows the focal length, the back focus, the open F-number, a maximum full angle of view, and the variable surface spacing based on the d line. In a field of the maximum full angle of view, [° ] indicates a degree unit. In Table 2, each value in the state where the infinite distance object is in focus is shown in a column of “Infinite Distance”, and each value in the state where the nearest object is in focus is shown in a column of “Short Range”. The focal length indicates only a value in the state where the infinite distance object is in focus. In a field of “Short Range”, an absolute value of the maximum imaging magnification is shown with “Times”.

In the basic lens data, a surface number of an aspherical surface is marked with *, and a numerical value of a paraxial curvature radius is shown in a field of the curvature radius of the aspherical surface. In Table 3, the column of Sn shows the surface number of the aspherical surface, and columns of KA and Am show a numerical value of the aspherical coefficient for each aspherical surface. Here, m of Am is an integer greater than or equal to 3 and varies depending on the surface. For example, for the first surface of Example 1, m=4, 6, 8, and 10 is established. In the numerical value of the aspherical coefficient in Table 3, “E±n” (n: integer) means “×10^{±n}”. KA and Am are aspherical coefficients in an aspheric equation represented by the following expression.

$$Zd = C \times {h}^{2} / \{ 1 + {( 1 - KA \times {C}^{2} \times {h}^{2} )}^{1 / 2} \} + Σ Am \times {h}^{m}$$

where
Zd: an aspherical depth (a length of a perpendicular line drawn from a point on an aspherical surface at a height h to a plane that is in contact with an aspherical surface apex and that is perpendicular to the optical axis Z)
h: a height (a distance from the optical axis Z to a lens surface)
C: a reciprocal of a paraxial curvature radius
KA and Am: aspherical coefficients
Σ in the aspheric equation means a sum total related to m.

In the data of each table, a degree unit is used for angles, and a millimeter (mm) unit is used for lengths. However, since the optical system can also be proportionally enlarged or proportionally reduced to be used, other appropriate units can also be used. Numerical values rounded to predetermined digits are described in each table shown below.

TABLE 1
Example 1

| Sn | R | D | Nd | νd | Material | ED | Nd + 0.01 × νd | ρr | (dN/dT) × 10⁻⁶ |
|---|---|---|---|---|---|---|---|---|---|
| *1 | 20.5162 | 0.9998 | 1.58913 | 61.15 | L-BAL35 | | 2.201 | 2.82 | 4.6 |
| | | | | | OHARA | | | | |
| *2 | 8.2829 | 6.7271 | | | | | | | |
| 3 (St) | ∞ | 2.3106 | | | | | | | |
| 4 | 14.0979 | 5.3335 | 1.61800 | 63.32 | S-PHM52Q | | 2.251 | 3.51 | −0.7 |
| | | | | | OHARA | | | | |
| 5 | −7.9734 | 0.7876 | 1.66672 | 48.32 | S-BAH11 | | 2.150 | 3.59 | 4.1 |
| | | | | | OHARA | | | | |
| 6 | −18.5097 | 6.0071 | | | | | | | |
| *7 | −26.0806 | 0.7998 | 1.53409 | 55.87 | Plastic | | 2.093 | 1.01 | |
| *8 | −20.3336 | 0.3000 | | | | | | | |
| *9 | −8.0365 | 2.1185 | 1.66121 | 20.35 | Plastic | 14.38 | 1.865 | 1.23 | |
| | | | | | (LA2) | | | | |
| *10 | −12.2010 | 2.5002 | | | | 17.20 | | | |
| *11 | 16.8225 | 6.7054 | 1.53409 | 55.87 | Plastic | 28.72 | 2.093 | 1.01 | |
| | | | | | (LA1) | | | | |
| *12 | 19.5681 | DD[12] | | | | 33.14 | | | |

TABLE 2
Example 1

| | Infinite | Short Range |
|---|---|---|
| | Distance | 0.11 Times |
| Focal Length | 20.68 | — |
| Back Focus | 11.51 | 13.78 |
| Open F-Number | 2.89 | 3.11 |
| Maximum Full Angle of View [°] | 99.8 | 96.0 |
| DD[12] | 11.51 | 13.78 |

TABLE 3
Example 1

| Sn | 1 | 2 |
|---|---|---|
| KA | 1.0000000E+00 | 1.0000000E+00 |
| A4 | −1.3167432E−05 | 6.5646999E−06 |
| A6 | −1.2251771E−06 | −1.3434549E−06 |
| A8 | 1.1780018E−08 | −2.1298084E−08 |
| A10 | −3.8977499E−11 | 1.9008191E−10 |

| Sn | 7 | 8 | 9 | 10 |
|---|---|---|---|---|
| KA | 1.0000000E+00 | 1.0000000E+00 | 1.0000000E+00 | 1.0000000E+00 |
| A4 | −6.3233767E−04 | −8.6143892E−04 | 1.1159917E−03 | 8.6997349E−04 |
| A6 | −1.2786832E−05 | 7.0110929E−06 | 8.0436650E−07 | −3.0715650E−06 |
| A8 | 2.3804036E−07 | −2.0445557E−07 | −1.4453133E−07 | −1.3256406E−08 |
| A10 | −5.6229264E−09 | −7.8507677E−10 | −6.5957084E−10 | −7.2321132E−11 |
| A12 | −2.7023912E−11 | 5.4294360E−11 | 3.3588296E−11 | 4.7798905E−13 |
| A14 | 5.9856866E−12 | 4.4277484E−13 | 6.1352560E−13 | 1.4265350E−14 |
| A16 | −1.2651196E−13 | −5.1478260E−15 | −6.6982080E−15 | 1.0940027E−16 |
| A18 | 2.3781086E−15 | 3.7803905E−16 | −3.6297185E−16 | −9.1229758E−19 |
| A20 | −2.2378325E−17 | −4.2483259E−18 | 5.2330548E−18 | −6.6762314E−21 |

| Sn | 11 | 12 |
|---|---|---|
| KA | 1.0000000E+00 | 1.0000000E+00 |
| A4 | −3.2849858E−04 | −2.4030786E−04 |
| A6 | 1.9643340E−06 | 1.1689066E−06 |
| A8 | −6.9123666E−09 | −6.6326708E−09 |
| A10 | 5.1632105E−12 | 2.7435148E−11 |
| A12 | 4.2012361E−14 | −6.4206996E−14 |
| A14 | −1.5444156E−16 | 2.8398249E−17 |
| A16 | −2.0480926E−20 | 9.8509976E−20 |
| A18 | 1.6595862E−21 | 3.5408184E−22 |
| A20 | −4.5974126E−24 | −1.2800377E−24 |

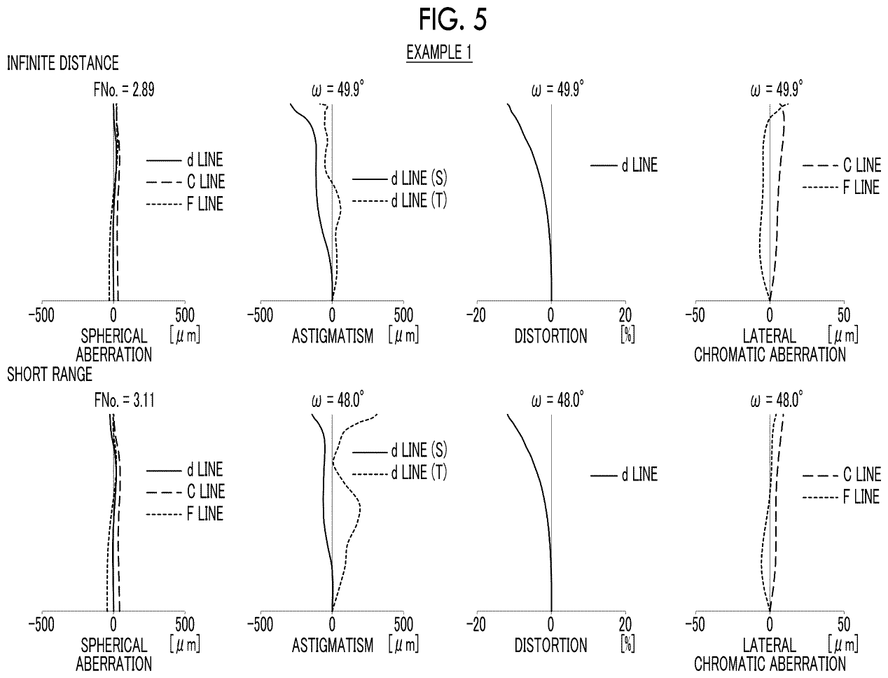

Each aberration diagram of the imaging lens of Example 1 is illustrated in FIG. 5. In FIG. 5, the spherical aberration, the astigmatism, the distortion, and the lateral chromatic aberration are illustrated in this order from the left. In FIG. 5, each aberration diagram in the state where the infinite distance object is in focus is illustrated in an upper part labeled “INFINITE DISTANCE”, and each aberration diagram in the state where the nearest object is in focus is illustrated in a lower part labeled “SHORT RANGE”. In the spherical aberration diagram, aberrations on the d line, a C line, and an F line are illustrated by a solid line, a long broken line, and a short broken line, respectively. In the astigmatism diagram, an aberration on the d line in a sagittal direction is illustrated by a solid line, and an aberration on the d line in a tangential direction is illustrated by a short broken line. In the distortion diagram, an aberration on the d line is illustrated by a solid line. In the lateral chromatic aberration diagram, aberrations on the C line and the F line are illustrated by a long broken line and a short broken line, respectively. In the spherical aberration diagram, a value of the open F-number is shown after “FNo.=”. In other aberration diagrams, a value of the maximum half angle of view is shown after “ω=”.

Symbols, meanings, description methods, and illustration methods of each data related to Example 1 are basically the same for the following examples unless otherwise specified. Thus, duplicate descriptions will be omitted below.

### Example 2

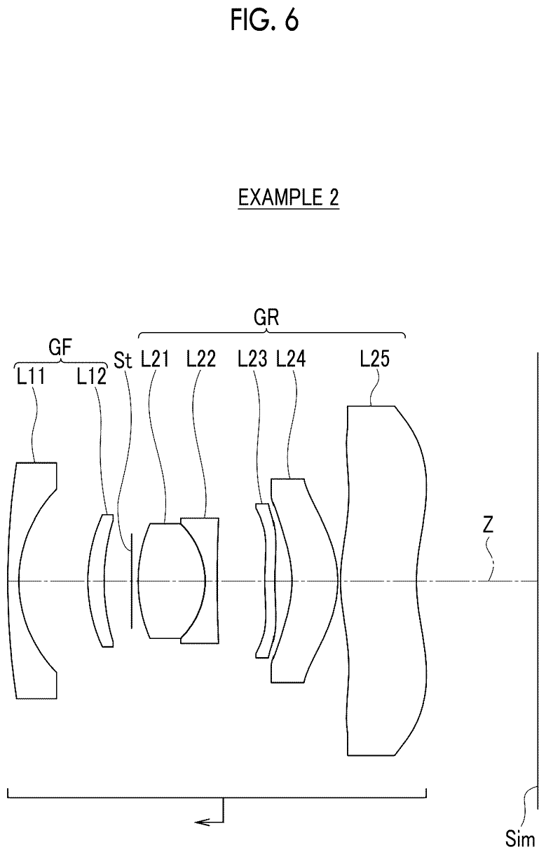

A cross-sectional view of a configuration of an imaging lens of Example 2 is illustrated in FIG. 6. The imaging lens of Example 2 consists of, in order from the object side to the image side, the front group GF, the aperture stop St, and the rear group GR. The front group GF consists of two lenses including lenses L11 and L12 in order from the object side to the image side. The lens L12 corresponds to the LFp lens. The rear group GR consists of five lenses including the lenses L21 to L25 in order from the object side to the image side. During the focusing from the infinite distance object to the short range object, the entire imaging lens moves to the object side in an integrated manner.

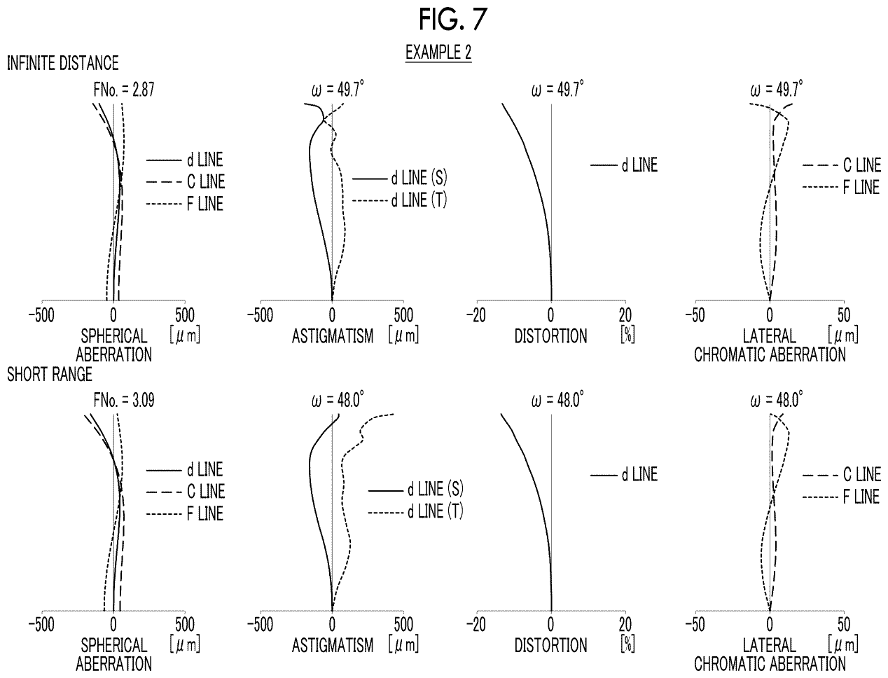

For the imaging lens of Example 2, Table 4 shows basic lens data, Table 5 shows specifications and a variable surface spacing, Table 6 shows aspherical coefficients, and FIG. 7 illustrates each aberration diagram.

TABLE 4
Example 2

| Sn | R | D | Nd | νd | Material | ED | Nd + 0.01 × νd | ρr | (dN/dT) × 10⁻⁶ |
|---|---|---|---|---|---|---|---|---|---|
| 1 | 79.2828 | 0.9998 | 1.48749 | 70.24 | S-FSL5 | | 2.18989 | | −0.8 |
| | | | | | OHARA | | | | |
| 2 | 12.7684 | 6.2502 | | | | | | | |
| 3 | 15.6183 | 1.4683 | 1.76182 | 26.52 | S-TIH14 | | 2.02702 | | 2.0 |
| | | | | | OHARA | | | | |
| 4 | 20.8518 | 2.5002 | | | | | | | |
| 5 (St) | ∞ | 0.5892 | | | | | | | |
| 6 | 14.5229 | 6.0501 | 1.67790 | 55.35 | S-LAL12Q | | 2.23140 | 3.59 | 6.0 |
| | | | | | OHARA | | | | |
| 7 | −7.8408 | 1.0990 | 1.67270 | 32.10 | S-TIM25 | | 1.99370 | 2.91 | 2.9 |
| | | | | | OHARA | | | | |
| 8 | 141.9701 | 4.3073 | | | | | | | |
| *9 | 27.5285 | 0.8571 | 1.66121 | 20.35 | Plastic | 13.82 | 1.86471 | 1.23 | |
| | | | | | (LA1) | | | | |
| *10 | 28.2230 | 1.5549 | | | | 14.60 | | | |
| *11 | −10.7866 | 4.1448 | 1.53409 | 55.87 | Plastic | 15.27 | 2.09279 | 1.01 | |
| | | | | | (LA2) | | | | |
| *12 | 10.6016 | 0.2501 | | | | 19.34 | | | |
| *13 | 17.6996 | 6.8647 | 1.53409 | 55.87 | Plastic | 28.92 | 2.09279 | 1.01 | |
| | | | | | (LA1) | | | | |
| *14 | 17.8569 | DD[14] | | | | 33.07 | | | |

TABLE 5
Example 2

| | Infinite | Short Range |
|---|---|---|
| | Distance | 0.11 Times |
| Focal Length | 21.16 | — |
| Back Focus | 11.00 | 13.32 |
| Open F-Number | 2.87 | 3.09 |
| Maximum Full Angle of View [°] | 99.4 | 96.0 |
| DD[14] | 11.00 | 13.32 |

TABLE 6
Example 2

| Sn | 9 | 10 | 11 | 12 |
|---|---|---|---|---|
| KA | 1.0000000E+00 | 1.0000000E+00 | 1.0000000E+00 | 1.0000000E+00 |
| A4 | −9.4202188E−04 | −8.3447218E−04 | 6.4195073E−04 | 2.1048126E−04 |
| A6 | 2.2902923E−06 | 6.3268970E−06 | −6.3901372E−06 | 4.2543409E−07 |
| A8 | 1.1065841E−07 | −5.1539608E−08 | 3.9671196E−08 | 4.0589840E−09 |
| A10 | −5.8006896E−09 | −8.0005770E−10 | 1.9399374E−10 | 1.2802511E−10 |
| A12 | 1.8956313E−11 | 4.1021412E−11 | −4.3740498E−12 | −1.7569805E−13 |
| A14 | 5.6828274E−12 | −2.3714662E−13 | 4.5339245E−15 | −3.4075556E−15 |
| A16 | −1.3843708E−13 | 4.2716406E−15 | 1.6140076E−16 | −3.1028050E−17 |
| A18 | 1.2754375E−15 | −1.1400039E−16 | −1.9157061E−17 | 8.3022346E−20 |
| A20 | −4.3114034E−18 | 8.4646871E−19 | 4.0578767E−19 | 4.9304805E−21 |

| Sn | 13 | 14 |
|---|---|---|
| KA | 1.0000000E+00 | 1.0000000E+00 |
| A4 | −3.9402241E−04 | −3.2364270E−04 |
| A6 | 2.0009014E−06 | 1.6611644E−06 |
| A8 | −4.9120370E−09 | −8.3703939E−09 |
| A10 | 2.4642382E−13 | 2.7011477E−11 |
| A12 | 2.2694036E−14 | −5.0687005E−14 |
| A14 | −2.8898331E−17 | 2.8364986E−17 |
| A16 | 2.4321344E−20 | 1.0926441E−21 |
| A18 | −8.0681215E−23 | 4.7488492E−23 |
| A20 | −3.5139142E−25 | 8.6337444E−26 |

### Example 3

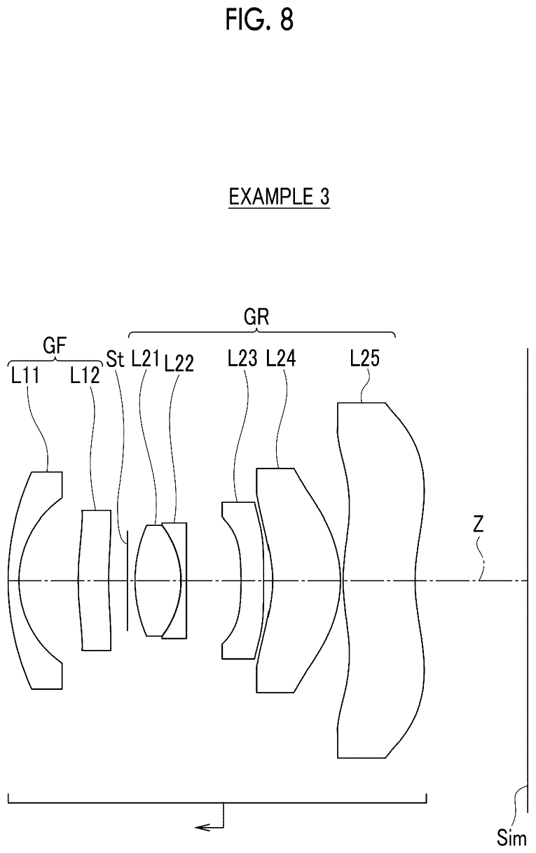

A cross-sectional view of a configuration of an imaging lens of Example 3 is illustrated in FIG. 8. The imaging lens of Example 3 consists of, in order from the object side to the image side, the front group GF, the aperture stop St, and the rear group GR. The front group GF consists of two lenses including the lenses L11 and L12 in order from the object side to the image side. The lens L12 corresponds to the LFp lens. The rear group GR consists of five lenses including the lenses L21 to L25 in order from the object side to the image side. During the focusing from the infinite distance object to the short range object, the entire imaging lens moves to the object side in an integrated manner.

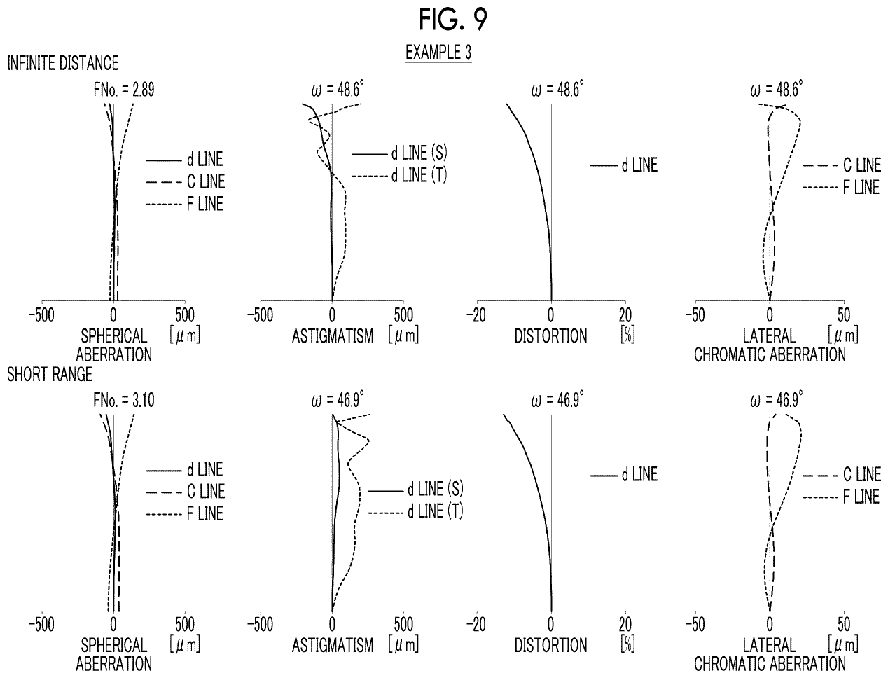

For the imaging lens of Example 3, Table 7 shows basic lens data, Table 8 shows specifications and a variable surface spacing, Table 9 shows aspherical coefficients, and FIG. 9 illustrates each aberration diagram.

TABLE 7
Example 3

| Sn | R | D | Nd | νd | Material | ED | Nd + 0.01 × νd | ρr | (dN/dT) × 10⁻⁶ |
|---|---|---|---|---|---|---|---|---|---|
| 1 | 24.6332 | 0.9998 | 1.48749 | 70.24 | S-FSL5 | | 2.18989 | | −0.8 |
| | | | | | OHARA | | | | |
| 2 | 9.4336 | 5.5067 | | | | | | | |
| *3 | 26.8012 | 2.8240 | 1.63894 | 22.97 | Plastic | | 1.86864 | | |
| *4 | 35.0370 | 1.7482 | | | | | | | |
| 5 (St) | ∞ | 0.6986 | | | | | | | |
| 6 | 12.9773 | 4.2665 | 1.69680 | 55.53 | S-LAL14 | | 2.25210 | 3.70 | 4.1 |
| | | | | | OHARA | | | | |
| 7 | −8.5172 | 0.5032 | 1.62004 | 36.26 | S-TIM2 | | 1.98264 | 2.69 | 2.8 |
| | | | | | OHARA | | | | |
| 8 | 14634.1425 | 5.0668 | | | | | | | |
| *9 | −43.9849 | 2.0948 | 1.66121 | 20.35 | Plastic | 11.85 | 1.86471 | 1.23 | |
| | | | | | (LA1) | | | | |
| *10 | 4290.9147 | 0.8003 | | | | 14.60 | | | |
| *11 | −11.7392 | 6.2826 | 1.53409 | 55.87 | Plastic | 15.42 | 2.09279 | 1.01 | |
| | | | | | (LA2) | | | | |
| *12 | −11.4331 | 0.2498 | | | | 20.92 | | | |
| *13 | 17.8224 | 6.6817 | 1.53409 | 55.87 | Plastic | 28.94 | 2.09279 | 1.01 | |
| | | | | | (LA1) | | | | |
| *14 | 17.3424 | DD[14] | | | | 33.08 | | | |

TABLE 8
Example 3

| | Infinite | Short Range |
|---|---|---|
| | Distance | 0.11 Times |
| Focal Length | 21.72 | — |
| Back Focus | 10.45 | 12.84 |
| Open F-Number | 2.89 | 3.10 |
| Maximum Full Angle of View [°] | 97.2 | 93.8 |
| DD[14] | 10.45 | 12.84 |

TABLE 9
Example 3

| Sn | 3 | 4 |
|---|---|---|
| KA | 1.0000000E+00 | 1.0000000E+00 |
| A4 | −1.9160764E−04 | −2.5841677E−04 |
| A6 | −1.4782362E−06 | −1.4074127E−06 |
| A8 | −4.3650397E−09 | 3.4605164E−08 |
| A10 | 2.2359000E−10 | −1.9376686E−11 |

| Sn | 9 | 10 | 11 |
|---|---|---|---|
| KA | 1.0000000E+00 | 1.0000000E+00 | 1.0000000E+00 |
| A4 | −1.0531377E−03 | −5.8222613E−04 | 7.0062142E−04 |
| A6 | −4.8673198E−06 | 6.4478991E−06 | −6.9335471E−06 |
| A8 | 3.5217750E−07 | −5.2502723E−08 | −2.5161434E−08 |
| A10 | −1.1610992E−08 | −1.0971443E−09 | 1.8121484E−09 |
| A12 | −1.4630897E−10 | 3.8683513E−11 | −4.5480305E−12 |
| A14 | 1.0327771E−11 | −3.5999404E−14 | −1.0325235E−13 |
| A16 | −3.5813406E−14 | 4.6444047E−15 | −3.9107910E−15 |
| A18 | 5.6601985E−16 | −1.5115284E−16 | 1.1048723E−16 |
| A20 | −4.2089115E−17 | 6.1868619E−19 | −8.6025374E−19 |
| Sn | 12 | 13 | 14 |
| KA | 1.0000000E+00 | 1.0000000E+00 | 1.0000000E+00 |
| A4 | 3.9033151E−05 | −4.4364713E−04 | −3.5259370E−04 |
| A6 | 1.4755671E−07 | 2.0565546E−06 | 1.7398059E−06 |
| A8 | 1.1969426E−08 | −4.6439821E−09 | −8.5206125E−09 |
| A10 | 2.4750226E−11 | −9.8391560E−14 | 2.6452966E−11 |
| A12 | 2.1218490E−13 | 2.3611197E−14 | −4.7831990E−14 |
| A14 | −4.0459229E−15 | −1.2520187E−17 | 1.8555684E−17 |
| A16 | 1.8319458E−18 | 3.0809298E−20 | 3.0990616E−20 |
| A18 | −1.5013949E−19 | −1.8653153E−22 | 1.1174399E−23 |
| A20 | 1.7946440E−21 | −7.9312713E−25 | −2.0984946E−26 |

### Example 4

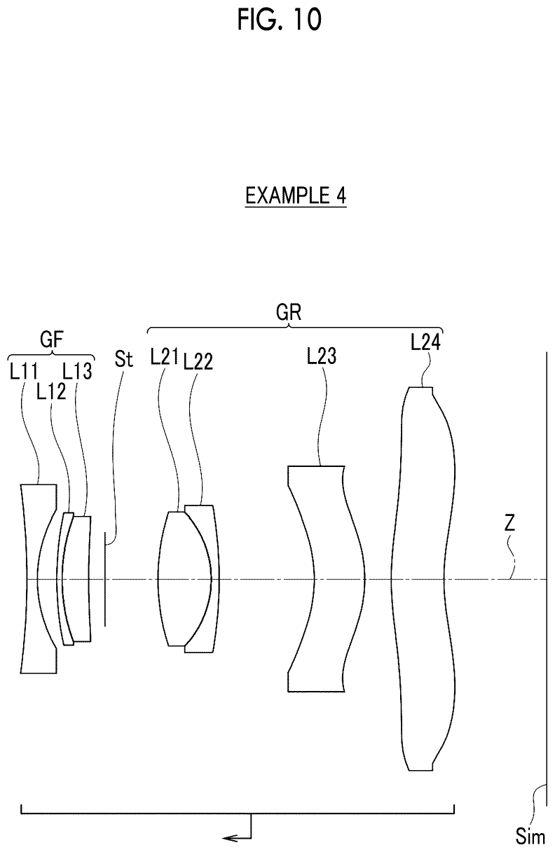

A cross-sectional view of a configuration of an imaging lens of Example 4 is illustrated in FIG. 10. The imaging lens of Example 4 consists of, in order from the object side to the image side, the front group GF, the aperture stop St, and the rear group GR. The front group GF consists of three lenses including lenses L11 to L13 in order from the object side to the image side. A cemented lens in which the lens L12 and the lens L13 are cemented corresponds to the LFp lens. The rear group GR consists of four lenses including the lenses L21 to L24 in order from the object side to the image side. During the focusing from the infinite distance object to the short range object, the entire imaging lens moves to the object side in an integrated manner.

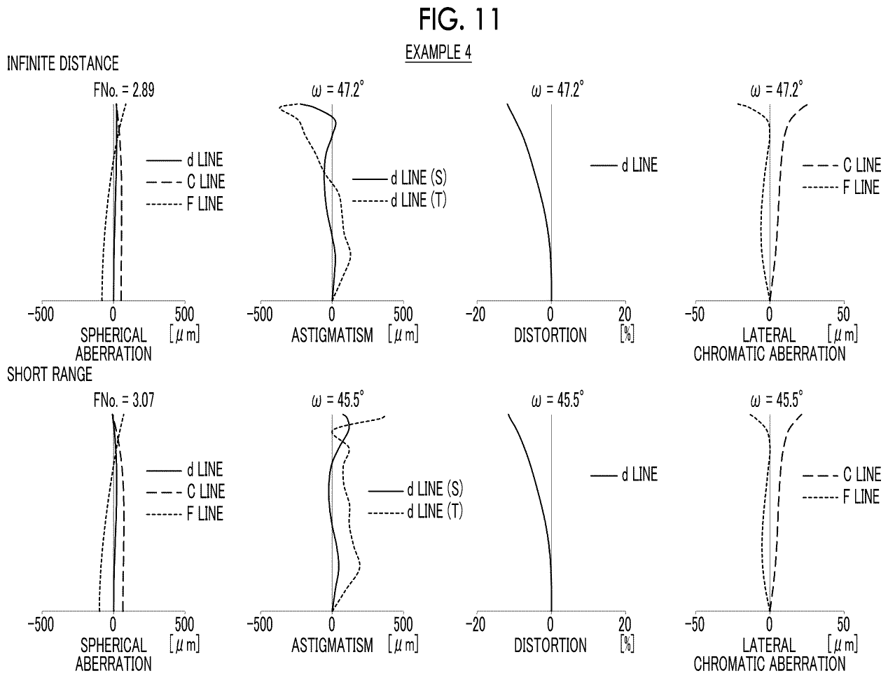

For the imaging lens of Example 4, Table 10 shows basic lens data, Table 11 shows specifications and a variable surface spacing, Table 12 shows aspherical coefficients, and FIG. 11 illustrates each aberration diagram.

TABLE 10
Example 4

| Sn | R | D | Nd | νd | Material | ED | Nd + 0.01 × νd | ρr | (dN/dT) × 10⁻⁶ |
|---|---|---|---|---|---|---|---|---|---|
| 1 | −67.3926 | 0.9998 | 1.48749 | 70.24 | S-FSL5 | | 2.18989 | | −0.8 |
| | | | | | OHARA | | | | |
| 2 | 13.1242 | 1.8332 | | | | | | | |
| 3 | 30.3022 | 0.5100 | 1.61340 | 44.27 | S-NBM51 | | 2.05610 | | 4.0 |
| | | | | | OHARA | | | | |
| 4 | 17.2054 | 2.5132 | 1.88300 | 39.22 | H-ZLAF68N | | 2.27520 | | 3.4 |
| | | | | | CDGM | | | | |
| 5 | 81.3605 | 1.5510 | | | | | | | |
| 6 (St) | ∞ | 5.0225 | | | | | | | |
| 7 | 20.8464 | 5.0490 | 1.69680 | 55.53 | S-LAL14 | | 2.25210 | 3.70 | 4.1 |
| | | | | | OHARA | | | | |
| 8 | −9.3855 | 0.7502 | 1.69895 | 30.13 | S-TIM35 | | 2.00025 | 2.96 | 3.6 |
| | | | | | OHARA | | | | |
| 9 | −40.5606 | 8.9675 | | | | | | | |
| *10 | −13.3317 | 4.7867 | 1.54436 | 56.03 | Plastic | 17.79 | 2.10466 | 1.04 | |
| | | | | | (LA2) | | | | |
| *11 | −12.4718 | 2.5002 | | | | 21.52 | | | |
| *12 | 25.5809 | 4.9999 | 1.54436 | 56.03 | Plastic | 32.85 | 2.10466 | 1.04 | |
| | | | | | (LA1) | | | | |
| *13 | 19.2430 | DD[13] | | | | 35.21 | | | |

TABLE 11
Example 4

| | Infinite | Short Range |
|---|---|---|
| | Distance | 0.11 Times |
| Focal Length | 22.76 | — |
| Back Focus | 9.75 | 12.26 |
| Open F-Number | 2.89 | 3.07 |
| Maximum Full Angle of View [°] | 94.4 | 91.0 |
| DD[13] | 9.75 | 12.26 |

TABLE 12
Example 4

| Sn | 10 | 11 | 12 | 13 |
|---|---|---|---|---|
| KA | 1.0000000E+00 | 1.0000000E+00 | 1.0000000E+00 | 1.0000000E+00 |
| A4 | 7.5613282E−05 | 1.2930171E−04 | −2.0819015E−04 | −2.6771759E−04 |
| A6 | 1.7251074E−06 | 1.1126147E−06 | 1.3131766E−06 | 1.3791550E−06 |
| A8 | −7.2131810E−10 | 2.2617383E−08 | −4.6589232E−09 | −6.2334901E−09 |
| A10 | −1.6922017E−10 | −2.6279418E−10 | 3.9640967E−12 | 1.8799778E−11 |
| A12 | 6.4137446E−13 | 9.0360193E−13 | 1.7947030E−14 | −3.8349563E−14 |
| A14 | 0.0000000E+00 | 0.0000000E+00 | −3.2594142E−17 | 3.5868486E−17 |

### Example 5

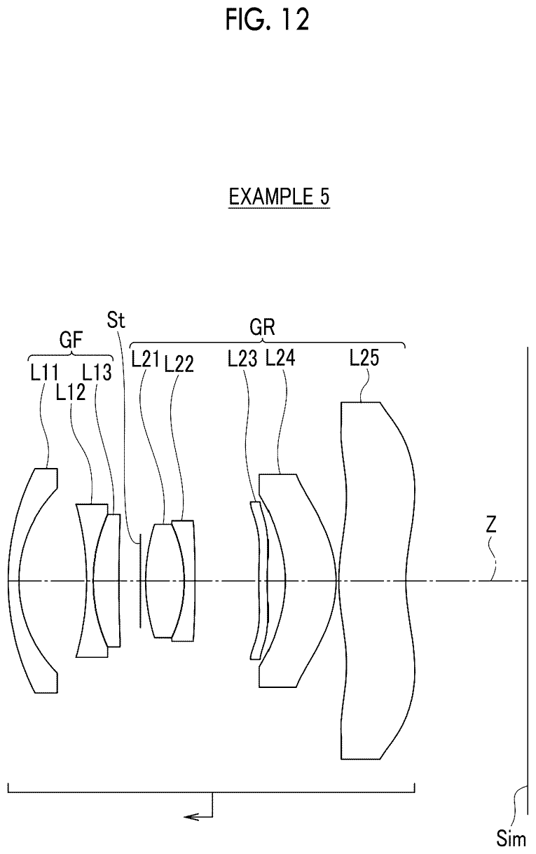

A cross-sectional view of a configuration of an imaging lens of Example 5 is illustrated in FIG. 12. The imaging lens of Example 5 consists of, in order from the object side to the image side, the front group GF, the aperture stop St, and the rear group GR. The front group GF consists of three lenses including the lenses L11 to L13 in order from the object side to the image side. A cemented lens in which the lens L12 and the lens L13 are cemented corresponds to the LFp lens. The rear group GR consists of five lenses including the lenses L21 to L25 in order from the object side to the image side. During the focusing from the infinite distance object to the short range object, the entire imaging lens moves to the object side in an integrated manner.

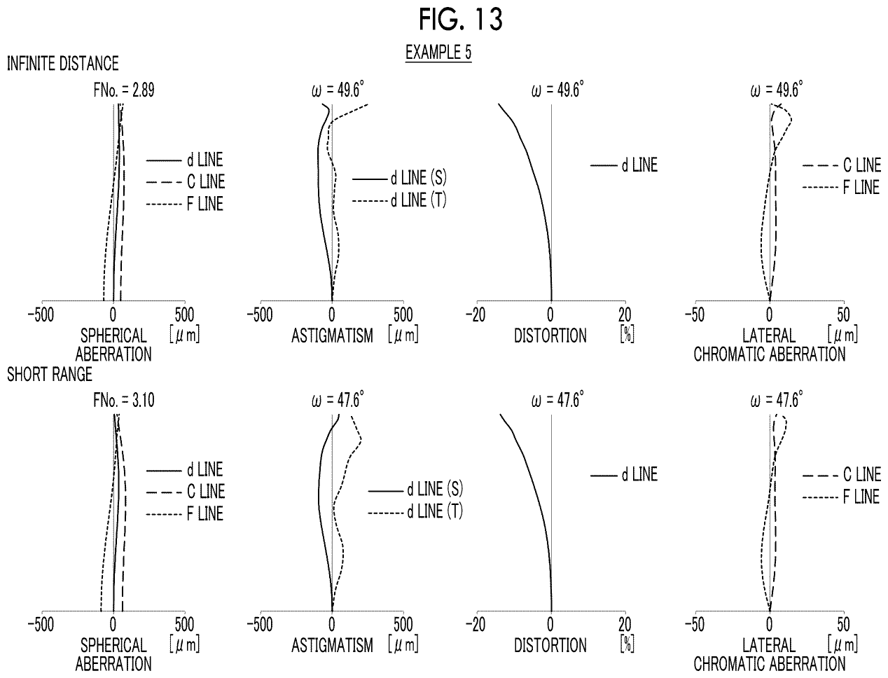

For the imaging lens of Example 5, Table 13 shows basic lens data, Table 14 shows specifications and a variable surface spacing, Table 15 shows aspherical coefficients, and FIG. 13 illustrates each aberration diagram.

TABLE 13
Example 5

| Sn | R | D | Nd | νd | Material | ED | Nd + 0.01 × νd | ρr | (dN/dT) × 10⁻⁶ |
|---|---|---|---|---|---|---|---|---|---|
| 1 | 23.1563 | 1.0000 | 1.48749 | 70.24 | S-FSL5 | | 2.18989 | | −0.8 |
| | | | | | OHARA | | | | |
| 2 | 12.1182 | 6.2501 | | | | | | | |
| 3 | −26.2300 | 0.6100 | 1.48749 | 70.24 | S-FSL5 | | 2.18989 | | −0.8 |
| | | | | | OHARA | | | | |
| 4 | 14.8395 | 2.3690 | 1.89190 | 37.13 | S-LAH92 | | 2.26320 | | 5.2 |
| | | | | | OHARA | | | | |
| 5 | 138.8157 | 1.9780 | | | | | | | |
| 6 (St) | ∞ | 0.5002 | | | | | | | |
| 7 | 17.3138 | 3.5605 | 1.75500 | 52.32 | S-LAH97 | | 2.27820 | 4.17 | 4.1 |
| | | | | | OHARA | | | | |
| 8 | −12.6761 | 1.0000 | 1.84666 | 23.78 | S-TIH53W | | 2.08446 | 3.54 | 1.3 |
| | | | | | OHARA | | | | |
| 9 | −98.1975 | 5.8833 | | | | | | | |
| *10 | 36.4162 | 0.7744 | 1.66121 | 20.35 | Plastic | 14.17 | 1.86471 | 1.23 | |
| | | | | | (LA1) | | | | |
| *11 | 34.2811 | 1.6348 | | | | 14.60 | | | |
| *12 | −11.4365 | 4.6825 | 1.53409 | 55.87 | Plastic | 14.98 | 2.09279 | 1.01 | |
| | | | | | (LA2) | | | | |
| *13 | −10.7325 | 0.2500 | | | | 19.77 | | | |
| *14 | 17.2280 | 6.1987 | 1.53409 | 55.87 | Plastic | 28.58 | 2.09279 | 1.01 | |
| | | | | | (LA1) | | | | |
| *15 | 17.4962 | DD[15] | | | | 32.37 | | | |

TABLE 14
Example 5

| | Infinite | Short Range |
|---|---|---|
| | Distance | 0.11 Times |
| Focal Length | 21.48 | — |
| Back Focus | 11.26 | 13.63 |
| Open F-Number | 2.89 | 3.10 |
| Maximum Full Angle of View [°] | 99.2 | 95.2 |
| DD[15] | 11.26 | 13.63 |

TABLE 15
Example 5

| Sn | 10 | 11 | 12 |
|---|---|---|---|
| KA | 1.0000000E+00 | 1.0000000E+00 | 1.0000000E+00 |
| A4 | −9.1409003E−04 | −8.6259471E−04 | 4.7467658E−04 |
| A6 | 3.6813492E−06 | 6.4681427E−06 | −7.2460751E−06 |
| A8 | 1.1988325E−07 | −4.4793554E−08 | 4.5127126E−08 |
| A10 | −5.5417481E−09 | −8.4025356E−10 | 4.4279957E−10 |
| A12 | 1.7339970E−11 | 4.0171151E−11 | −3.6592889E−12 |
| A14 | 5.7216376E−12 | −1.4084306E−13 | −4.4478283E−14 |
| A16 | −1.3930910E−13 | 4.5267753E−15 | −4.1223715E−16 |
| A18 | 1.2976777E−15 | −1.0651986E−16 | −2.1009060E−17 |
| A20 | −4.8018446E−18 | 3.9686163E−19 | 4.7997396E−19 |
| Sn | 13 | 14 | 15 |
| KA | 1.0000000E+00 | 1.0000000E+00 | 1.0000000E+00 |
| A4 | 1.2298853E−04 | −4.1787051E−04 | −3.5658773E−04 |
| A6 | 5.2510619E−07 | 2.0181439E−06 | 1.8091672E−06 |
| A8 | 7.2473808E−09 | −4.9005836E−09 | −8.9492863E−09 |
| A10 | 1.0369065E−10 | 6.4561205E−13 | 2.8786288E−11 |
| A12 | −3.1048018E−13 | 2.2501438E−14 | −5.3751658E−14 |
| A14 | −3.1558882E−15 | −3.5332084E−17 | 3.2821431E−17 |
| A16 | −3.5063763E−17 | 7.4246022E−20 | −2.6006558E−20 |
| A18 | 8.9804167E−20 | −2.3291283E−22 | 1.3505022E−22 |
| A20 | 4.7601670E−21 | −3.9704394E−25 | −2.8803706E−26 |

### Example 6

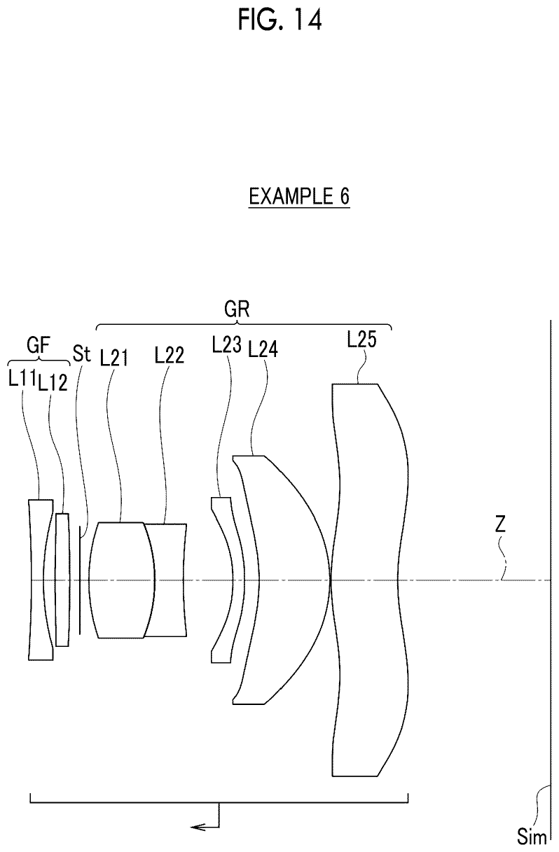

A cross-sectional view of a configuration of an imaging lens of Example 6 is illustrated in FIG. 14. The imaging lens of Example 6 consists of, in order from the object side to the image side, the front group GF, the aperture stop St, and the rear group GR. The front group GF consists of two lenses including the lenses L11 and L12 in order from the object side to the image side. The lens L12 corresponds to the LFp lens. The rear group GR consists of five lenses including the lenses L21 to L25 in order from the object side to the image side. During the focusing from the infinite distance object to the short range object, the entire imaging lens moves to the object side in an integrated manner.

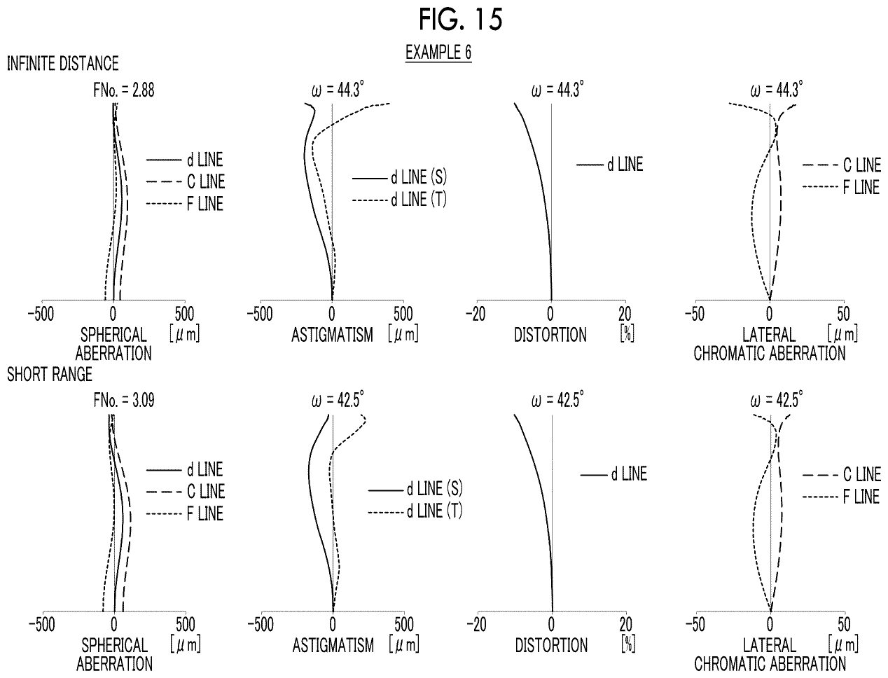

For the imaging lens of Example 6, Table 16 shows basic lens data, Table 17 shows specifications and a variable surface spacing, Table 18 shows aspherical coefficients, and FIG. 15 illustrates each aberration diagram.

TABLE 16
Example 6

| Sn | R | D | Nd | νd | Material | ED | Nd + 0.01 × νd | ρr | (dN/dT) × 10⁻⁶ |
|---|---|---|---|---|---|---|---|---|---|
| 1 | −96.4938 | 1.0000 | 1.48749 | 70.24 | S-FSL5 | | 2.18989 | | −0.8 |
| | | | | | OHARA | | | | |
| 2 | 20.9086 | 0.9695 | | | | | | | |
| *3 | 98.5673 | 1.2050 | 1.54436 | 56.03 | Plastic | | 2.10466 | | |
| *4 | −242.2132 | 0.8501 | | | | | | | |
| 5 (St) | ∞ | 0.7482 | | | | | | | |
| 6 | 15.1279 | 5.4625 | 1.88300 | 39.22 | H-ZLAF68N | | 2.27520 | 5.17 | 3.4 |
| | | | | | CDGM | | | | |
| 7 | −12.7659 | 2.3708 | 1.76182 | 26.52 | S-TIH14 | | 2.02702 | 3.17 | 2.0 |
| | | | | | OHARA | | | | |
| 8 | 39.8640 | 4.1077 | | | | | | | |
| *9 | −12.5423 | 0.9708 | 1.66121 | 20.35 | Plastic | 11.84 | 1.86471 | 1.23 | |
| | | | | | (LA2) | | | | |
| *10 | −16.9880 | 1.2164 | | | | 13.78 | | | |
| *11 | −14.9406 | 5.8185 | 1.54436 | 56.03 | Plastic | 17.20 | 2.10466 | 1.04 | |
| | | | | | (LA2) | | | | |
| *12 | −11.0443 | 0.0999 | | | | 20.74 | | | |
| *13 | 17.4716 | 5.5250 | 1.54436 | 56.03 | Plastic | 29.62 | 2.10466 | 1.04 | |
| | | | | | (LA1) | | | | |
| *14 | 17.6912 | DD[14] | | | | 32.76 | | | |

TABLE 17
Example 6

| | Infinite | Short Range |
|---|---|---|
| | Distance | 0.11 Times |
| Focal Length | 24.59 | — |
| Back Focus | 12.71 | 15.41 |
| Open F-Number | 2.88 | 3.09 |
| Maximum Full Angle of View [°] | 88.6 | 85.0 |
| DD[14] | 12.71 | 15.41 |

TABLE 18
Example 6

| Sn | 3 | 4 |
|---|---|---|
| KA | 1.0000000E+00 | 1.0000000E+00 |
| A4 | −6.9894318E−05 | −5.3436339E−05 |
| A6 | −8.5039365E−07 | −1.5056498E−06 |
| A8 | −1.2199739E−09 | 2.5847157E−08 |
| A10 | 1.0103775E−10 | −1.7129620E−10 |

| Sn | 9 | 10 | 11 | 12 |
|---|---|---|---|---|
| KA | 1.0000000E+00 | 1.0000000E+00 | 1.0000000E+00 | 1.0000000E+00 |
| A4 | −1.1230019E−03 | −8.8514260E−04 | 3.5709842E−04 | 3.8406599E−05 |
| A6 | 4.1025703E−05 | 3.9860039E−05 | −3.0272454E−06 | 4.5337955E−07 |
| A8 | −5.4501760E−07 | −5.0591045E−07 | 2.4527386E−08 | −8.8124560E−09 |
| A10 | 2.9705724E−09 | 2.5710495E−09 | 3.2861272E−11 | 1.9043814E−10 |
| A12 | 1.8863959E−12 | −3.8107231E−13 | −1.6794865E−12 | −4.7436894E−13 |

| Sn | 13 | 14 |
|---|---|---|
| KA | 1.0000000E+00 | 1.0000000E+00 |
| A4 | −3.9940919E−04 | −3.4043392E−04 |
| A6 | 1.9114281E−06 | 1.7510720E−06 |
| A8 | −4.8281047E−09 | −8.6006889E−09 |
| A10 | 1.8603581E−12 | 2.7013494E−11 |
| A12 | 1.7829336E−14 | −4.9807259E−14 |
| A14 | −3.2594142E−17 | 3.5868486E−17 |

### Example 7

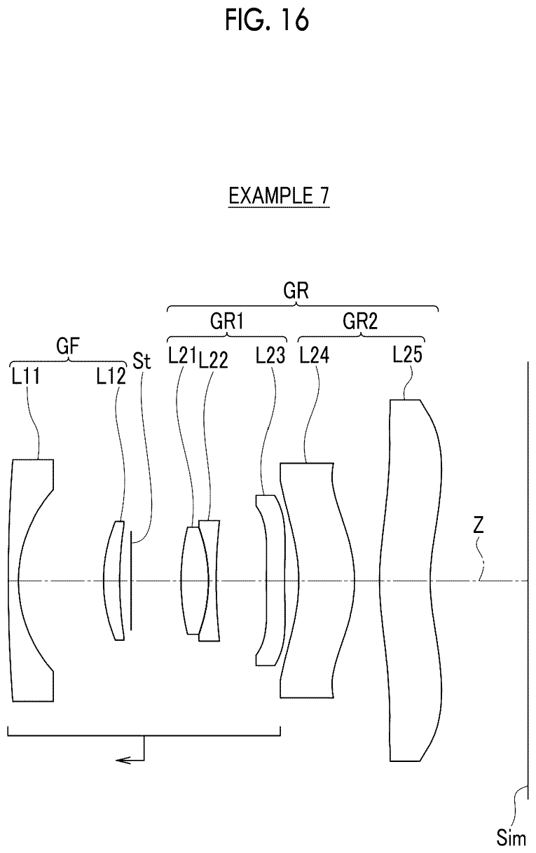

A cross-sectional view of a configuration of an imaging lens of Example 7 is illustrated in FIG. 16. The imaging lens of Example 7 consists of, in order from the object side to the image side, the front group GF, the aperture stop St, and the rear group GR. The front group GF consists of two lenses including the lenses L11 and L12 in order from the object side to the image side. The lens L12 corresponds to the LFp lens. The rear group GR consists of a first subsequent lens group GR1 and a second subsequent lens group GR2 in order from the object side to the image side. The first subsequent lens group GR1 consists of three lenses including the lenses L21 to L23 in order from the object side to the image side. The second subsequent lens group GR2 consists of two lenses including the lenses L24 and L25 in order from the object side to the image side. During the focusing from the infinite distance object to the short range object, the front group GF, the aperture stop St, and the first subsequent lens group GR1 move to the object side in an integrated manner, and the second subsequent lens group GR2 is fixed with respect to the image plane Sim.

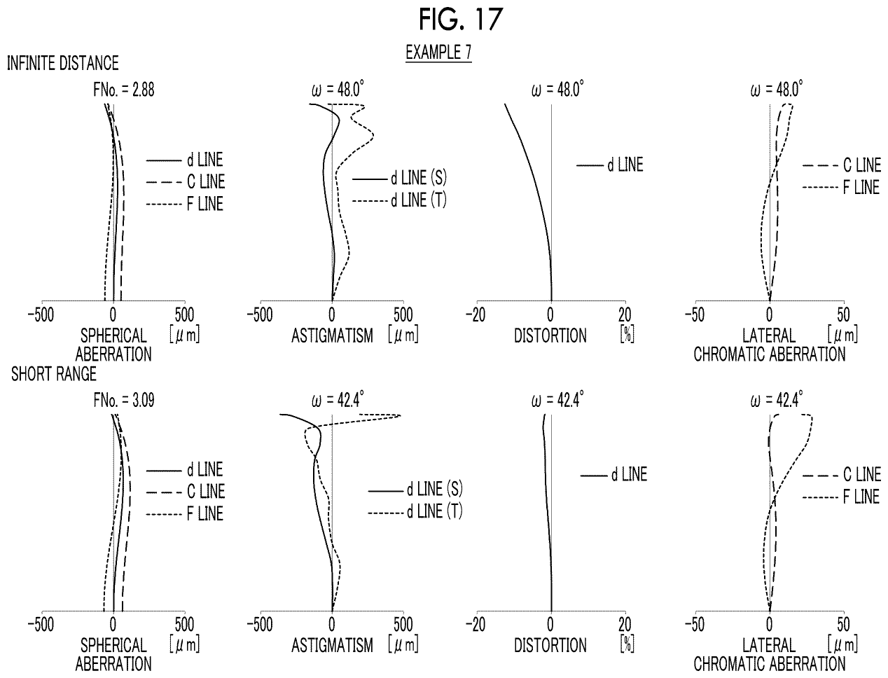

For the imaging lens of Example 7, Table 19 shows basic lens data, Table 20 shows specifications and a variable surface spacing, Table 21 shows aspherical coefficients, and FIG. 17 illustrates each aberration diagram.

TABLE 19
Example 7

| Sn | R | D | Nd | νd | Material | ED | Nd + 0.01 × νd | ρr | (dN/dT) × 10⁻⁶ |
|---|---|---|---|---|---|---|---|---|---|
| 1 | 161.8860 | 0.9998 | 1.48749 | 70.24 | S-FSL5 | | 2.18989 | | −0.8 |
| | | | | | OHARA | | | | |
| 2 | 13.5249 | 8.3967 | | | | | | | |
| 3 | 15.4807 | 1.5882 | 1.83481 | 42.74 | S-LAH55VS | | 2.26221 | | 5.0 |
| | | | | | OHARA | | | | |
| 4 | 36.7403 | 1.1267 | | | | | | | |
| 5 (St) | ∞ | 4.9285 | | | | | | | |
| 6 | 22.0688 | 2.7101 | 1.88300 | 39.22 | H-ZLAF68N | | 2.27520 | 5.17 | 3.4 |
| | | | | | CDGM | | | | |
| 7 | −15.2673 | 0.7598 | 1.84666 | 23.78 | S-TIH53W | | 2.08446 | 3.54 | 1.3 |
| | | | | | OHARA | | | | |
| 8 | 54.6267 | 4.9526 | | | | | | | |
| *9 | 84.1319 | 1.7502 | 1.66121 | 20.35 | Plastic | 14.84 | 1.86471 | 1.23 | |
| | | | | | (LA1) | | | | |
| *10 | 73.5940 | DD[10] | | | | 16.88 | | | |
| *11 | −17.3000 | 5.5002 | 1.54436 | 56.03 | Plastic | 19.11 | 2.10466 | 1.04 | |
| | | | | | (LA2) | | | | |
| *12 | −13.9367 | 2.4580 | | | | 22.93 | | | |
| *13 | 26.4677 | 5.0002 | 1.54436 | 56.03 | Plastic | 33.60 | 2.10466 | 1.04 | |
| | | | | | (LA1) | | | | |
| *14 | 19.3061 | 9.6500 | | | | 35.75 | | | |

TABLE 20
Example 7

| | Infinite | Short Range |
|---|---|---|
| | Distance | 0.11 Times |
| Focal Length | 22.30 | — |
| Back Focus | 9.65 | 9.65 |
| Open F-Number | 2.88 | 3.09 |
| Maximum Full Angle of View [°] | 96.0 | 84.8 |
| DD[10] | 1.39 | 4.39 |

TABLE 21
Example 7

| Sn | 9 | 10 | 11 | 12 |
|---|---|---|---|---|
| KA | 1.0000000E+00 | 1.0000000E+00 | 1.0000000E+00 | 1.0000000E+00 |
| A4 | −3.4958396E−04 | −2.3728358E−04 | 1.4235782E−04 | 1.2612780E−04 |
| A6 | −5.7762634E−07 | −8.1309330E−07 | −8.1397512E−07 | 2.2659160E−07 |
| A8 | −3.3270618E−08 | −8.8245039E−09 | 2.2202245E−08 | 1.2537989E−08 |
| A10 | 1.1503122E−10 | 1.6587017E−10 | −2.1625319E−10 | −9.7401741E−11 |
| A12 | 1.8863959E−12 | −3.8107231E−13 | 6.6873500E−13 | 2.4746548E−13 |

| Sn | 13 | 14 |
|---|---|---|
| KA | 1.0000000E+00 | 1.0000000E+00 |
| A4 | −1.9091600E−04 | −2.6379842E−04 |
| A6 | 1.2094875E−06 | 1.4624450E−06 |
| A8 | −4.2330299E−09 | −6.8138595E−09 |
| A10 | 2.2842732E−12 | 2.0250919E−11 |
| A12 | 2.0731442E−14 | −3.9821677E−14 |
| A14 | −3.2594142E−17 | 3.5868486E−17 |

### Example 8

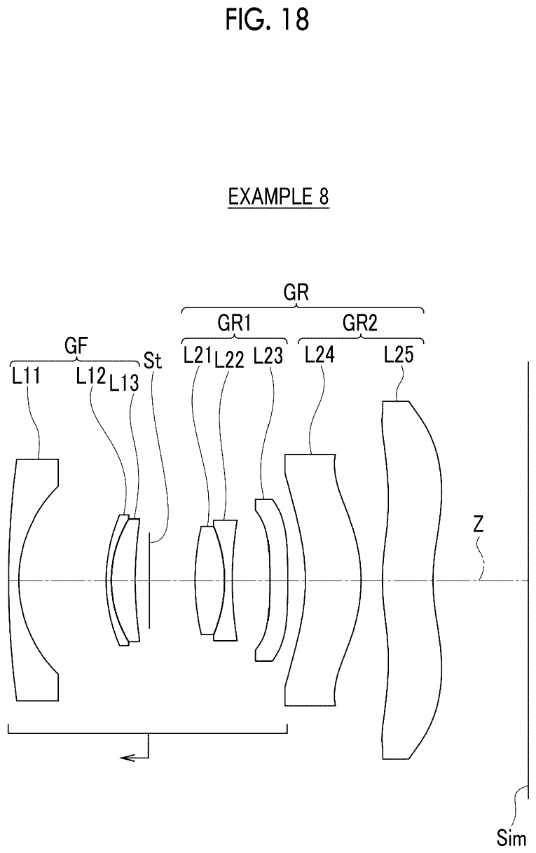

A cross-sectional view of a configuration of an imaging lens of Example 8 is illustrated in FIG. 18. The imaging lens of Example 8 consists of, in order from the object side to the image side, the front group GF, the aperture stop St, and the rear group GR. The front group GF consists of three lenses including the lenses L11 to L13 in order from the object side to the image side. A cemented lens in which the lens L12 and the lens L13 are cemented corresponds to the LFp lens. The rear group GR consists of the first subsequent lens group GR1 and the second subsequent lens group GR2 in order from the object side to the image side. The first subsequent lens group GR1 consists of three lenses including the lenses L21 to L23 in order from the object side to the image side. The second subsequent lens group GR2 consists of two lenses including the lenses L24 and L25 in order from the object side to the image side. During the focusing from the infinite distance object to the short range object, the front group GF, the aperture stop St, and the first subsequent lens group GR1 move to the object side in an integrated manner, and the second subsequent lens group GR2 is fixed with respect to the image plane Sim.

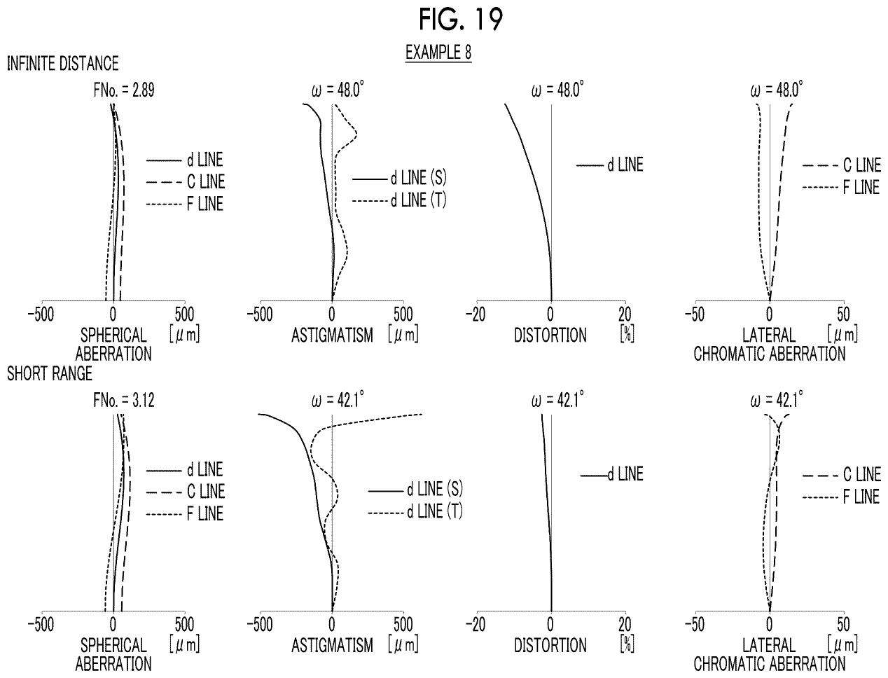

For the imaging lens of Example 8, Table 22 shows basic lens data, Table 23 shows specifications and a variable surface spacing, Table 24 shows aspherical coefficients, and FIG. 19 illustrates each aberration diagram.

TABLE 22
Example 8

| Sn | R | D | Nd | νd | Material | ED | Nd + 0.01 × νd | ρr | (dN/dT) × 10⁻⁶ |
|---|---|---|---|---|---|---|---|---|---|
| 1 | 89.6823 | 0.9998 | 1.48749 | 70.24 | S-FSL5 | | 2.18989 | | −0.8 |
| | | | | | OHARA | | | | |
| 2 | 13.1587 | 8.6308 | | | | | | | |
| 3 | 16.4953 | 0.5100 | 1.76182 | 26.52 | S-TIH14 | | 2.02702 | | 2.0 |
| | | | | | OHARA | | | | |
| 4 | 11.7001 | 2.3582 | 1.88300 | 39.22 | H-ZLAF68N | | 2.27520 | | 3.4 |
| | | | | | CDGM | | | | |
| 5 | 40.2964 | 1.3964 | | | | | | | |
| 6 (St) | ∞ | 4.5196 | | | | | | | |
| 7 | 24.2821 | 2.9058 | 1.88300 | 39.22 | H-ZLAF68N | | 2.27520 | 5.17 | 3.4 |
| | | | | | CDGM | | | | |
| 8 | −13.9341 | 0.7600 | 1.78472 | 25.68 | S-TIH11 | | 2.04152 | 3.24 | 1.5 |
| | | | | | OHARA | | | | |
| 9 | 37.7290 | 3.6659 | | | | | | | |
| *10 | −161.0901 | 1.7502 | 1.66121 | 20.35 | Plastic | 13.85 | 1.86471 | 1.23 | |
| *11 | −276.1638 | DD[11] | | | | 16.05 | | | |
| *12 | −20.2103 | 5.4999 | 1.54436 | 56.03 | Plastic | 20.09 | 2.10466 | 1.04 | |
| | | | | | (LA2) | | | | |
| *13 | −16.6409 | 2.1057 | | | | 24.18 | | | |
| *14 | 21.1947 | 5.0002 | 1.54436 | 56.03 | Plastic | 32.94 | 2.10466 | 1.04 | |
| | | | | | (LA1) | | | | |
| *15 | 18.7148 | 9.4000 | | | | 35.27 | | | |

TABLE 23
Example 8

| | Infinite | Short Range |
|---|---|---|
| | Distance | 0.12 Times |
| Focal Length | 22.32 | — |
| Back Focus | 9.40 | 9.40 |
| Open F-Number | 2.89 | 3.12 |
| Maximum Full Angle of View [°] | 96.0 | 84.2 |
| DD[11] | 1.75 | 5.23 |

TABLE 24
Example 8

| Sn | 10 | 11 | 12 | 13 |
|---|---|---|---|---|
| KA | 1.0000000E+00 | 1.0000000E+00 | 1.0000000E+00 | 1.0000000E+00 |
| A4 | −4.4457252E−04 | −3.1667165E−04 | 1.0684358E−04 | −2.0801341E−05 |
| A6 | 1.0342278E−07 | 3.4784402E−07 | −1.4975684E−06 | 7.6282840E−07 |
| A8 | −5.3746768E−08 | −2.5441794E−08 | 2.9573490E−08 | 9.3517126E−09 |
| A10 | 1.7503198E−10 | 2.6702130E−10 | −2.3924604E−10 | −7.9230346E−11 |
| A12 | 1.8863959E−12 | −3.8107231E−13 | 6.6590709E−13 | 1.7316029E−13 |

| Sn | 14 | 15 |
|---|---|---|
| KA | 1.0000000E+00 | 1.0000000E+00 |
| A4 | −3.3695363E−04 | −3.0621951E−04 |
| A6 | 1.8837411E−06 | 1.4436402E−06 |
| A8 | −5.3095053E−09 | −6.2211188E−09 |
| A10 | 1.6019719E−12 | 1.9326986E−11 |
| A12 | 2.3186079E−14 | −4.0539310E−14 |
| A14 | −3.2594142E−17 | 3.5868486E−17 |

### Example 9

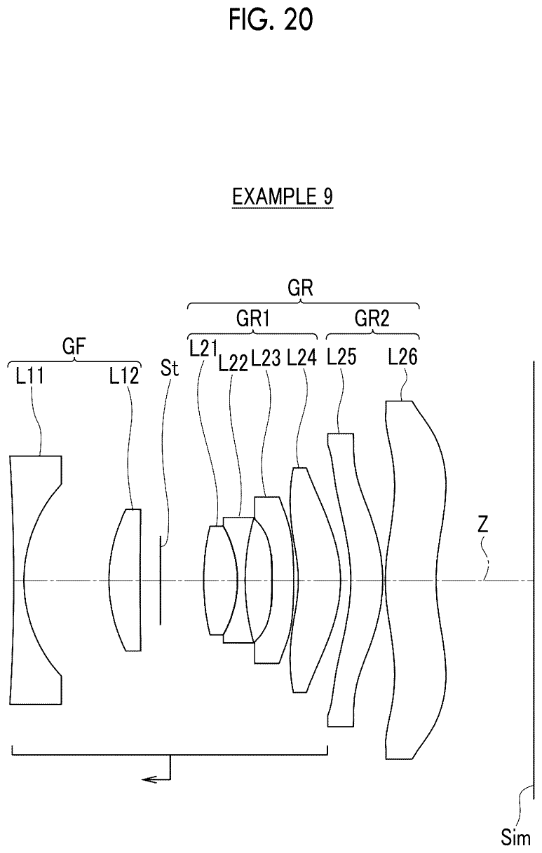

A cross-sectional view of a configuration of an imaging lens of Example 9 is illustrated in FIG. 20. The imaging lens of Example 9 consists of, in order from the object side to the image side, the front group GF, the aperture stop St, and the rear group GR. The front group GF consists of two lenses including the lenses L11 and L12 in order from the object side to the image side. The lens L12 corresponds to the LFp lens. The rear group GR consists of the first subsequent lens group GR1 and the second subsequent lens group GR2 in order from the object side to the image side. The first subsequent lens group GR1 consists of four lenses including the lenses L21 to L24 in order from the object side to the image side. The second subsequent lens group GR2 consists of two lenses including lenses L25 and L26 in order from the object side to the image side. During the focusing from the infinite distance object to the short range object, the front group GF, the aperture stop St, and the first subsequent lens group GR1 move to the object side in an integrated manner, and the second subsequent lens group GR2 is fixed with respect to the image plane Sim.

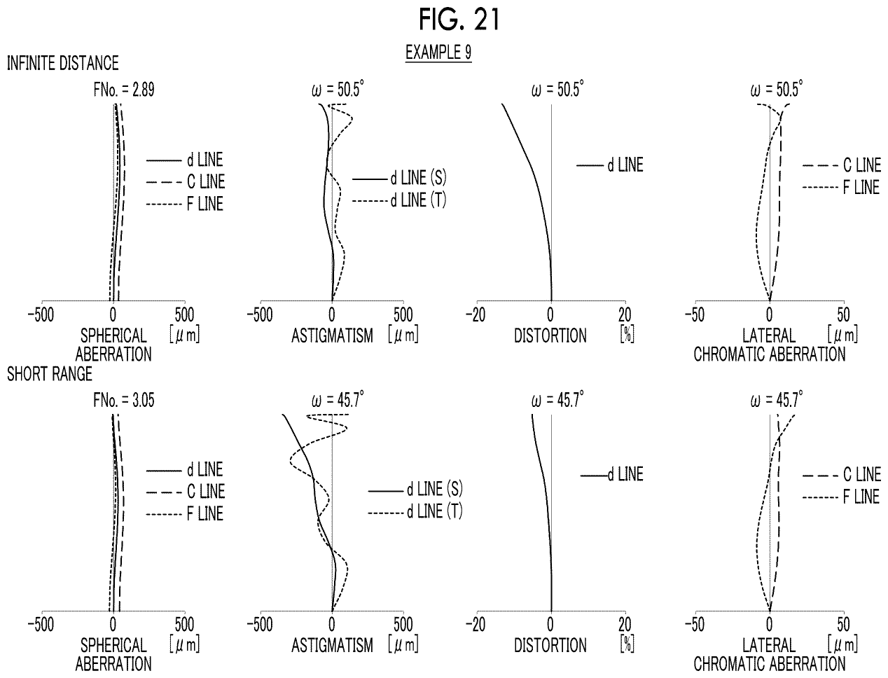

For the imaging lens of Example 9, Table 25 shows basic lens data, Table 26 shows specifications and a variable surface spacing, Table 27 shows aspherical coefficients, and FIG. 21 illustrates each aberration diagram.

TABLE 25
Example 9

| Sn | R | D | Nd | νd | Material | ED | Nd + 0.01 × νd | ρr | (dN/dT) × 10⁻⁶ |
|---|---|---|---|---|---|---|---|---|---|
| 1 | −198.1814 | 1.0002 | 1.48749 | 70.24 | S-FSL5 | | 2.18989 | | −0.8 |
| | | | | | OHARA | | | | |
| 2 | 14.0972 | 8.3608 | | | | | | | |
| 3 | 15.5619 | 3.0534 | 1.83481 | 42.74 | S-LAH55VS | | 2.26221 | | 5.0 |
| | | | | | OHARA | | | | |
| 4 | 288.1516 | 2.0058 | | | | | | | |
| 5 (St) | ∞ | 4.2502 | | | | | | | |
| 6 | 23.5282 | 3.3209 | 1.88300 | 39.22 | H-ZLAF68N | | 2.27520 | 5.17 | 3.4 |
| | | | | | CDGM | | | | |
| 7 | −11.1551 | 0.7598 | 1.84666 | 23.78 | S-TIH53W | | 2.08446 | 3.54 | 1.3 |
| | | | | | OHARA | | | | |
| 8 | 22.9016 | 2.6122 | | | | | | | |
| *9 | −62.5484 | 2.1035 | 1.66121 | 20.35 | Plastic | | 1.86471 | 1.23 | |
| *10 | −59.5864 | 0.4500 | | | | | | | |
| *11 | −13.3846 | 4.1579 | 1.66121 | 20.35 | Plastic | 20.89 | 1.86471 | 1.23 | |
| | | | | | (LA2) | | | | |
| *12 | −13.0424 | DD[12] | | | | 22.22 | | | |
| *13 | −19.1796 | 3.1422 | 1.54436 | 56.03 | Plastic | 25.72 | 2.10466 | 1.04 | |
| | | | | | (LA2) | | | | |
| *14 | −15.9751 | 0.2498 | | | | 27.76 | | | |
| *15 | 18.6722 | 4.9868 | 1.54436 | 56.03 | Plastic | 32.62 | 2.10466 | 1.04 | |
| | | | | | (LA1) | | | | |
| *16 | 18.9326 | 9.6098 | | | | 34.94 | | | |

TABLE 26
Example 9

| | Infinite | Short Range |
|---|---|---|
| | Distance | 0.11 Times |
| Focal Length | 20.60 | — |
| Back Focus | 9.61 | 9.61 |
| Open F-Number | 2.89 | 3.05 |
| Maximum Full Angle of View [°] | 101.0 | 91.4 |
| DD[12] | 1.00 | 4.37 |

TABLE 27
Example 9

| Sn | 9 | 10 | 11 | 12 |
|---|---|---|---|---|
| KA | 1.0000000E+00 | 1.0000000E+00 | 1.0000000E+00 | 1.0000000E+00 |
| A4 | −8.1388792E−04 | −1.4674786E−04 | 7.0995435E−04 | 1.6694837E−04 |
| A6 | −6.4137253E−06 | −6.8243936E−06 | −5.8816346E−06 | −1.2569028E−06 |
| A8 | −5.0448736E−08 | 1.2809213E−07 | 3.5521435E−08 | 2.9586193E−08 |
| A10 | 2.3229704E−09 | −5.1395848E−10 | −1.1928620E−10 | −2.4030803E−10 |
| A12 | 1.8863959E−12 | −3.8107231E−13 | 2.4019060E−13 | 7.6119473E−13 |
| Sn | 13 | 14 | 15 | 16 |
| KA | 1.0000000E+00 | 1.0000000E+00 | 1.0000000E+00 | 1.0000000E+00 |
| A4 | 1.6450829E−04 | 5.3431475E−05 | −2.9348561E−04 | −2.6920612E−04 |
| A6 | −1.1223708E−06 | −5.1070060E−08 | 1.3259835E−06 | 1.2885584E−06 |
| A8 | 1.2361192E−08 | 1.1483526E−08 | −4.5717029E−09 | −6.7405338E−09 |
| A10 | −6.4276261E−11 | −7.3166044E−11 | 6.0691910E−12 | 2.2263400E−11 |
| A12 | 1.0591730E−13 | 1.4028629E−13 | 1.1658407E−14 | −4.2973087E−14 |
| A14 | 0.0000000E+00 | 0.0000000E+00 | −3.2594142E−17 | 3.5868486E−17 |

### Example 10

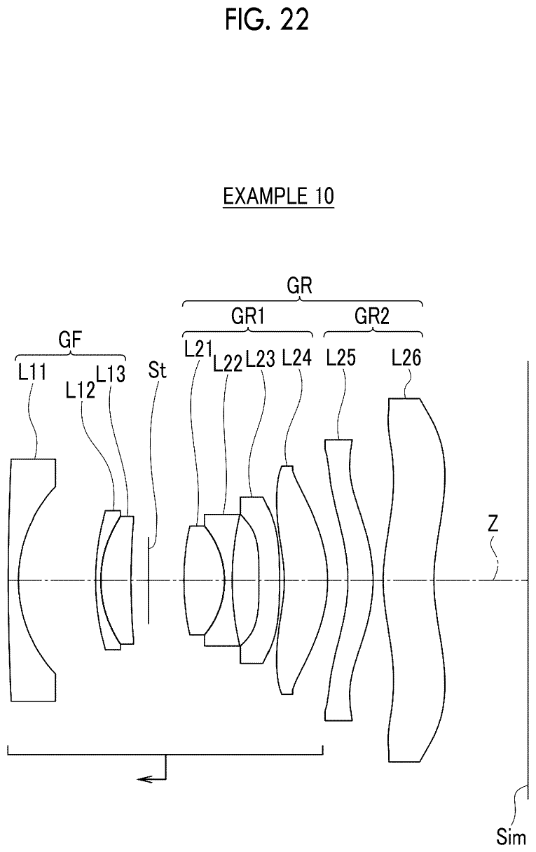

A cross-sectional view of a configuration of an imaging lens of Example 10 is illustrated in FIG. 22. The imaging lens of Example 10 consists of, in order from the object side to the image side, the front group GF, the aperture stop St, and the rear group GR. The front group GF consists of three lenses including the lenses L11 to L13 in order from the object side to the image side. A cemented lens in which the lens L12 and the lens L13 are cemented corresponds to the LFp lens. The rear group GR consists of the first subsequent lens group GR1 and the second subsequent lens group GR2 in order from the object side to the image side. The first subsequent lens group GR1 consists of four lenses including the lenses L21 to L24 in order from the object side to the image side. The second subsequent lens group GR2 consists of two lenses including the lenses L25 and L26 in order from the object side to the image side. During the focusing from the infinite distance object to the short range object, the front group GF, the aperture stop St, and the first subsequent lens group GR1 move to the object side in an integrated manner, and the second subsequent lens group GR2 is fixed with respect to the image plane Sim.

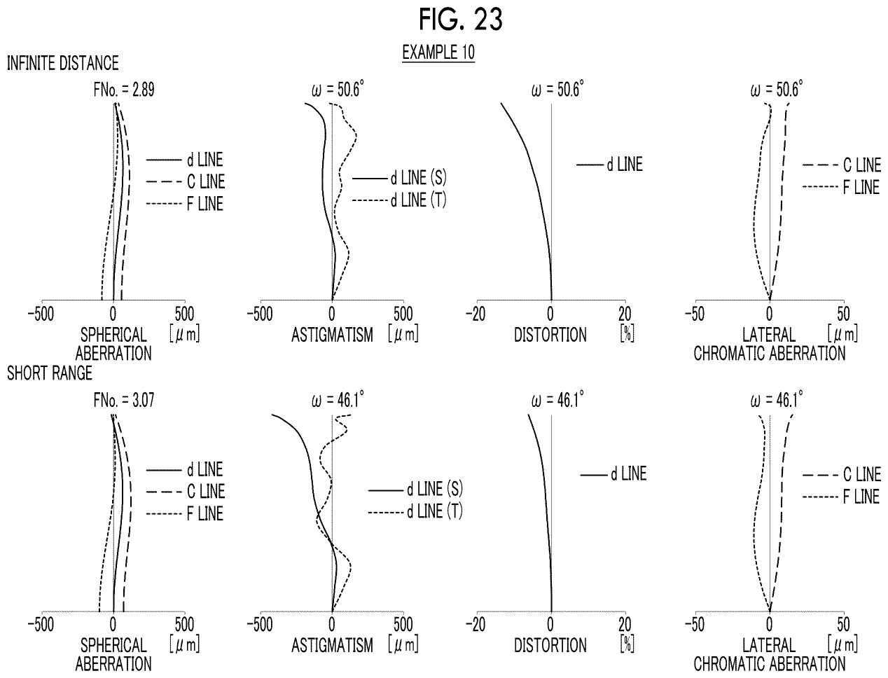

For the imaging lens of Example 10, Table 28 shows basic lens data, Table 29 shows specifications and a variable surface spacing, Table 30 shows aspherical coefficients, and FIG. 23 illustrates each aberration diagram.

TABLE 28
Example 10

| Sn | R | D | Nd | νd | Material | ED | Nd + 0.01 × νd | ρr | (dN/dT) × 10⁻⁶ |
|---|---|---|---|---|---|---|---|---|---|
| 1 | 248.9476 | 0.9998 | 1.48749 | 70.24 | S-FSL5 | | 2.18989 | | −0.8 |
| | | | | | OHARA | | | | |
| 2 | 13.6164 | 7.6062 | | | | | | | |
| 3 | 25.0273 | 0.5100 | 1.48749 | 70.24 | S-FSL5 | | 2.18989 | | −0.8 |
| | | | | | OHARA | | | | |
| 4 | 11.3071 | 2.9721 | 1.88300 | 39.22 | H-ZLAF68N | | 2.27520 | | 3.4 |
| | | | | | CDGM | | | | |
| 5 | 70.2617 | 1.7052 | | | | | | | |
| 6 (St) | ∞ | 3.5001 | | | | | | | |
| 7 | 25.3639 | 3.9896 | 1.88300 | 39.22 | H-ZLAF68N | | 2.27520 | 5.17 | 3.4 |
| | | | | | CDGM | | | | |
| 8 | −8.4023 | 0.7598 | 1.84666 | 23.78 | S-TIH53W | | 2.08446 | 3.54 | 1.3 |
| | | | | | OHARA | | | | |
| 9 | 28.1442 | 2.6411 | | | | | | | |
| *10 | −128.5669 | 1.9833 | 1.66121 | 20.35 | Plastic | 12.74 | 1.86471 | 1.23 | |
| *11 | −49.8024 | 0.4500 | | | | 16.45 | | | |
| *12 | −14.7202 | 4.2718 | 1.66121 | 20.35 | Plastic | 20.56 | 1.86471 | 1.23 | |
| | | | | | (LA2) | | | | |
| *13 | −13.6218 | DD[13] | | | | 21.66 | | | |
| *14 | −16.1512 | 2.4659 | 1.54436 | 56.03 | Plastic | 25.45 | 2.10466 | 1.04 | |
| | | | | | (LA2) | | | | |
| *15 | −15.6852 | 1.0000 | | | | 27.39 | | | |
| *16 | 18.7322 | 5.0002 | 1.54436 | 56.03 | Plastic | 33.47 | 2.10466 | 1.04 | |
| | | | | | (LA1) | | | | |
| *17 | 19.5412 | 9.2550 | | | | 35.88 | | | |

TABLE 29
Example 10

| | Infinite | Short Range |
|---|---|---|
| | Distance | 0.12 Times |
| Focal Length | 20.60 | — |
| Back Focus | 9.25 | 9.25 |
| Open F-Number | 2.89 | 3.07 |
| Maximum Full Angle of View [°] | 101.2 | 92.2 |
| DD[13] | 2.00 | 5.21 |

TABLE 30
Example 10

| Sn | 10 | 11 | 12 | 13 |
|---|---|---|---|---|
| KA | 1.0000000E+00 | 1.0000000E+00 | 1.0000000E+00 | 1.0000000E+00 |
| A4 | −6.5918427E−04 | −6.8187105E−06 | 6.3387350E−04 | 1.2544541E−04 |
| A6 | −7.8831084E−06 | −1.0560791E−05 | −5.5417843E−06 | −1.3461261E−06 |
| A8 | −4.1080769E−08 | 1.5565347E−07 | 3.4635649E−08 | 2.9286855E−08 |
| A10 | 1.6962310E−09 | −5.8932933E−10 | −1.1910246E−10 | −2.4631355E−10 |
| A12 | 1.8863959E−12 | −3.8107231E−13 | 2.4848705E−13 | 8.7750285E−13 |
| Sn | 14 | 15 | 16 | 17 |
| KA | 1.0000000E+00 | 1.0000000E+00 | 1.0000000E+00 | 1.0000000E+00 |
| A4 | 2.0909864E−04 | 8.9688202E−05 | −2.7178041E−04 | −2.4427738E−04 |
| A6 | −1.0012043E−06 | 4.2268241E−08 | 1.2219693E−06 | 1.2271904E−06 |
| A8 | 1.1127047E−08 | 1.0457936E−08 | −4.3768164E−09 | −6.2819054E−09 |
| A10 | −5.9547580E−11 | −7.2717021E−11 | 6.3674467E−12 | 2.0885661E−11 |
| A12 | 9.8138163E−14 | 1.4840702E−13 | 1.0437722E−14 | −4.1686478E−14 |
| A14 | 0.0000000E+00 | 0.0000000E+00 | −3.2594142E−17 | 3.5868486E−17 |

### Example 11

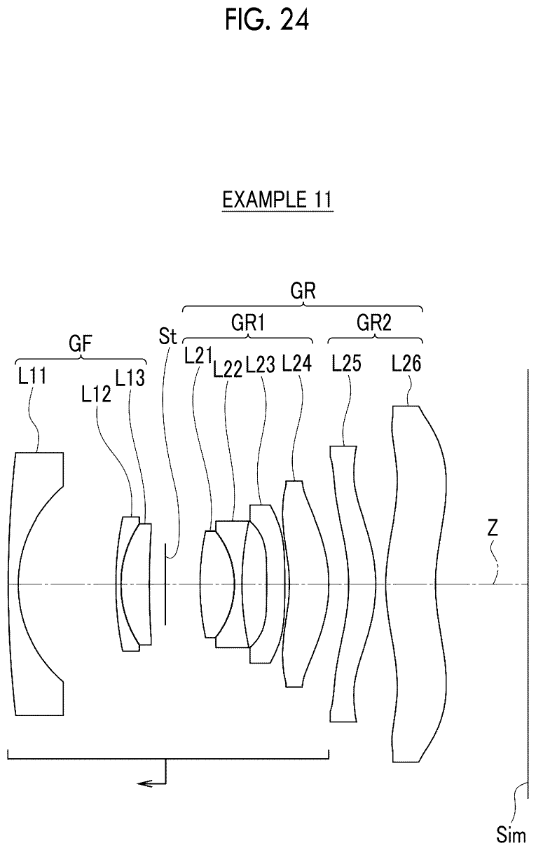

A cross-sectional view of a configuration of an imaging lens of Example 11 is illustrated in FIG. 24. The imaging lens of Example 11 consists of, in order from the object side to the image side, the front group GF, the aperture stop St, and the rear group GR. The front group GF consists of three lenses including the lenses L11 to L13 in order from the object side to the image side. A cemented lens in which the lens L12 and the lens L13 are cemented corresponds to the LFp lens. The rear group GR consists of the first subsequent lens group GR1 and the second subsequent lens group GR2 in order from the object side to the image side. The first subsequent lens group GR1 consists of four lenses including the lenses L21 to L24 in order from the object side to the image side. The second subsequent lens group GR2 consists of two lenses including the lenses L25 and L26 in order from the object side to the image side. During the focusing from the infinite distance object to the short range object, the front group GF, the aperture stop St, and the first subsequent lens group GR1 move to the object side in an integrated manner, and the second subsequent lens group GR2 is fixed with respect to the image plane Sim.

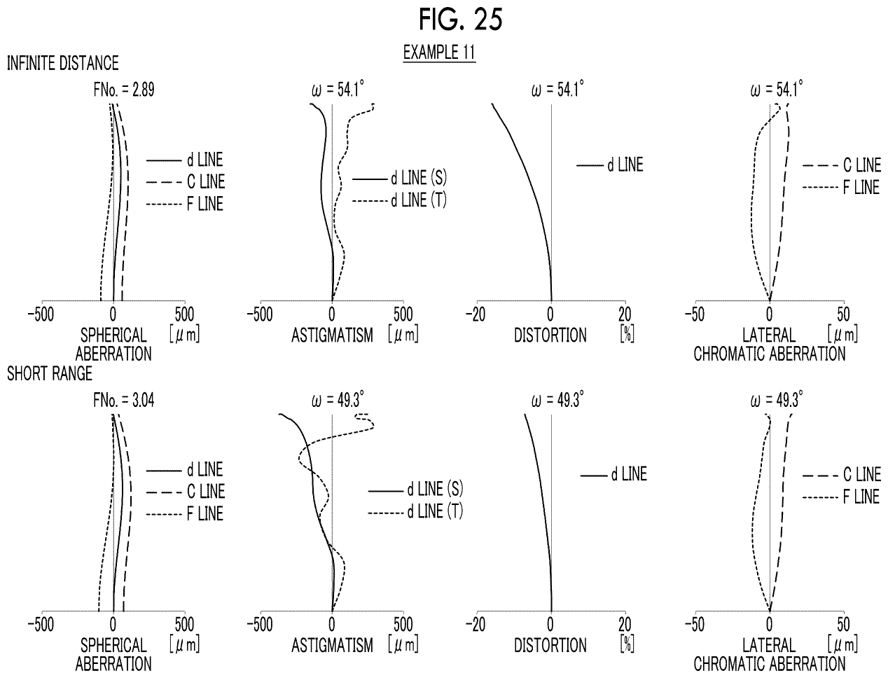

For the imaging lens of Example 11, Table 31 shows basic lens data, Table 32 shows specifications and a variable surface spacing, Table 33 shows aspherical coefficients, and FIG. 25 illustrates each aberration diagram.

TABLE 31
Example 11

| Sn | R | D | Nd | νd | Material | ED | Nd + 0.01 × νd | ρr | (dN/dT) × 10⁻⁶ |
|---|---|---|---|---|---|---|---|---|---|
| 1 | 117.1751 | 1.0000 | 1.48749 | 70.24 | S-FSL5 | | 2.18989 | | −0.8 |
| | | | | | OHARA | | | | |
| 2 | 13.0369 | 9.8237 | | | | | | | |
| 3 | 33.3916 | 0.5100 | 1.48749 | 70.24 | S-FSL5 | | 2.18989 | | −0.8 |
| | | | | | OHARA | | | | |
| 4 | 11.0305 | 2.8634 | 1.88300 | 39.22 | H-ZLAF68N | | 2.27520 | | 3.4 |
| | | | | | CDGM | | | | |
| 5 | 86.9983 | 1.5944 | | | | | | | |
| 6 (St) | ∞ | 3.5002 | | | | | | | |
| 7 | 26.4373 | 3.4621 | 1.88300 | 39.22 | H-ZLAF68N | | 2.27520 | 5.17 | 3.4 |
| | | | | | CDGM | | | | |
| 8 | −8.5891 | 0.7601 | 1.84666 | 23.78 | S-TIH53W | | 2.08446 | 3.54 | 1.3 |
| | | | | | OHARA | | | | |
| 9 | 29.7793 | 2.4831 | | | | | | | |
| *10 | −3484.1647 | 1.7799 | 1.66121 | 20.35 | Plastic | 12.63 | 1.86471 | 1.23 | |
| *11 | −98.1897 | 0.4500 | | | | 15.94 | | | |
| *12 | −14.9518 | 3.9708 | 1.66121 | 20.35 | Plastic | 9.91 | 1.86471 | 1.23 | |
| | | | | | (LA2) | | | | |
| *13 | −14.0878 | DD[13] | | | | 20.83 | | | |
| *14 | −18.7170 | 2.7190 | 1.54436 | 56.03 | Plastic | 25.00 | 2.10466 | 1.04 | |
| | | | | | (LA2) | | | | |
| *15 | −15.4905 | 1.0000 | | | | 26.89 | | | |
| *16 | 18.6930 | 5.0000 | 1.54436 | 56.03 | Plastic | 33.38 | 2.10466 | 1.04 | |
| | | | | | (LA1) | | | | |
| *17 | 19.2962 | 9.3083 | | | | 35.60 | | | |

TABLE 32
Example 11

| | Infinite | Short Range |
|---|---|---|
| | Distance | 0.11 Times |
| Focal Length | 18.64 | — |
| Back Focus | 9.31 | 9.31 |
| Open F-Number | 2.89 | 3.04 |
| Maximum Full Angle of View [°] | 108.2 | 98.6 |
| DD[13] | 2.00 | 5.16 |

TABLE 33
Example 11

| Sn | 10 | 11 | 12 | 13 |
|---|---|---|---|---|
| KA | 1.0000000E+00 | 1.0000000E+00 | 1.0000000E+00 | 1.0000000E+00 |
| A4 | −7.4917136E−04 | −1.4415543E−04 | 6.3838798E−04 | 1.4713548E−04 |
| A6 | −8.2791889E−06 | −9.9861803E−06 | −5.5121915E−06 | −1.5584054E−06 |
| A8 | −9.5107462E−09 | 1.7147564E−07 | 3.5093591E−08 | 2.9874880E−08 |
| A10 | 1.5458981E−09 | −7.5841926E−10 | −1.0971816E−10 | −2.2246400E−10 |
| A12 | 1.8863959E−12 | −3.8107231E−13 | 2.2053555E−13 | 8.4780289E−13 |
| Sn | 14 | 15 | 16 | 17 |
| KA | 1.0000000E+00 | 1.0000000E+00 | 1.0000000E+00 | 1.0000000E+00 |
| A4 | 1.8713895E−04 | 1.0641350E−04 | −2.4318291E−04 | −2.4376223E−04 |
| A6 | −9.3857932E−07 | 2.6898229E−09 | 1.0099489E−06 | 1.1845756E−06 |
| A8 | 1.0113350E−08 | 1.0605458E−08 | −3.9761230E−09 | −6.2356817E−09 |
| A10 | −5.7055090E−11 | −7.6312870E−11 | 6.8073424E−12 | 2.1031881E−11 |
| A12 | 9.2302372E−14 | 1.6282002E−13 | 8.9575399E−15 | −4.1962694E−14 |
| A14 | 0.0000000E+00 | 0.0000000E+00 | −3.2594142E−17 | 3.5868486E−17 |

### Example 12

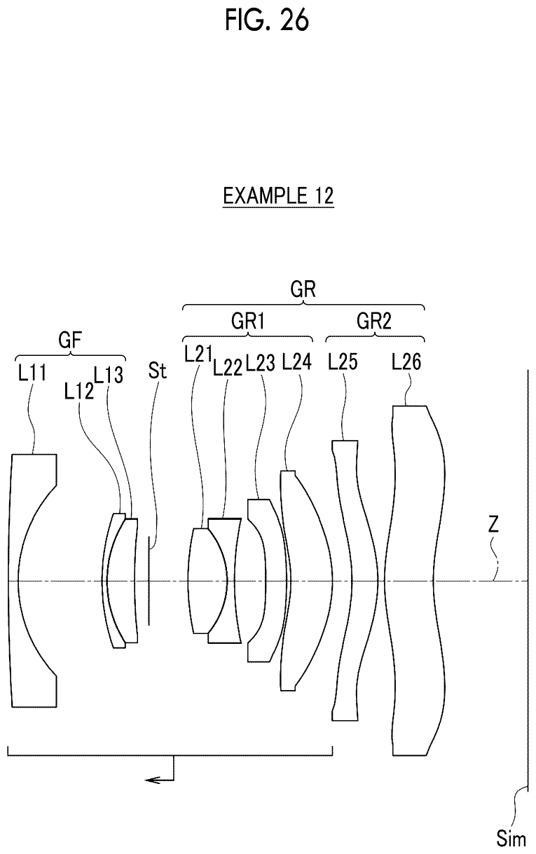

A cross-sectional view of a configuration of an imaging lens of Example 12 is illustrated in FIG. 26. The imaging lens of Example 12 consists of, in order from the object side to the image side, the front group GF, the aperture stop St, and the rear group GR. The front group GF consists of three lenses including the lenses L11 to L13 in order from the object side to the image side. A cemented lens in which the lens L12 and the lens L13 are cemented corresponds to the LFp lens. The rear group GR consists of the first subsequent lens group GR1 and the second subsequent lens group GR2 in order from the object side to the image side. The first subsequent lens group GR1 consists of four lenses including the lenses L21 to L24 in order from the object side to the image side. The second subsequent lens group GR2 consists of two lenses including the lenses L25 and L26 in order from the object side to the image side. During the focusing from the infinite distance object to the short range object, the front group GF, the aperture stop St, and the first subsequent lens group GR1 move to the object side in an integrated manner, and the second subsequent lens group GR2 is fixed with respect to the image plane Sim.

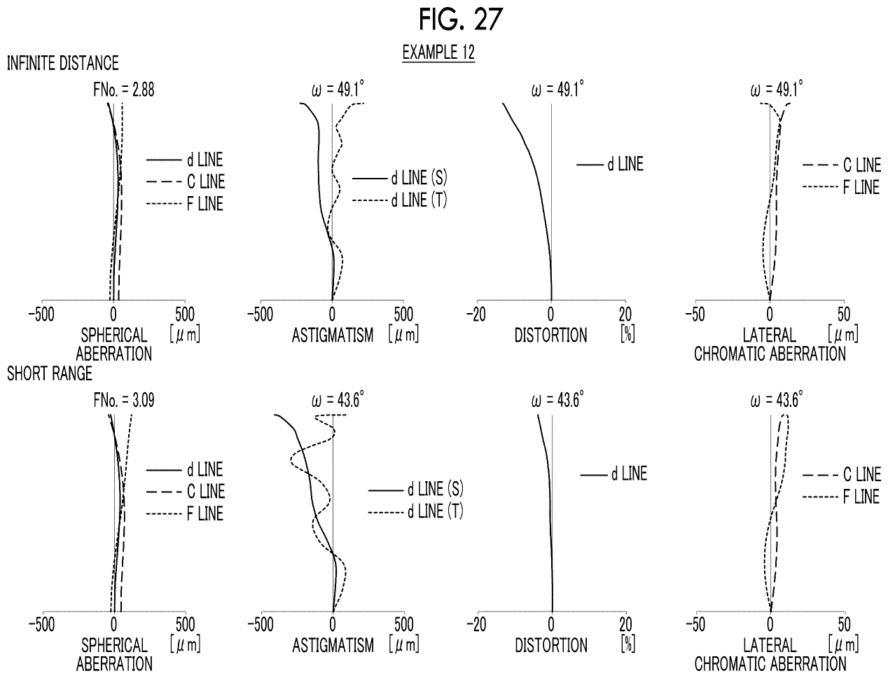

For the imaging lens of Example 12, Table 34 shows basic lens data, Table 35 shows specifications and a variable surface spacing, Table 36 shows aspherical coefficients, and FIG. 27 illustrates each aberration diagram.

TABLE 34
Example 12

| Sn | R | D | Nd | νd | Material | ED | Nd + 0.01 × νd | ρr | (dN/dT) × 10⁻⁶ |
|---|---|---|---|---|---|---|---|---|---|
| 1 | 219.7295 | 0.9999 | 1.48749 | 70.24 | S-FSL5 | | 2.18989 | | −0.8 |
| | | | | | OHARA | | | | |
| 2 | 14.2220 | 8.5840 | | | | | | | |
| 3 | 21.0809 | 0.5100 | 1.48749 | 70.24 | S-FSL5 | | 2.18989 | | −0.8 |
| | | | | | OHARA | | | | |
| 4 | 11.7673 | 2.8165 | 1.88300 | 39.22 | H-ZLAF68N | | 2.27520 | | 3.4 |
| | | | | | CDGM | | | | |
| 5 | 54.1300 | 1.4697 | | | | | | | |
| 6 (St) | ∞ | 4.0002 | | | | | | | |
| 7 | 25.8116 | 3.9958 | 1.88300 | 39.22 | H-ZLAF68N | | 2.27520 | 5.17 | 3.4 |
| | | | | | CDGM | | | | |
| 8 | −8.4580 | 0.7598 | 1.84666 | 23.78 | S-TIH53W | | 2.08446 | 3.54 | 1.3 |
| | | | | | OHARA | | | | |
| 9 | 30.9478 | 3.1967 | | | | | | | |
| *10 | −70.0223 | 2.0684 | 1.66121 | 20.35 | Plastic | | 1.86471 | 1.23 | |
| *11 | −37.7360 | 0.4541 | | | | | | | |
| *12 | −13.0604 | 4.2501 | 1.66121 | 20.35 | Plastic | 19.93 | 1.86471 | 1.23 | |
| | | | | | (LA2) | | | | |
| *13 | −13.9486 | DD[13] | | | | 21.66 | | | |
| *14 | −17.4635 | 2.6387 | 1.54436 | 56.03 | Plastic | 26.45 | 2.10466 | 1.04 | |
| | | | | | (LA2) | | | | |
| *15 | −15.7432 | 0.6776 | | | | 28.43 | | | |
| *16 | 19.6006 | 4.9998 | 1.54436 | 56.03 | Plastic | 33.71 | 2.10466 | 1.04 | |
| | | | | | (LA1) | | | | |
| *17 | 19.8367 | 9.6754 | | | | 35.94 | | | |

TABLE 35
Example 12

| | Infinite | Short Range |
|---|---|---|
| | Distance | 0.14 Times |
| Focal Length | 21.60 | — |
| Back Focus | 9.68 | 9.68 |
| Open F-Number | 2.88 | 3.09 |
| Maximum Full Angle of View [°] | 98.2 | 87.2 |
| DD[13] | 2.00 | 6.14 |

TABLE 36
Example 12

| Sn | 10 | 11 | 12 | 13 |
|---|---|---|---|---|
| KA | 1.0000000E+00 | 1.0000000E+00 | 1.0000000E+00 | 1.0000000E+00 |
| A4 | −6.4362716E−04 | 6.5949952E−06 | 6.8232071E−04 | 1.4580330E−04 |
| A6 | −9.0374246E−06 | −1.0014341E−05 | −5.8068816E−06 | −1.7224585E−06 |
| A8 | −5.4127092E−09 | 1.4446076E−07 | 3.4130627E−08 | 2.8943342E−08 |
| A10 | 1.3493291E−09 | −4.9492747E−10 | −1.0624010E−10 | −2.3569683E−10 |
| A12 | 1.8863959E−12 | −3.8107231E−13 | 2.2432858E−13 | 7.1660954E−13 |
| Sn | 14 | 15 | 16 | 17 |
| KA | 1.0000000E+00 | 1.0000000E+00 | 1.0000000E+00 | 1.0000000E+00 |
| A4 | 2.2464095E−04 | 1.1618548E−04 | −2.4973771E−04 | −2.3640987E−04 |
| A6 | −1.3035357E−06 | −1.0453166E−07 | 1.2174119E−06 | 1.3000311E−06 |
| A8 | 1.2728608E−08 | 1.0204189E−08 | −4.3650248E−09 | −6.7352756E−09 |
| A10 | −6.6970069E−11 | −7.1859771E−11 | 4.9282227E−12 | 2.1570317E−11 |
| A12 | 1.1373569E−13 | 1.5019192E−13 | 1.4594480E−14 | −4.1380152E−14 |
| A14 | 0.0000000E+00 | 0.0000000E+00 | −3.2594142E−17 | 3.5868486E−17 |

### Example 13

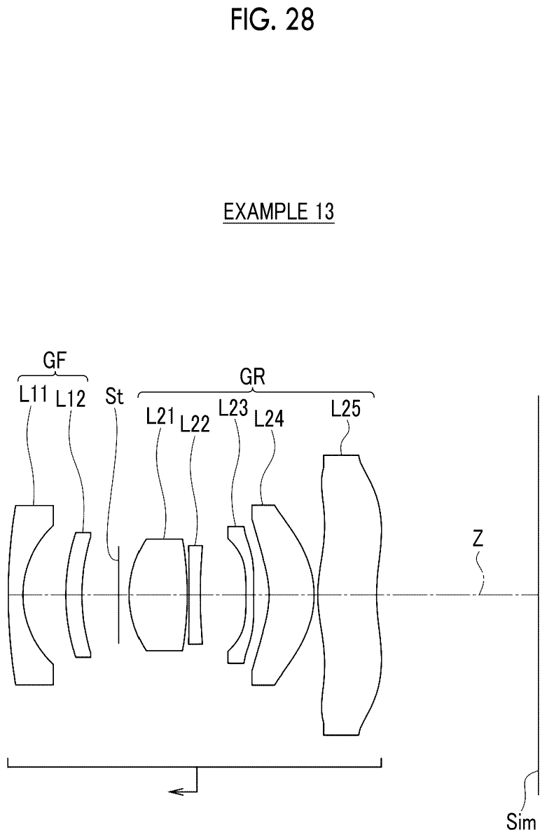

A cross-sectional view of a configuration of an imaging lens of Example 13 is illustrated in FIG. 28. The imaging lens of Example 13 consists of, in order from the object side to the image side, the front group GF, the aperture stop St, and the rear group GR. The front group GF consists of two lenses including the lenses L11 and L12 in order from the object side to the image side. The rear group GR consists of five lenses including the lenses L21 to L25 in order from the object side to the image side. During the focusing from the infinite distance object to the short range object, the entire imaging lens moves to the object side in an integrated manner.

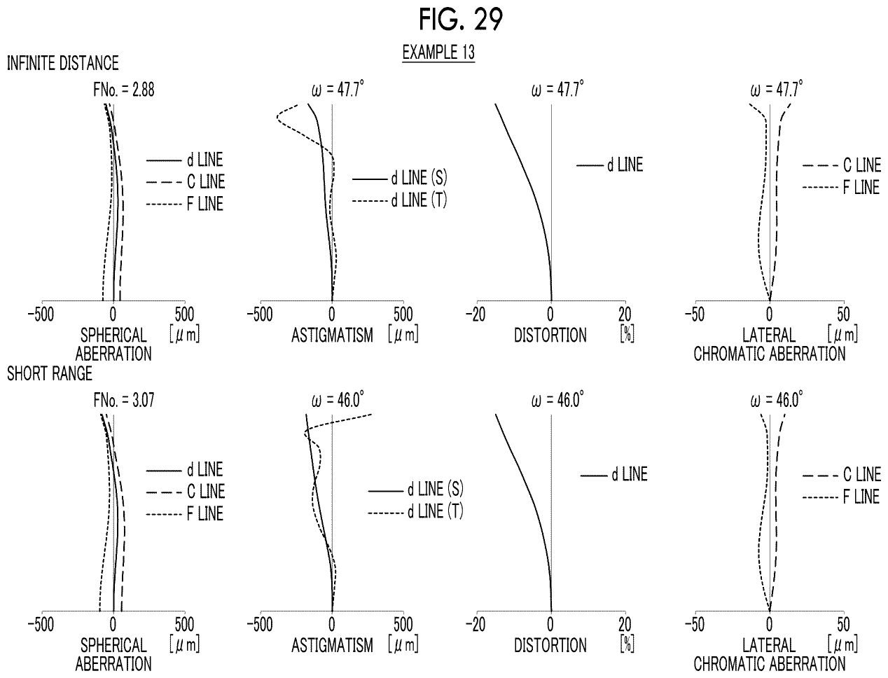

For the imaging lens of Example 13, Table 37 shows basic lens data, Table 38 shows specifications and a variable surface spacing, Table 39 shows aspherical coefficients, and FIG. 29 illustrates each aberration diagram.

TABLE 37
Example 13

| Sn | R | D | Nd | νd | Material | ED | Nd + 0.01 × νd | ρr | (dN/dT) × 10⁻⁶ |
|---|---|---|---|---|---|---|---|---|---|
| 1 | 41.0277 | 0.9998 | 1.48749 | 70.24 | S-FSL5 | | 2.18989 | | −0.8 |
| | | | | | OHARA | | | | |
| 2 | 7.0230 | 2.9194 | | | | | | | |
| 3 | 15.0172 | 1.1013 | 1.95906 | 17.47 | S-NPH3 | | 2.13376 | | 3.9 |
| | | | | | OHARA | | | | |
| 4 | 14.9040 | 2.5000 | | | | | | | |
| 5 (St) | ∞ | 0.7074 | | | | | | | |
| 6 | 7.5372 | 3.9270 | 1.64000 | 60.08 | S-BSM81 | | 2.24080 | 3.06 | 3.6 |
| | | | | | OHARA | | | | |
| 7 | −24.5607 | 0.1248 | | | | | | | |
| 8 | −192.4303 | 0.7625 | 1.80810 | 22.76 | S-NPH1W | | 2.03570 | 3.61 | −0.3 |
| | | | | | OHARA | | | | |
| 9 | 39.8496 | 3.1114 | | | | | | | |
| *10 | −65.4023 | 0.5253 | 1.66121 | 20.35 | Plastic | 8.08 | 1.86471 | 1.23 | |
| | | | | | (LA1) | | | | |
| *11 | 124.2080 | 1.0502 | | | | 9.43 | | | |
| *12 | −6.5734 | 3.0698 | 1.53409 | 55.87 | Plastic | 10.68 | 2.09279 | 1.01 | |
| | | | | | (LA2) | | | | |
| *13 | −6.9070 | 0.2498 | | | | 12.88 | | | |
| *14 | 10.7370 | 3.9993 | 1.53409 | 55.87 | Plastic | 18.34 | 2.09279 | 1.01 | |
| | | | | | (LA1) | | | | |
| *15 | 14.1711 | DD[15] | | | | 19.73 | | | |

TABLE 38
Example 13

| | Infinite | Short Range |
|---|---|---|
| | Distance | 0.12 Times |
| Focal Length | 15.21 | — |
| Back Focus | 10.84 | 12.66 |
| Open F-Number | 2.88 | 3.08 |
| Maximum Full Angle of View [°] | 95.4 | 92.0 |
| DD[15] | 10.84 | 12.66 |

TABLE 39
Example 13

| Sn | 10 | 11 | 12 |
|---|---|---|---|
| KA | 1.0000000E+00 | 1.0000000E+00 | 1.0000000E+00 |
| A4 | −4.7135536E−03 | −3.2760222E−03 | 3.2939998E−03 |
| A6 | 1.1990550E−05 | 7.4088553E−05 | −7.5636816E−05 |
| A8 | 2.3533047E−06 | −2.2810372E−07 | 3.4132418E−07 |
| A10 | −2.3324269E−07 | −1.5355086E−08 | 3.6139661E−08 |
| A12 | 9.5948555E−09 | 3.4809412E−09 | −5.5482439E−10 |
| A14 | 1.1763844E−09 | −5.5407058E−11 | 8.0670816E−12 |
| A16 | −8.8170232E−11 | 6.0577899E−13 | −8.1908050E−13 |
| A18 | 1.4624961E−12 | −9.8420964E−14 | 5.1217133E−14 |
| A20 | −1.3775610E−14 | 1.3614571E−15 | −9.4511772E−16 |
| Sn | 13 | 14 | 15 |
| KA | 1.0000000E+00 | 1.0000000E+00 | 1.0000000E+00 |
| A4 | 5.0219179E−04 | −1.6274188E−03 | −1.1984678E−03 |
| A6 | −4.6427378E−06 | 1.8099652E−05 | 1.4152909E−05 |
| A8 | 2.8199882E−07 | −9.1215574E−08 | −1.6163080E−07 |
| A10 | 4.8289165E−09 | −1.6928505E−11 | 1.3396223E−09 |
| A12 | −1.0684511E−10 | 2.8412171E−12 | −6.1406235E−12 |
| A14 | 1.7665335E−12 | −1.0807144E−14 | 1.8927157E−15 |
| A16 | −6.9419781E−14 | 5.1643871E−17 | 1.2473576E−16 |
| A18 | 9.3563130E−16 | −9.4626994E−19 | −1.1913490E−19 |
| A20 | 1.2060630E−17 | 6.4102853E−22 | 6.4888325E−22 |

### Example 14

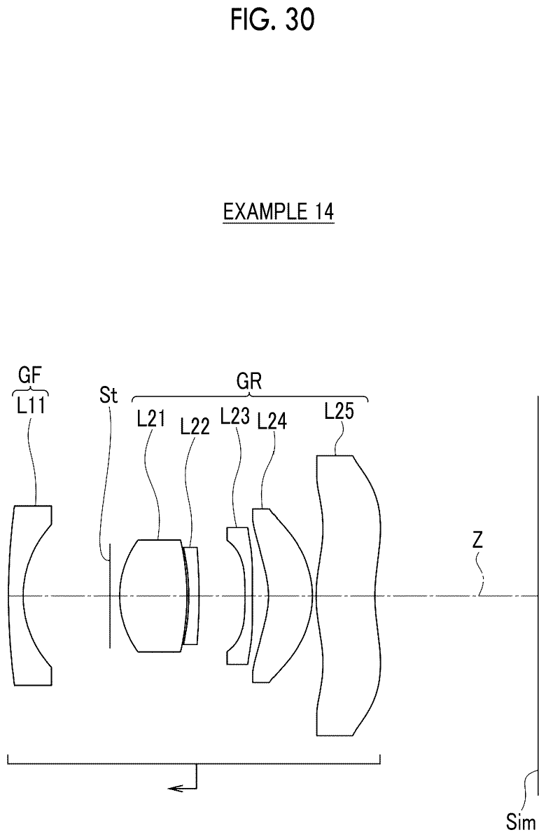

A cross-sectional view of a configuration of an imaging lens of Example 14 is illustrated in FIG. 30. The imaging lens of Example 14 consists of, in order from the object side to the image side, the front group GF, the aperture stop St, and the rear group GR. The front group GF consists of one lens that is the lens L11. The rear group GR consists of five lenses including the lenses L21 to L25 in order from the object side to the image side. During the focusing from the infinite distance object to the short range object, the entire imaging lens moves to the object side in an integrated manner.

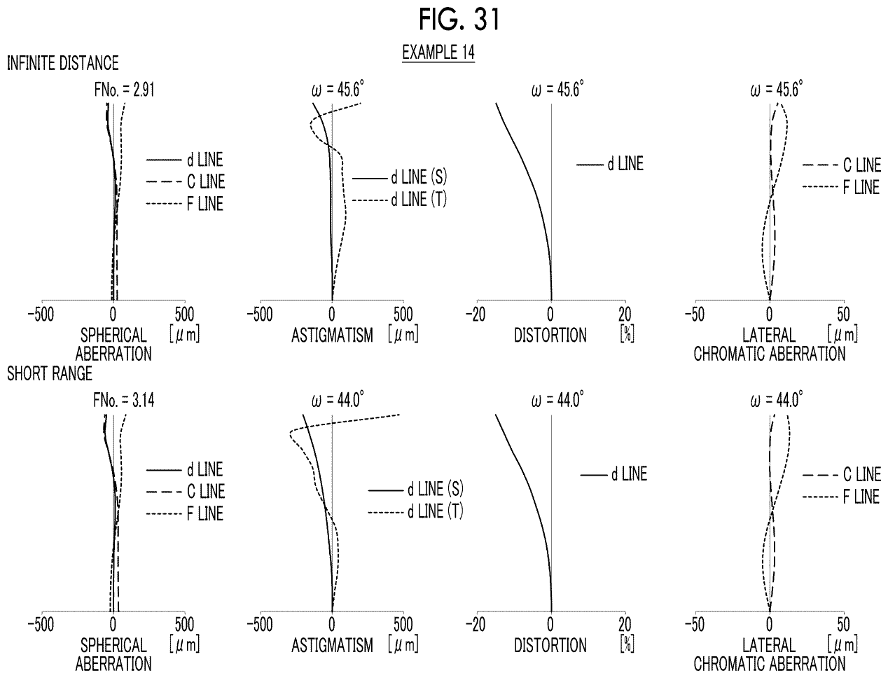

For the imaging lens of Example 14, Table 40 shows basic lens data, Table 41 shows specifications and a variable surface spacing, Table 42 shows aspherical coefficients, and FIG. 31 illustrates each aberration diagram.

TABLE 40
Example 14

| Sn | R | D | Nd | νd | Material | ED | Nd + 0.01 × νd | ρr | (dN/dT) × 10⁻⁶ |
|---|---|---|---|---|---|---|---|---|---|
| 1 | 50.5692 | 0.9998 | 1.48749 | 70.24 | S-FSL5 | | 2.18989 | | −0.8 |
| | | | | | OHARA | | | | |
| 2 | 7.7297 | 5.9034 | | | | | | | |
| 3 (St) | ∞ | 0.6624 | | | | | | | |
| 4 | 7.0062 | 4.5841 | 1.61772 | 49.81 | S-BSM28 | | 2.11582 | 3.23 | 1.3 |
| | | | | | OHARA | | | | |
| 5 | −18.8623 | 0.1252 | | | | | | | |
| 6 | −17.0816 | 0.7020 | 1.95906 | 17.47 | S-NPH3 | | 2.13376 | 3.59 | 3.9 |
| | | | | | OHARA | | | | |
| 7 | −42.8686 | 3.1287 | | | | | | | |
| *8 | −48.5647 | 0.4997 | 1.63894 | 22.97 | Plastic | 7.98 | 1.86864 | 1.23 | |
| | | | | | (LA1) | | | | |
| *9 | 69.5153 | 1.1014 | | | | 9.80 | | | |
| *10 | −6.2837 | 2.9534 | 1.53409 | 55.87 | Plastic | 10.78 | 2.09279 | 1.01 | |
| | | | | | (LA2) | | | | |
| *11 | −6.8699 | 0.2500 | | | | 12.40 | | | |
| *12 | 10.4874 | 4.0079 | 1.53409 | 55.87 | Plastic | 17.54 | 2.09279 | 1.01 | |
| | | | | | (LA1) | | | | |
| *13 | 13.5099 | DD[13] | | | | 19.63 | | | |

TABLE 41
Example 14

| | Infinite | Short Range |
|---|---|---|
| | Distance | 0.11 Times |
| Focal Length | 16.31 | — |
| Back Focus | 11.12 | 12.91 |
| Open F-Number | 2.91 | 3.14 |
| Maximum Full Angle of View [°] | 91.2 | 88.0 |
| DD[13] | 11.12 | 12.91 |

TABLE 42
Example 14

| Sn | 8 | 9 | 10 |
|---|---|---|---|
| KA | 1.0000000E+00 | 1.0000000E+00 | 1.0000000E+00 |
| A4 | −3.8184798E−03 | −2.0130235E−03 | 3.7306370E−03 |
| A6 | −3.0883602E−05 | 6.8342675E−05 | −8.5318463E−05 |
| A8 | 7.0207751E−06 | −8.0440503E−07 | 6.1540917E−07 |
| A10 | −6.3694534E−07 | −4.5376302E−08 | 2.6771630E−08 |
| A12 | 1.6971356E−08 | 2.5963280E−09 | −1.4312782E−10 |
| A14 | 3.3869643E−10 | −4.5499939E−11 | 7.5168249E−12 |
| A16 | −5.7573041E−11 | 1.8045125E−12 | −9.8879268E−13 |
| A18 | 3.7797765E−12 | −4.3129447E−14 | 5.0639794E−14 |
| A20 | −1.3467825E−13 | −2.1615514E−16 | −8.1945790E−16 |
| Sn | 11 | 12 | 13 |
| KA | 1.0000000E+00 | 1.0000000E+00 | 1.0000000E+00 |
| A4 | 5.3362746E−04 | −1.6558216E−03 | −1.1765851E−03 |
| A6 | −1.8691166E−05 | 1.7418249E−05 | 1.3469154E−05 |
| A8 | 3.9065538E−07 | −9.8084154E−08 | −1.5962881E−07 |
| A10 | 5.7244022E−09 | 8.0577301E−11 | 1.2966552E−09 |
| A12 | −2.1882041E−10 | 3.0919728E−12 | −5.8180569E−12 |
| A14 | 5.4308176E−12 | −1.5969193E−14 | 4.3545532E−15 |
| A16 | −3.0134151E−14 | 1.1372973E−16 | 3.2578361E−17 |
| A18 | 7.0372259E−16 | −1.1687087E−18 | 1.7920971E−19 |
| A20 | −5.7713287E−19 | −2.0144617E−21 | 2.2287406E−21 |

### Example 15

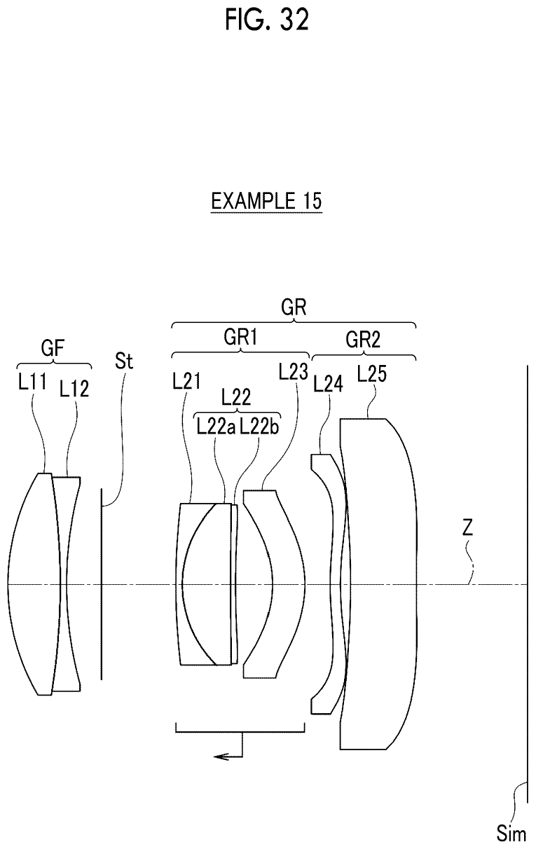

A cross-sectional view of a configuration of an imaging lens of Example 15 is illustrated in FIG. 32. The imaging lens of Example 15 consists of, in order from the object side to the image side, the front group GF, the aperture stop St, and the rear group GR. The front group GF consists of two lenses including the lenses L11 and L12 in order from the object side to the image side. A cemented lens in which the lens L11 and the lens L12 are cemented corresponds to the LFp lens. The rear group GR consists of the first subsequent lens group GR1 and the second subsequent lens group GR2 in order from the object side to the image side. The first subsequent lens group GR1 consists of three lenses including the lenses L21 to L23 in order from the object side to the image side. The second subsequent lens group GR2 consists of two lenses including the lenses L24 and L25 in order from the object side to the image side. The lens L22 is a compound aspherical lens in which a resin L22b of which a surface in contact with air has an aspherical shape is formed on a spherical surface of a lens L22a made of glass. During the focusing from the infinite distance object to the short range object, only the first subsequent lens group GR1 moves to the object side, and other lenses are fixed with respect to the image plane Sim.

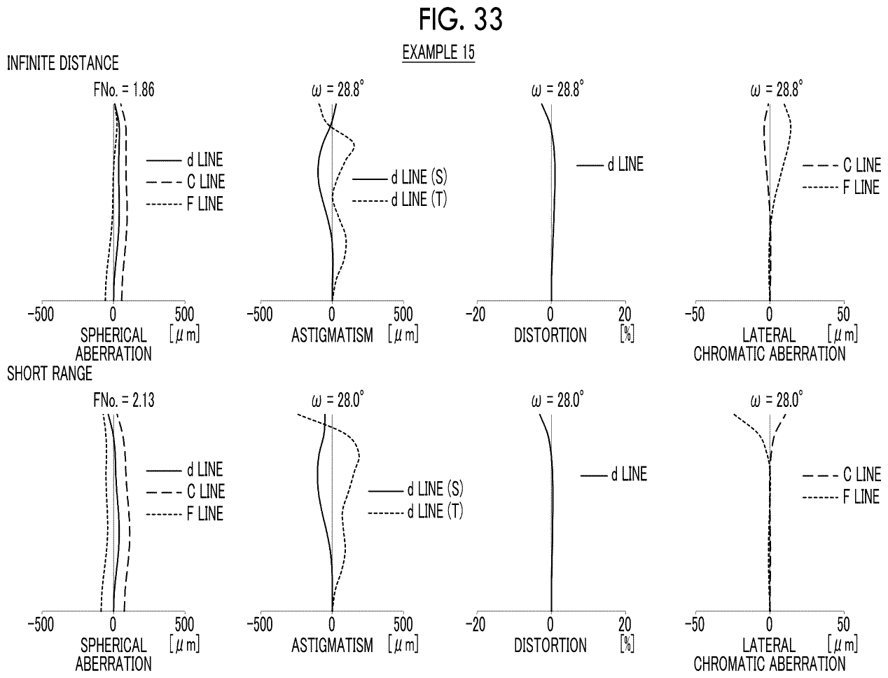

For the imaging lens of Example 15, Table 43 shows basic lens data, Table 44 shows specifications and a variable surface spacing, Table 45 shows aspherical coefficients, and FIG. 33 illustrates each aberration diagram.

TABLE 43
Example 15

| Sn | R | D | Nd | νd | Material | ED | Nd + 0.01 × νd | ρr | (dN/dT) × 10⁻⁶ |
|---|---|---|---|---|---|---|---|---|---|
| 1 | 21.8173 | 5.1588 | 1.88300 | 39.22 | H-ZLAF68N | | 2.27520 | | 3.4 |
| | | | | | CDGM | | | | |
| 2 | −68.9543 | 0.6248 | 2.00330 | 28.27 | S-LAH79 | | 2.28600 | | 9.4 |
| | | | | | OHARA | | | | |
| 3 | 37.5149 | 3.4476 | | | | | | | |
| 4 (St) | ∞ | DD[4] | | | | | | | |
| 5 | 68.2445 | 0.6348 | 1.69895 | 30.13 | S-TIM35 | | 2.00025 | 3.59 | 3.6 |
| | | | | | OHARA | | | | |
| 6 | 11.2200 | 4.7614 | 1.88300 | 39.22 | H-ZLAF68N | | 2.27520 | 5.17 | 3.4 |
| | | | | | CDGM | | | | |
| 7 | 460.4947 | 0.4841 | 1.56093 | 36.64 | Plastic | | | | |
| *8 | 85.4256 | 3.5902 | | | | | | | |
| *9 | −11.6203 | 3.1961 | 1.76450 | 49.10 | Plastic | 15.94 | 2.25550 | 4.29 | |
| | | | | | (LA2) | | | | |
| *10 | −12.0140 | DD[10] | | | | 18.56 | | | |
| *11 | 36.1741 | 0.9998 | 1.54436 | 56.03 | Plastic | 22.80 | 2.10466 | 1.04 | |
| | | | | | (LA1) | | | | |
| *12 | 30.2062 | 1.0000 | | | | 25.70 | | | |
| *13 | −76.3174 | 6.4928 | 1.54436 | 56.03 | Plastic | 27.36 | 2.10466 | 1.04 | |
| | | | | | (LA1) | | | | |
| *14 | 191.2793 | 10.9501 | | | | 32.67 | | | |

TABLE 44
Example 15

| | | Short Range |
|---|---|---|
| | Infinite Distance | 0.11 Times |
| Focal Length | 40.36 | — |
| Back Focus | 10.95 | 10.95 |
| Open F-Number | 1.86 | 2.13 |
| Maximum Full Angle of View [°] | 57.6 | 56.0 |
| DD[4] | 7.32 | 3.13 |
| DD[10] | 2.50 | 6.69 |

TABLE 45
Example 15

| Sn | 8 | 13 |
|---|---|---|
| KA | 1.0000000E+00 | 1.0000000E+00 |
| A4 | −3.5695631E−06 | 3.8317905E−05 |
| A6 | −1.0745266E−06 | −3.8547294E−07 |
| A8 | 1.7849417E−08 | 1.6127232E−09 |
| A10 | −3.1369113E−10 | −4.5139850E−13 |
| A12 | 1.2547200E−12 | −8.6887742E−15 |
| A14 | 1.7146045E−15 | 1.3714200E−18 |
| A16 | −9.4541541E−18 | −3.6090211E−19 |
| A18 | 1.9585172E−19 | 1.5177317E−21 |

| Sn | 9 | 10 | 11 |
|---|---|---|---|
| KA | 1.0000000E+00 | 1.0000000E+00 | 1.0000000E+00 |
| A4 | 3.1947976E−05 | 8.9475407E−05 | −1.6142973E−04 |
| A6 | −1.3210847E−07 | 3.1854499E−07 | −1.8211077E−07 |
| A8 | 2.0812021E−08 | 8.6779805E−09 | −3.1980589E−09 |
| A10 | −6.4239160E−11 | 3.1221767E−11 | 8.9077238E−12 |

| Sn | 12 | 14 |
|---|---|---|
| KA | 1.0000000E+00 | 1.0000000E+00 |
| A4 | −9.6780652E−05 | −5.3479021E−05 |
| A6 | −5.1716785E−07 | −4.3224097E−08 |
| A8 | 2.9994564E−10 | 8.1568718E−10 |
| A10 | 7.3485722E−12 | −2.3315985E−12 |

### Example 16

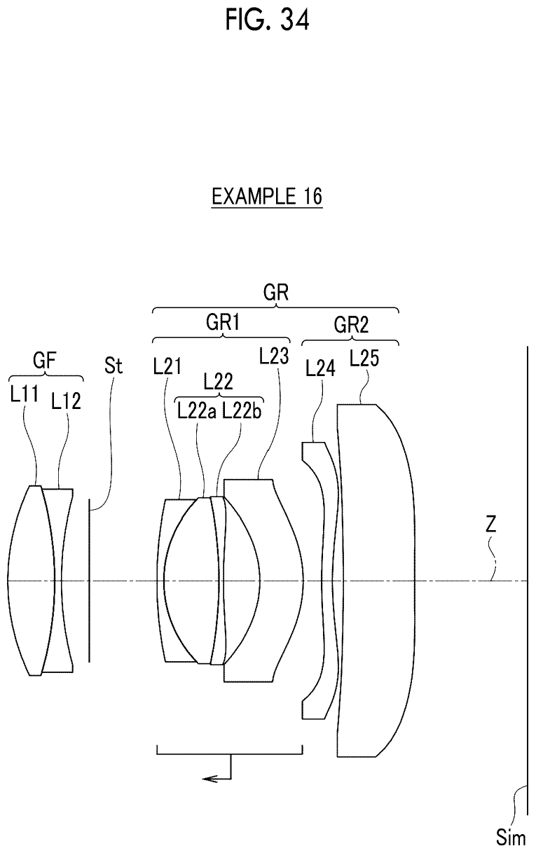

A cross-sectional view of a configuration of an imaging lens of Example 16 is illustrated in FIG. 34. The imaging lens of Example 16 consists of, in order from the object side to the image side, the front group GF, the aperture stop St, and the rear group GR. The front group GF consists of two lenses including the lenses L11 and L12 in order from the object side to the image side. A cemented lens in which the lens L11 and the lens L12 are cemented corresponds to the LFp lens. The rear group GR consists of the first subsequent lens group GR1 and the second subsequent lens group GR2 in order from the object side to the image side. The first subsequent lens group GR1 consists of three lenses including the lenses L21 to L23 in order from the object side to the image side. The second subsequent lens group GR2 consists of two lenses including the lenses L24 and L25 in order from the object side to the image side. The lens L22 is a compound aspherical lens in which the resin L22b of which the surface in contact with air has an aspherical shape is formed on the spherical surface of the lens L22a made of glass. During the focusing from the infinite distance object to the short range object, only the first subsequent lens group GR1 moves to the object side, and other lenses are fixed with respect to the image plane Sim.

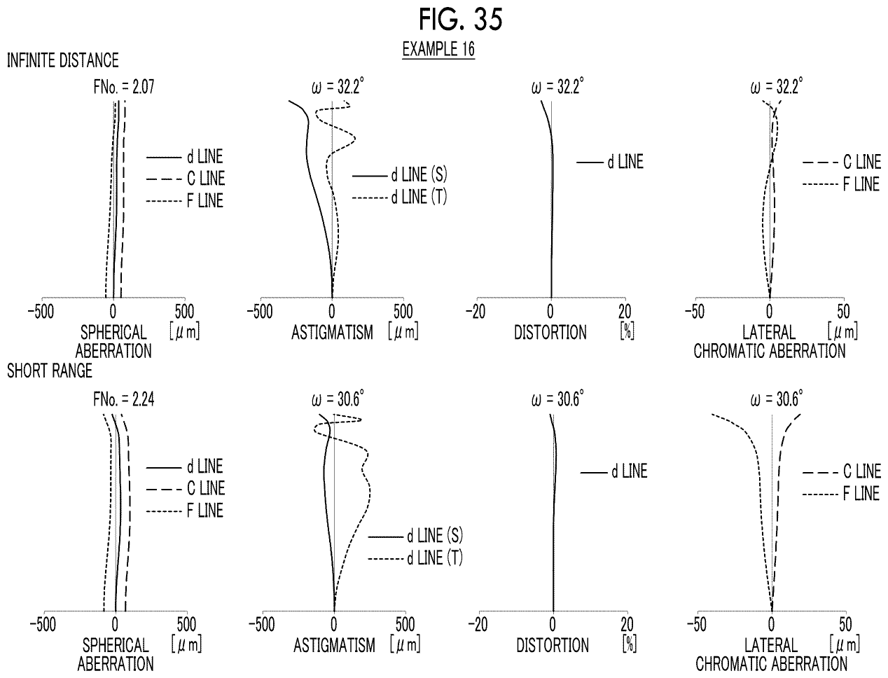

For the imaging lens of Example 16, Table 46 shows basic lens data, Table 47 shows specifications and a variable surface spacing, Table 48 shows aspherical coefficients, and FIG. 35 illustrates each aberration diagram.

TABLE 46
Example 16

| Sn | R | D | Nd | νd | Material | ED | Nd + 0.01 × νd | ρr | (dN/dT) × 10⁻⁶ |
|---|---|---|---|---|---|---|---|---|---|
| 1 | 20.2349 | 4.3307 | 1.88300 | 39.22 | H-ZLAF68N | | 2.27520 | | 3.4 |
| | | | | | CDGM | | | | |
| 2 | −31.1510 | 0.6248 | 1.95375 | 32.32 | S-LAH98 | | 2.27695 | | 4.3 |
| | | | | | OHARA | | | | |
| 3 | 30.0174 | 2.5796 | | | | | | | |
| 4 (St) | ∞ | DD[4] | | | | | | | |
| 5 | 36.7706 | 0.6348 | 1.75520 | 27.51 | S-TIH4 | | 2.03030 | 3.15 | 2.1 |
| | | | | | OHARA | | | | |
| 6 | 10.8551 | 5.0909 | 1.88300 | 39.22 | H-ZLAF68N | | 2.27520 | 5.17 | 3.4 |
| | | | | | CDGM | | | | |
| 7 | −38.1074 | 0.4192 | 1.56093 | 36.64 | Plastic | | | | |
| *8 | 51.9298 | 3.3596 | | | | | | | |
| *9 | −9.6753 | 3.9572 | 1.76450 | 49.10 | Plastic | 7.80 | 2.25550 | 4.29 | |
| | | | | | (LA2) | | | | |
| *10 | −11.1562 | DD[10] | | | | 9.41 | | | |
| *11 | 45.4646 | 0.9998 | 1.54436 | 56.03 | Plastic | 11.20 | 2.10466 | 1.04 | |
| | | | | | (LA1) | | | | |
| *12 | 34.3859 | 1.0000 | | | | 12.86 | | | |
| *13 | −164.2272 | 6.5743 | 1.54436 | 56.03 | Plastic | 14.25 | 2.10466 | 1.04 | |
| | | | | | (LA1) | | | | |
| *14 | 213.1863 | 10.4434 | | | | 16.40 | | | |

TABLE 47
Example 16

| | | Short Range |
|---|---|---|
| | Infinite Distance | 0.11 Times |
| Focal Length | 35.29 | — |
| Back Focus | 10.44 | 10.44 |
| Open F-Number | 2.07 | 2.24 |
| Maximum Full Angle of View [°] | 64.4 | 61.2 |
| DD[4] | 6.24 | 2.70 |
| DD[10] | 1.70 | 5.24 |

TABLE 48
Example 16

| Sn | 8 | 13 |
|---|---|---|
| KA | 1.0000000E+00 | 1.0000000E+00 |
| A4 | −3.2509946E−05 | 2.8226800E−05 |
| A6 | −1.6525147E−06 | −3.7077088E−07 |
| A8 | 9.4986296E−09 | 1.5273284E−09 |
| A10 | −3.5437544E−10 | −9.8467274E−13 |
| A12 | 1.9836068E−12 | 1.7245701E−16 |
| A14 | −1.7799074E−14 | 2.7904640E−17 |
| A16 | −4.3150700E−16 | −5.4396740E−19 |
| A18 | 3.3228041E−18 | 1.5561899E−21 |

| Sn | 9 | 10 | 11 |
|---|---|---|---|
| KA | 1.0000000E+00 | 1.0000000E+00 | 1.0000000E+00 |
| A4 | 1.1658185E−04 | 1.5702959E−04 | −1.0589494E−04 |
| A6 | −5.3899679E−07 | 3.1598672E−07 | −6.1037013E−07 |
| A8 | 3.2733121E−08 | 7.4871741E−09 | −3.1045634E−10 |
| A10 | −1.5029693E−10 | 7.6557778E−11 | −7.3678974E−12 |

| Sn | 12 | 14 |
|---|---|---|
| KA | 1.0000000E+00 | 1.0000000E+00 |
| A4 | −6.0019157E−05 | −7.7427984E−05 |
| A6 | −5.9223569E−07 | 1.4867927E−07 |
| A8 | −9.5885454E−10 | 4.1064725E−11 |
| A10 | 1.4509221E−11 | −1.2215942E−12 |

### Example 17

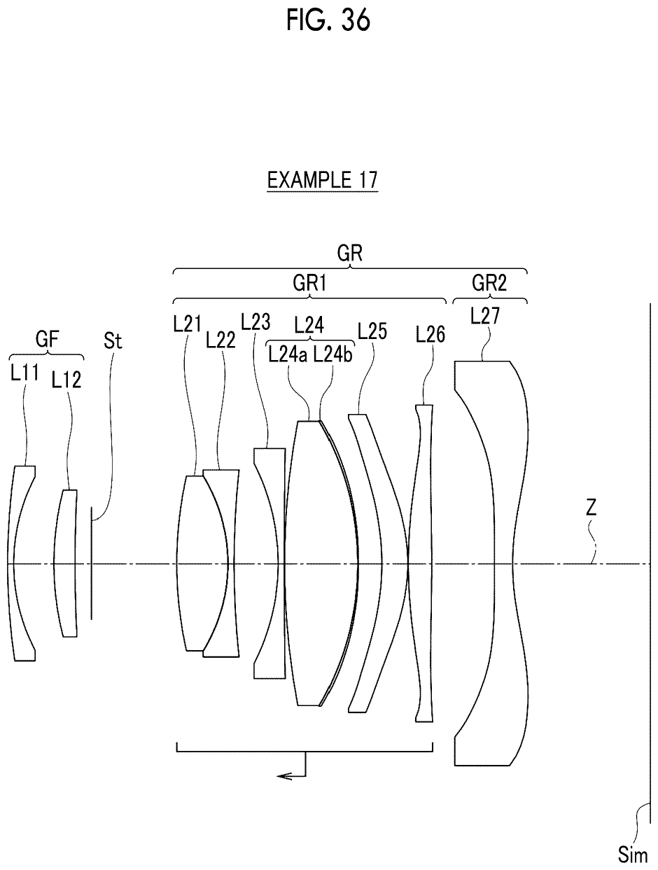

A cross-sectional view of a configuration of an imaging lens of Example 17 is illustrated in FIG. 36. The imaging lens of Example 17 consists of, in order from the object side to the image side, the front group GF, the aperture stop St, and the rear group GR. The front group GF consists of two lenses including the lenses L11 and L12 in order from the object side to the image side. The lens L12 corresponds to the LFp lens. The rear group GR consists of the first subsequent lens group GR1 and the second subsequent lens group GR2 in order from the object side to the image side. The first subsequent lens group GR1 consists of six lenses including the lenses L21 to L26 in order from the object side to the image side. The second subsequent lens group GR2 consists of one lens that is a lens L27. The lens L24 is a compound aspherical lens in which a resin L24b of which a surface in contact with air has an aspherical shape is formed on a spherical surface of a lens L24a made of glass. During the focusing from the infinite distance object to the short range object, only the first subsequent lens group GR1 moves to the object side, and other lenses are fixed with respect to the image plane Sim.

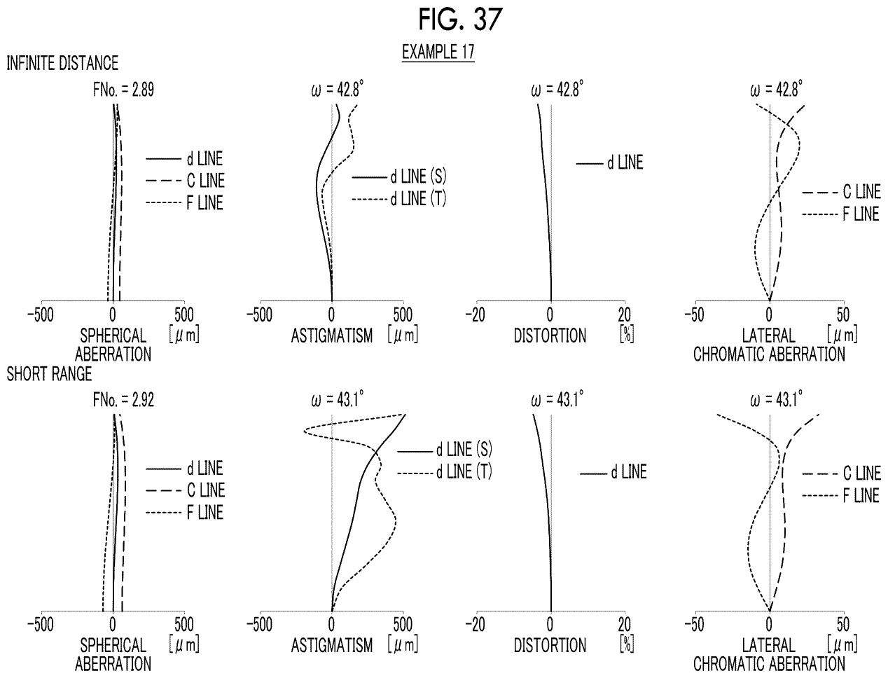

For the imaging lens of Example 17, Table 49 shows basic lens data, Table 50 shows specifications and a variable surface spacing, Table 51 shows aspherical coefficients, and FIG. 37 illustrates each aberration diagram.

TABLE 49
Example 17

| Sn | R | D | Nd | νd | Material | ED | Nd + 0.01 × νd | ρr | (dN/dT) × 10⁻⁶ |
|---|---|---|---|---|---|---|---|---|---|
| 1 | 55.8509 | 0.4998 | 1.76200 | 40.10 | S-LAM55 | | 2.16300 | | 3.7 |
| | | | | | OHARA | | | | |
| 2 | 15.5611 | 3.3363 | | | | | | | |
| 3 | 24.5301 | 1.7493 | 2.00330 | 28.27 | S-LAH79 | | 2.28600 | | 9.4 |
| | | | | | OHARA | | | | |
| 4 | 123.5418 | 1.3461 | | | | | | | |
| 5 (St) | ∞ | DD[5] | | | | | | | |
| 6 | 33.0217 | 4.2386 | 1.95375 | 32.32 | S-LAH98 | | 2.27695 | 4.94 | 4.3 |
| | | | | | OHARA | | | | |
| 7 | −13.9120 | 0.5097 | 1.86074 | 23.08 | J-SFH2 | | 2.09154 | 3.82 | −2.9 |
| | | | | | HIKARI | | | | |
| 8 | 73.6412 | 3.6501 | | | | | | | |
| 9 | −18.3490 | 0.5003 | 1.95906 | 17.47 | S-NPH3 | | 2.13376 | 3.59 | 3.9 |
| | | | | | OHARA | | | | |
| 10 | 551.8993 | 0.0367 | | | | | | | |
| 11 | 64.1954 | 6.0175 | 2.00100 | 29.13 | TAFD55 | | 2.29230 | 5.12 | 4.4 |
| | | | | | HOYA | | | | |
| 12 | −23.7309 | 0.0500 | 1.56093 | 36.64 | Plastic | | | | |
| *13 | −29.5101 | 1.9329 | | | | | | | |
| *14 | −21.8441 | 2.1548 | 1.66121 | 20.35 | Plastic | 12.06 | 1.86471 | 1.23 | |
| | | | | | (LA2) | | | | |
| *15 | −14.9185 | 0.0490 | | | | 12.41 | | | |
| *16 | 40.1373 | 1.9318 | 1.54436 | 56.03 | Plastic | 12.85 | 2.10466 | 1.04 | |
| | | | | | (LA2) | | | | |
| *17 | −172.9958 | DD[17] | | | | 13.18 | | | |
| *18 | −703.2034 | 1.4998 | 1.54436 | 56.03 | Plastic | 14.47 | 2.10466 | 1.04 | |
| | | | | | (LA1) | | | | |
| *19 | 19.2716 | 11.3964 | | | | 16.85 | | | |

TABLE 50
Example 17

| | | Short Range |
|---|---|---|
| | Infinite Distance | 0.102 Times |
| Focal Length | 24.25 | — |
| Back Focus | 11.40 | 11.40 |
| Open F-Number | 2.89 | 2.92 |
| Maximum Full Angle of View [°] | 85.6 | 86.2 |
| DD[5] | 7.08 | 5.68 |
| DD[17] | 5.20 | 6.59 |

TABLE 51
Example 17

| Sn | 13 | 14 | 15 |
|---|---|---|---|
| KA | 1.0000000E+00 | 1.0000000E+00 | 1.0000000E+00 |
| A4 | −4.2517228E−05 | 4.3882817E−06 | 8.8041449E−05 |
| A6 | 6.8973419E−08 | 6.9582592E−07 | 5.5494277E−07 |
| A8 | 1.6227441E−09 | −3.0872114E−09 | −1.5247084E−09 |
| A10 | −1.1049730E−11 | 4.0984502E−12 | −1.1600322E−12 |
| A12 | −1.6222138E−14 | 1.2050526E−14 | −2.1729222E−15 |
| A14 | 1.7826454E−16 | −4.6848236E−16 | −1.1007359E−17 |
| A16 | 3.3867973E−20 | 1.4689704E−18 | 1.6075760E−19 |

| Sn | 16 | 17 | 18 | 19 |
|---|---|---|---|---|
| KA | 1.0000000E+00 | 1.0000000E+00 | 1.0000000E+00 | 1.0000000E+00 |
| A4 | −2.3764281E−05 | 3.3748307E−05 | −6.3920165E−05 | −1.9292104E−04 |
| A6 | 6.4055735E−08 | −1.8708045E−07 | −7.4527983E−07 | 4.2352564E−07 |
| A8 | −1.2151617E−09 | 9.7456997E−10 | 6.5124001E−09 | −2.5271473E−10 |
| A10 | −1.9672856E−12 | −2.1607220E−12 | −1.4951112E−11 | −1.4455246E−12 |

### Example 18

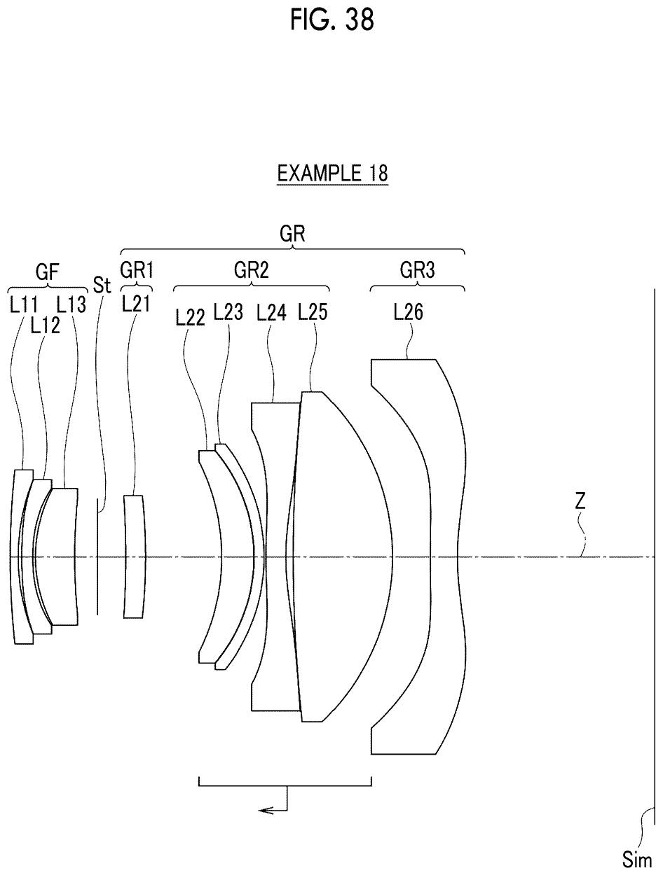

A cross-sectional view of a configuration of an imaging lens of Example 18 is illustrated in FIG. 38. The imaging lens of Example 18 consists of, in order from the object side to the image side, the front group GF, the aperture stop St, and the rear group GR. The front group GF consists of three lenses including the lenses L11 to L13 in order from the object side to the image side. The lens L13 corresponds to the LFp lens. The rear group GR consists of the first subsequent lens group GR1, the second subsequent lens group GR2, and a third subsequent lens group GR3 in order from the object side to the image side. The first subsequent lens group GR1 consists of one lens that is the lens L21. The second subsequent lens group GR2 consists of four lenses including the lenses L22 to L25 in order from the object side to the image side. The third subsequent lens group GR3 consists of one lens that is the lens L26. During the focusing from the infinite distance object to the short range object, only the second subsequent lens group GR2 moves to the object side, and other lenses are fixed with respect to the image plane Sim.

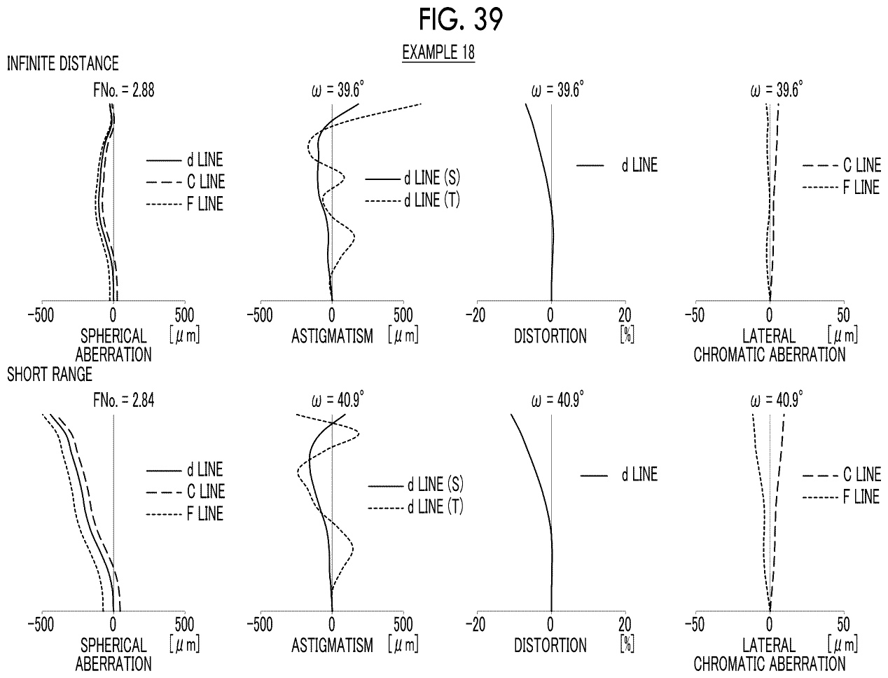

For the imaging lens of Example 18, Table 52 shows basic lens data, Table 53 shows specifications and a variable surface spacing, Table 54 shows aspherical coefficients, and FIG. 39 illustrates each aberration diagram.

TABLE 52
Example 18

| Sn | R | D | Nd | νd | Material | ED | Nd + 0.01 × νd | ρr | (dN/dT) × 10⁻⁶ |
|---|---|---|---|---|---|---|---|---|---|
| 1 | 43.7681 | 0.4190 | 1.47047 | 66.88 | H-QK1 | | 2.13927 | | 0.2 |
| | | | | | CDGM | | | | |
| 2 | 11.0379 | 0.1912 | | | | | | | |
| *3 | 27.2422 | 0.5783 | 1.63351 | 23.63 | Plastic | | 1.86981 | | |
| *4 | 9.3628 | 0.1434 | | | | | | | |
| 5 | 7.7095 | 2.0723 | 1.90043 | 37.37 | TAFD37 | | 2.27413 | | 4.3 |
| | | | | | HOYA | | | | |
| 6 | 31.2759 | 1.1986 | | | | | | | |
| 7 (St) | ∞ | 1.4995 | | | | | | | |
| 8 | −50.6883 | 1.0485 | 1.75500 | 52.32 | H-LAK53A | | 2.27820 | 4.39 | 3.9 |
| | | | | | CDGM | | | | |
| 9 | −30.7549 | DD[9] | | | | | | | |
| 10 | −11.2692 | 1.7076 | 1.88100 | 40.14 | TAFD33 | | 2.28240 | 5.40 | 4.5 |
| | | | | | HOYA | | | | |
| 11 | −8.7988 | 0.5298 | 1.98613 | 16.48 | FDS16-W | | 2.15093 | 3.54 | 8.5 |
| | | | | | HOYA | | | | |
| 12 | −9.8283 | 0.1002 | | | | | | | |
| *13 | 35.5729 | 1.0500 | 1.58364 | 30.27 | Plastic | 8.19 | 1.88634 | 1.20 | |
| *14 | 14.0089 | 0.3916 | | | | 7.29 | | | |
| 15 | 82.2513 | 5.2206 | 1.77250 | 49.60 | S-LAH66 | 13.56 | 2.26850 | 4.23 | 4.5 |
| | | | | | OHARA | | | | |
| 16 | −12.2759 | DD[16] | | | | 16.41 | | | |
| *17 | 90.5890 | 1.4305 | 1.63351 | 23.63 | Plastic | 18.14 | 1.86981 | 1.24 | |
| | | | | | (LA1) | | | | |
| *18 | 15.6753 | 10.4300 | | | | 21.03 | | | |

TABLE 53
Example 18

| | Infinite | Short Range |
|---|---|---|
| | Distance | 0.13 Times |
| Focal Length | 18.47 | — |
| Back Focus | 10.43 | 10.43 |
| Open F-Number | 2.88 | 2.84 |
| Maximum Full Angle of View [°] | 79.2 | 81.8 |
| DD[9] | 4.02 | 2.58 |
| DD[16] | 2.00 | 3.44 |

TABLE 54
Example 18

| Sn | 3 | 4 | 13 |
|---|---|---|---|
| KA | −5.0000059E+00 | 1.7929640E+00 | −2.4844630E+00 |
| A4 | 2.1408148E−03 | 2.3110151E−03 | −5.8242412E−04 |
| A6 | −1.4165688E−04 | −2.4556606E−04 | −5.9090274E−05 |
| A8 | 1.6780113E−05 | 7.0038987E−05 | 5.5467709E−06 |
| A10 | −2.6997772E−06 | −1.6674544E−05 | −2.8253576E−07 |
| A12 | 3.1770048E−07 | 2.4248427E−06 | 9.7034120E−09 |
| A14 | −2.2562272E−08 | −2.1163322E−07 | −2.2534641E−10 |
| A16 | 9.0129719E−10 | 1.0831487E−08 | 3.3089269E−12 |
| A18 | −1.8108732E−11 | −2.9994302E−10 | −2.7323524E−14 |
| A20 | 1.3445653E−13 | 3.4928382E−12 | 9.6372207E−17 |
| Sn | 14 | 17 | 18 |
| KA | 1.9333197E+00 | −4.9999926E+00 | 1.4680553E−01 |
| A4 | −6.1161880E−04 | −3.1456770E−04 | −2.3727564E−04 |
| A6 | −3.6972586E−05 | −3.6831893E−05 | −3.7524976E−05 |
| A8 | 2.8868476E−06 | 1.8098835E−06 | 1.6124168E−06 |
| A10 | −1.0377002E−07 | −6.0232123E−08 | −3.8500655E−08 |
| A12 | 2.3157065E−09 | 1.4054504E−09 | 5.9434739E−10 |
| A14 | −3.3883868E−11 | −2.0753660E−11 | −5.8945892E−12 |
| A16 | 3.1622654E−13 | 1.8171504E−13 | 3.5764982E−14 |
| A18 | −1.6993116E−15 | −8.6459833E−16 | −1.1984794E−16 |
| A20 | 3.9743527E−18 | 1.7438925E−18 | 1.6888164E−19 |

### Example 19

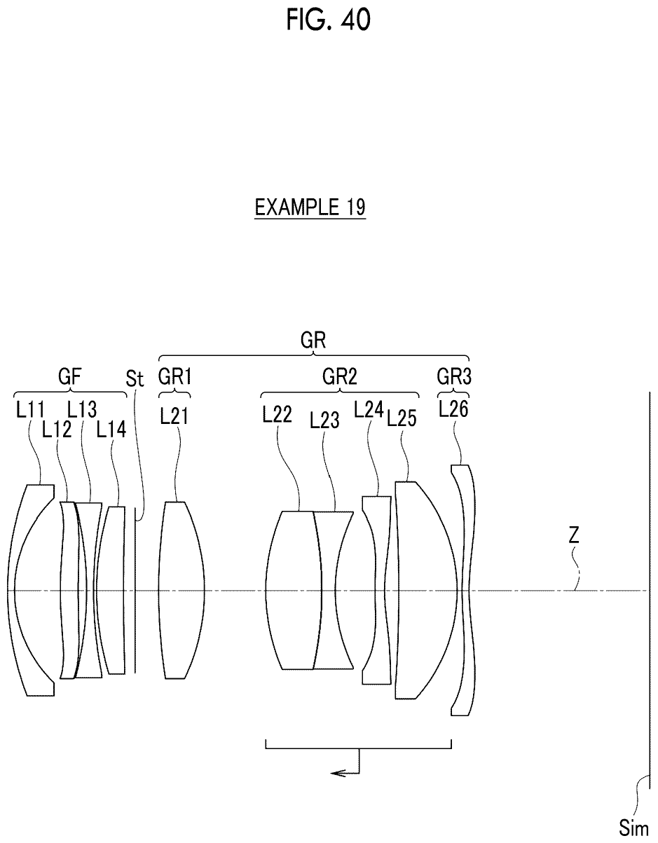

A cross-sectional view of a configuration of an imaging lens of Example 19 is illustrated in FIG. 40. The imaging lens of Example 19 consists of, in order from the object side to the image side, the front group GF, the aperture stop St, and the rear group GR. The front group GF consists of four lenses including lenses L11 to L14 in order from the object side to the image side. The lens L12 and the lens L14 correspond to the LFp lens. The rear group GR consists of the first subsequent lens group GR1, the second subsequent lens group GR2, and the third subsequent lens group GR3 in order from the object side to the image side. The first subsequent lens group GR1 consists of one lens that is the lens L21. The second subsequent lens group GR2 consists of four lenses including the lenses L22 to L25 in order from the object side to the image side. The third subsequent lens group GR3 consists of one lens that is the lens L26. During the focusing from the infinite distance object to the short range object, only the second subsequent lens group GR2 moves to the object side, and other lenses are fixed with respect to the image plane Sim.

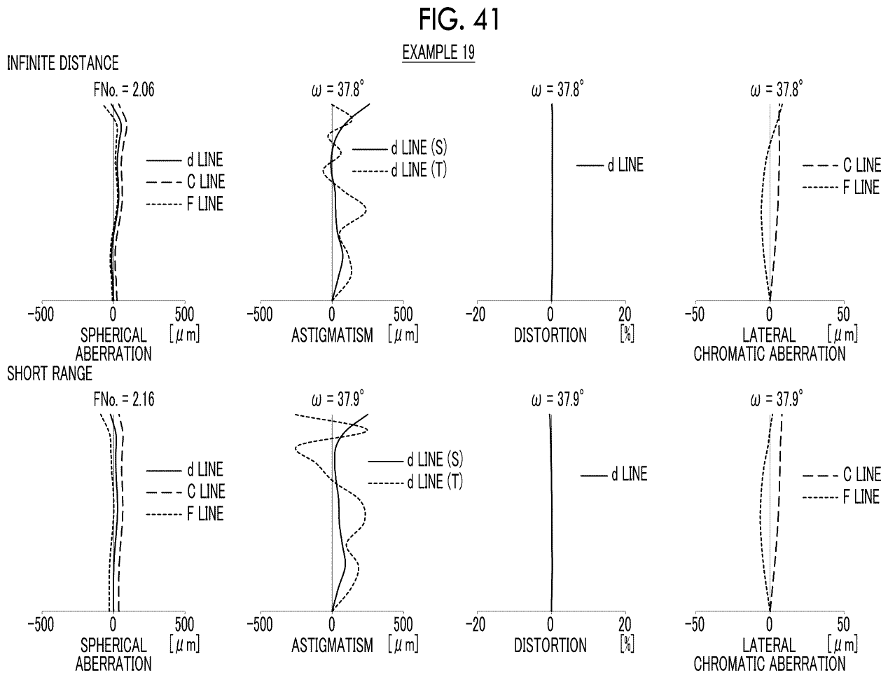

For the imaging lens of Example 19, Table 55 shows basic lens data, Table 56 shows specifications and a variable surface spacing, Table 57 shows aspherical coefficients, and FIG. 41 illustrates each aberration diagram.

TABLE 55
Example 19

| Sn | R | D | Nd | νd | Material | ED | Nd + 0.01 × νd | ρr | (dN/dT) × 10⁻⁶ |
|---|---|---|---|---|---|---|---|---|---|
| 1 | 21.2333 | 0.5000 | 1.77047 | 29.74 | NBFD29 | | 2.06787 | | 3.4 |
| | | | | | HOYA | | | | |
| 2 | 9.2437 | 3.2839 | | | | | | | |
| *3 | 28.4694 | 1.2818 | 1.63351 | 23.63 | Plastic | | 1.86981 | | |
| *4 | 67.2495 | 0.6020 | | | | | | | |
| 5 | −25.0585 | 0.5000 | 1.48749 | 70.44 | FC5 | | 2.19189 | | — |
| | | | | | HOYA | | | | |
| 6 | 31.7972 | 0.2145 | | | | | | | |
| 7 | 20.8615 | 1.9328 | 1.85150 | 40.78 | S-LAH89 | | 2.25930 | | 5.3 |
| | | | | | OHARA | | | | |
| 8 | 177.3898 | 0.8296 | | | | | | | |
| 9 (St) | ∞ | 1.6865 | | | | | | | |
| 10 | 41.3696 | 3.2886 | 1.43700 | 95.10 | FCD100 | | 2.38800 | 3.53 | −6.3 |
| | | | | | HOYA | | | | |
| 11 | −14.8839 | DD[11] | | | | | | | |
| 12 | 14.2569 | 4.0184 | 1.84850 | 43.79 | J-LASFH22 | | 2.28640 | 5.08 | |
| | | | | | HIKARI | | | | |
| 13 | −26.2168 | 0.9252 | 1.73037 | 32.23 | NBFD32 | | 2.05267 | 3.18 | 3.2 |
| | | | | | HOYA | | | | |
| 14 | 12.5680 | 2.8615 | | | | | | | |
| *15 | 33.8920 | 0.6738 | 1.58364 | 30.27 | Plastic | | 1.88634 | 1.20 | |
| *16 | 12.3489 | 1.0203 | | | | | | | |
| 17 | −101.5215 | 4.1863 | 1.72916 | 54.68 | Plastic | | 2.27596 | 4.18 | |
| 18 | −11.7344 | DD[18] | | | | | | | |
| *19 | 23.7635 | 0.5000 | 1.63351 | 23.63 | Plastic | 17.02 | 1.86981 | 1.24 | |
| | | | | | (LA1) | | | | |
| *20 | 16.0965 | 12.9700 | | | | 18.06 | | | |

TABLE 56
Example 19

| | Infinite | Short Range |
|---|---|---|
| | Distance | 0.13 Times |
| Focal Length | 18.31 | — |
| Back Focus | 12.97 | 12.97 |
| Open F-Number | 2.06 | 2.16 |
| Maximum Full Angle of View [°] | 75.6 | 75.8 |
| DD[11] | 4.39 | 2.37 |
| DD[18] | 0.35 | 2.38 |

TABLE 57
Example 19

| Sn | 3 | 4 | 15 |
|---|---|---|---|
| KA | −2.1431363E+00 | −2.0189497E+00 | 9.3804171E−01 |
| A4 | −2.7606720E−04 | −3.4702473E−04 | −2.2392575E−03 |
| A6 | 8.0661368E−07 | 1.7021328E−05 | 8.5293869E−05 |
| A8 | 2.5426167E−07 | −1.5730585E−06 | −7.2084514E−06 |
| A10 | −6.0692633E−08 | 6.3104808E−08 | 5.7791699E−07 |
| A12 | 3.8741471E−09 | −1.1428336E−09 | −3.0551373E−08 |
| A14 | −1.2805691E−10 | −3.3097935E−12 | 1.0097270E−09 |
| A16 | 2.3251189E−12 | 4.6621960E−13 | −2.0281138E−11 |
| A18 | −2.2033090E−14 | −6.5644489E−15 | 2.2695323E−13 |
| A20 | 8.7014888E−17 | 2.9634951E−17 | −1.0827703E−15 |
| Sn | 16 | 19 | 20 |
| KA | 1.7979057E+00 | −2.4820297E+00 | 1.6085343E+00 |
| A4 | −1.9407125E−03 | −1.0203182E−03 | −1.0823130E−03 |
| A6 | 4.9771201E−05 | 3.7527320E−05 | 3.0155778E−05 |
| A8 | −9.3762740E−07 | −1.7980695E−06 | −9.1576529E−07 |
| A10 | 1.3784725E−08 | 7.1210886E−08 | 2.1632408E−08 |
| A12 | −2.7024725E−10 | −1.9673315E−09 | −3.6459990E−10 |
| A14 | 7.2520042E−12 | 3.5474983E−11 | 4.1591469E−12 |
| A16 | −1.4947084E−13 | −3.9593616E−13 | −3.0626829E−14 |
| A18 | 1.7541666E−15 | 2.4710138E−15 | 1.3056316E−16 |
| A20 | −8.6412960E−18 | −6.5869117E−18 | −2.4268134E−19 |

### Example 20

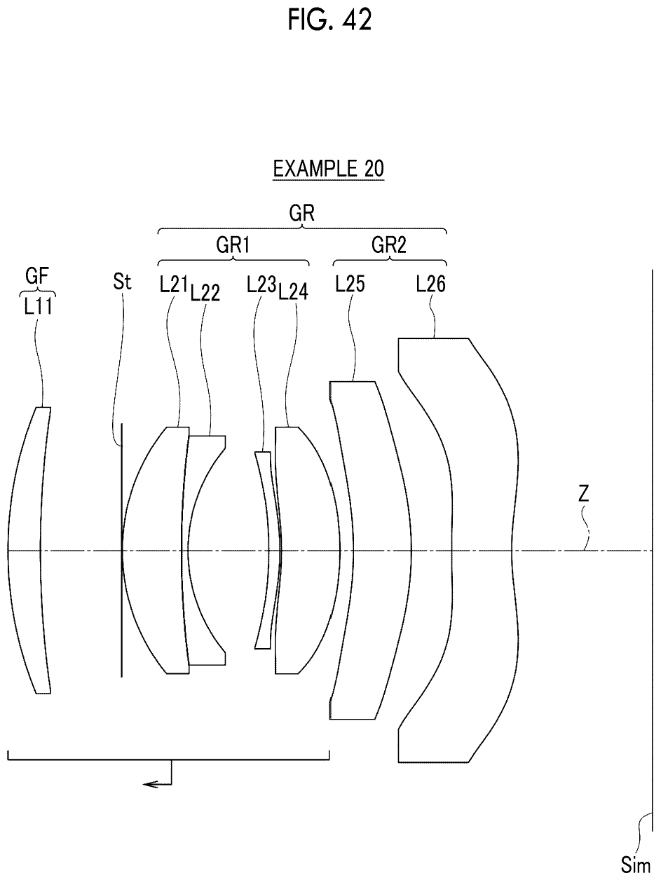

A cross-sectional view of a configuration of an imaging lens of Example 20 is illustrated in FIG. 42. The imaging lens of Example 20 consists of, in order from the object side to the image side, the front group GF, the aperture stop St, and the rear group GR. The front group GF consists of one lens that is the lens L11. The lens L11 corresponds to the LFp lens. The rear group GR consists of the first subsequent lens group GR1 and the second subsequent lens group GR2 in order from the object side to the image side. The first subsequent lens group GR1 consists of four lenses including the lenses L21 to L24 in order from the object side to the image side. The second subsequent lens group GR2 consists of two lenses including the lenses L25 and L26 in order from the object side to the image side. During the focusing from the infinite distance object to the short range object, the front group GF, the aperture stop St, and the first subsequent lens group GR1 move to the object side in an integrated manner, and the second subsequent lens group GR2 is fixed with respect to the image plane Sim.

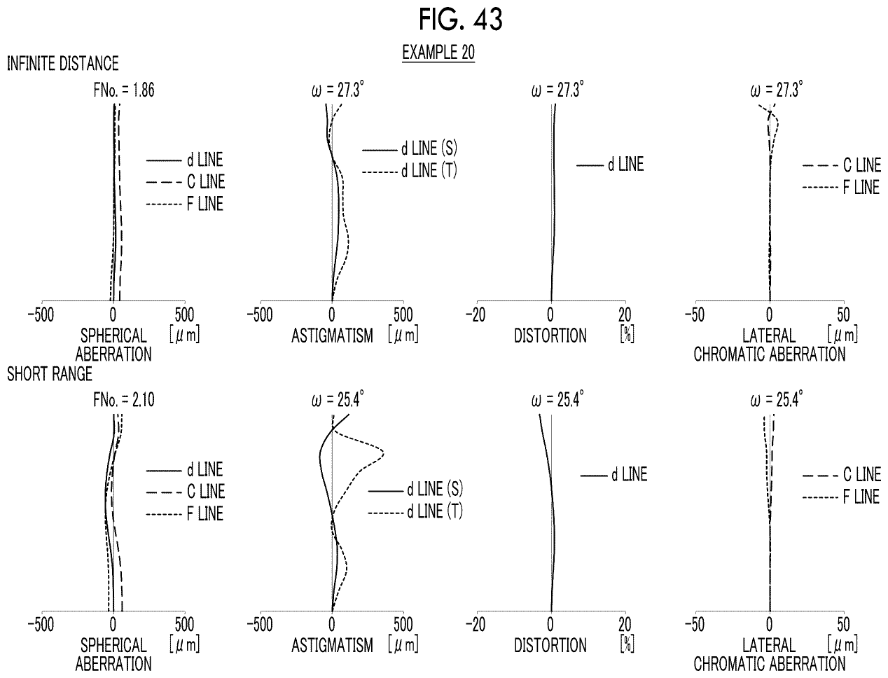

For the imaging lens of Example 20, Table 58 shows basic lens data, Table 59 shows specifications and a variable surface spacing, Table 60 shows aspherical coefficients, and FIG. 43 illustrates each aberration diagram.

TABLE 58
Example 20

| Sn | R | D | Nd | νd | Material | ED | Nd + 0.01 × νd | ρr | (dN/dT) × 10⁻⁶ |
|---|---|---|---|---|---|---|---|---|---|
| 1 | 29.7234 | 2.5219 | 1.75500 | 52.32 | S-LAH97 | | 2.27820 | 4.17 | 4.1 |
| | | | | | OHARA | | | | |
| 2 | 76.8224 | 6.3326 | | | | | | | |
| 3 (St) | ∞ | 0.0399 | | | | | | | |
| 4 | 15.2291 | 4.5978 | 1.88300 | 39.22 | H-ZLAF68N | | 2.27520 | 5.17 | 3.4 |
| | | | | | CDGM | | | | |
| 5 | 69.0355 | 0.5087 | 1.84666 | 23.78 | S-TIH53W | | 2.08446 | 3.54 | 1.3 |
| | | | | | OHARA | | | | |
| 6 | 12.4662 | 6.2805 | | | | | | | |
| *7 | −32.4899 | 0.8639 | 1.80154 | 45.47 | MC-TAF31-15 | 15.20 | 2.25624 | 4.84 | −5.9 |
| | | | | | HOYA (LA2) | | | | |
| *8 | −18.9071 | 0.1286 | | | | 15.40 | | | |
| *9 | −20.9860 | 4.5002 | 1.54436 | 56.03 | Plastic | | 2.10466 | 1.04 | |
| *10 | −21.2742 | DD[10] | | | | | | | |
| *11 | −25.4308 | 4.5000 | 1.66121 | 20.35 | Plastic | 23.61 | 1.86471 | 1.24 | |
| | | | | | (LA2) | | | | |
| *12 | −23.7618 | 3.1326 | | | | 26.45 | | | |
| *13 | 57.7054 | 4.6712 | 1.54436 | 56.03 | Plastic | 28.00 | 2.10466 | 1.04 | |
| | | | | | (LA1) | | | | |
| *14 | 21.4600 | 10.9400 | | | | 32.85 | | | |

TABLE 59

| | Infinite | Short Range |
|---|---|---|
| Example 20 | Distance | 0.15 Times |
| Focal Length | 41.41 | — |
| Back Focus | 10.94 | 10.94 |
| Open F-Number | 1.86 | 2.10 |
| Maximum Full Angle of View [°] | 54.6 | 50.8 |
| DD[10] | 1.05 | 5.76 |

TABLE 60
Example 20

| Sn | 7 | 8 | 9 | 10 |
|---|---|---|---|---|
| KA | −1.3020688E+00 | 7.6529168E−01 | 1.0000000E+00 | 1.0000000E+00 |
| A4 | −2.9059344E−04 | 1.3540378E−04 | 4.8908705E−04 | −6.7813094E−05 |
| A6 | 7.8159962E−06 | 4.7554179E−06 | −5.2185664E−06 | −4.5469253E−07 |
| A8 | −6.6172209E−08 | −6.7408222E−08 | 1.5838223E−08 | 6.3435356E−09 |
| A10 | −1.6951289E−10 | 5.5111950E−10 | 3.9583780E−10 | −5.2025249E−11 |
| A12 | 2.2094240E−12 | −6.1580618E−12 | −1.7053113E−12 | −6.9600898E−13 |
| A14 | 1.6529072E−14 | 5.4968667E−14 | −3.4545744E−14 | 1.0631833E−14 |
| A16 | −9.8363276E−17 | −2.5385243E−16 | 9.4599934E−17 | −4.8450499E−17 |
| A18 | −2.9641852E−19 | 4.6431470E−19 | 1.2676578E−18 | 4.4158897E−20 |
| Sn | 11 | 12 | 13 | 14 |
| KA | 1.0000000E+00 | 1.0000000E+00 | 1.0000000E+00 | 1.0000000E+00 |
| A4 | 8.5374290E−05 | 1.7649783E−05 | −3.8043299E−04 | −3.5469762E−04 |
| A6 | 1.6337382E−08 | 4.2347644E−07 | 1.8502535E−06 | 1.9433637E−06 |
| A8 | −4.9469034E−10 | −7.5809785E−10 | −4.3739183E−09 | −9.1863361E−09 |
| A10 | −1.0624535E−11 | −6.6913125E−12 | −2.3579370E−12 | 2.8507469E−11 |
| A12 | −3.1644369E−14 | −1.9671432E−14 | 3.0369259E−14 | −5.1913097E−14 |
| A14 | 3.9738805E−16 | 4.0707199E−17 | 2.2818011E−17 | 3.9434837E−17 |
| A16 | −5.6927900E−20 | 7.5748448E−19 | 1.6394188E−19 | 1.2757584E−20 |
| A18 | −3.0981596E−22 | −7.8454203E−22 | −8.6016068E−22 | 2.9887337E−23 |

### Example 21

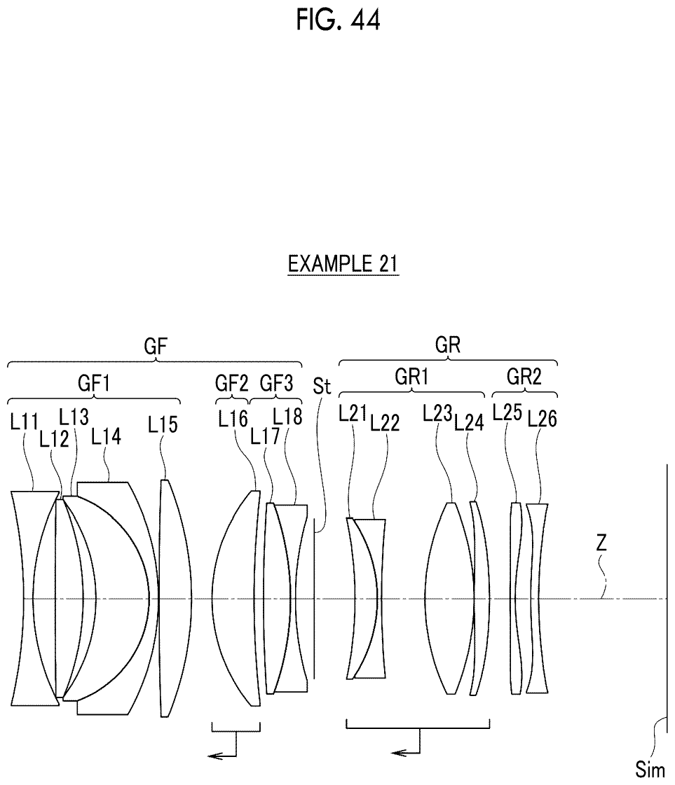

A cross-sectional view of a configuration of an imaging lens of Example 21 is illustrated in FIG. 44. The imaging lens of Example 21 consists of, in order from the object side to the image side, the front group GF, the aperture stop St, and the rear group GR. The front group GF consists of a first front side lens group GF1, a second front side lens group GF2, and a third front side lens group GF3 in order from the object side to the image side. The first front side lens group GF1 consists of five lenses including the lenses L11 to L15 in order from the object side to the image side. The second front side lens group GF2 consists of one lens that is the lens L16. The third front side lens group GF3 consists of two lenses including lenses L17 and L18 in order from the object side to the image side. The lens L12, the lens L15, and the lens L16 correspond to the LFp lens. The rear group GR consists of the first subsequent lens group GR1 and the second subsequent lens group GR2 in order from the object side to the image side. The first subsequent lens group GR1 consists of four lenses including the lenses L21 to L24 in order from the object side to the image side. The second subsequent lens group GR2 consists of two lenses including the lenses L25 and L26 in order from the object side to the image side. During the focusing from the infinite distance object to the short range object, the second front side lens group GF2 and the first subsequent lens group GR1 move to the object side by changing a mutual spacing, and other lenses are fixed with respect to the image plane Sim.

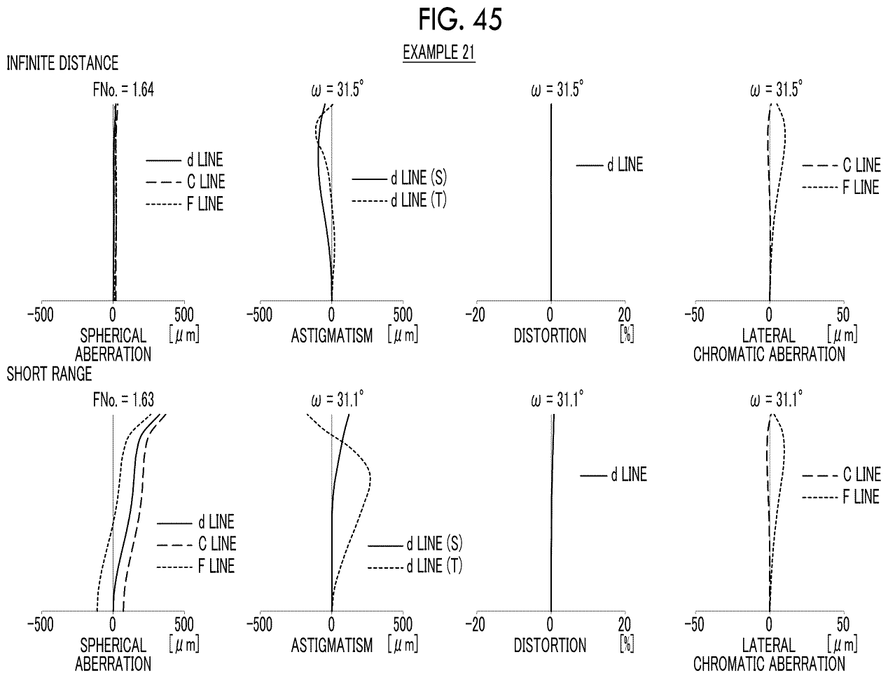

For the imaging lens of Example 21, Tables 61A and 61B show basic lens data, Table 62 shows specifications and a variable surface spacing, Table 63 shows aspherical coefficients, and FIG. 45 illustrates each aberration diagram. The basic lens data is shown in two tables in order to avoid one lengthy table.

TABLE 61A
Example 21

| Sn | R | D | Nd | νd | Material | ED | Nd + 0.01 × νd | ρr | (dN/dT) × 10⁻⁶ |
|---|---|---|---|---|---|---|---|---|---|
| 1 | −75.2619 | 1.5000 | 1.75500 | 52.32 | S-LAH97 | | 2.27820 | | 4.1 |
| | | | | | OHARA | | | | |
| 2 | 36.8263 | 3.5735 | | | | | | | |
| 3 | 1189.3808 | 4.4763 | 1.49700 | 81.54 | S-FPL51 | | 2.31240 | | −6.2 |
| | | | | | OHARA | | | | |
| 4 | −41.5218 | 2.0572 | | | | | | | |
| 5 | −26.8440 | 8.5440 | 1.83400 | 37.21 | S-LAH60V | | 2.20610 | | 9.1 |
| | | | | | OHARA | | | | |
| 6 | −17.6014 | 1.5000 | 1.89286 | 20.36 | S-NPH4 | | 2.09646 | | 1.1 |
| | | | | | OHARA | | | | |
| 7 | −38.2009 | 0.1000 | | | | | | | |
| 8 | 593.5312 | 5.2087 | 2.00272 | 19.32 | E-FDS2 | | 2.19592 | | 7.7 |
| | | | | | HOYA | | | | |
| 9 | −50.4354 | DD[9] | | | | | | | |
| 10 | 27.0997 | 6.7561 | 1.43875 | 94.66 | S-FPL55 | | 2.38535 | | −6.3 |
| | | | | | OHARA | | | | |
| 11 | 148.7428 | DD[11] | | | | | | | |
| 12 | 223.2841 | 4.3476 | 1.88300 | 39.22 | H-ZLAF68N | | 2.27520 | | 3.4 |
| | | | | | CDGM | | | | |
| 13 | −44.8146 | 0.7892 | 1.69895 | 30.13 | S-TIM35 | | 2.00025 | | 3.6 |
| | | | | | OHARA | | | | |
| 14 | 47.9630 | 3.0083 | | | | | | | |

TABLE 61B
Example 21

| Sn | R | D | Nd | νd | Material | ED | Nd + 0.01 × νd | ρr | (dN/dT) × 10⁻⁶ |
|---|---|---|---|---|---|---|---|---|---|
| 15 (St) | ∞ | DD[15] | | | | | | | |
| 16 | −62.7103 | 3.5948 | 1.43875 | 94.66 | S-FPL55 | | 2.38535 | 3.59 | −6.3 |
| | | | | | OHARA | | | | |
| 17 | −23.1777 | 0.6646 | 1.71736 | 29.52 | S-TIH1 | | 2.01256 | 3.06 | 2.7 |
| | | | | | OHARA | | | | |
| 18 | 136.1640 | 6.9698 | | | | | | | |
| 19 | 35.3519 | 7.8865 | 1.49700 | 81.54 | S-FPL51 | | 2.31240 | 3.62 | −6.2 |
| | | | | | OHARA | | | | |
| 20 | −40.5112 | 0.0374 | | | | | | | |
| *21 | 228.1410 | 2.4401 | 1.95150 | 29.83 | MP-TAFD405 | 31.02 | 2.24980 | 5.42 | — |
| | | | | | HOYA | | | | |
| *22 | −67.6063 | DD[22] | | | | 31.29 | | | |
| *23 | 1545.5282 | 0.7975 | 1.68948 | 31.02 | L-TIM28 | 30.97 | 1.99968 | 2.88 | 0.0 |
| | | | | | OHARA (LA1) | | | | |
| *24 | 36.8459 | 2.5011 | | | | 30.77 | | | |
| *25 | 78.6649 | 1.2692 | 1.85135 | 40.10 | MC-TAFD305 | 30.22 | 2.25235 | 5.25 | 7.6 |
| | | | | | HOYA | | | | |
| *26 | 78.8113 | 20.6300 | | | | 30.50 | | | |

TABLE 62
Example 21

| | Infinite | Short Range |
|---|---|---|
| | Distance | 0.15 Times |
| Focal Length | 35.25 | — |
| Back Focus | 20.63 | 20.63 |
| Open F-Number | 1.64 | 1.63 |
| Maximum Full Angle of View [°] | 63.0 | 62.2 |
| DD[9] | 3.29 | 0.84 |
| DD[11] | 1.51 | 3.96 |
| DD[15] | 6.47 | 3.89 |
| DD[22] | 3.34 | 5.92 |

TABLE 63
Example 21

| Sn | 21 | 22 | 23 |
|---|---|---|---|
| KA | 1.0000000E+00 | 1.0000000E+00 | 1.0000000E+00 |
| A4 | −1.7756294E−05 | 2.6181475E−07 | −1.0725310E−06 |
| A6 | 2.5098088E−08 | −1.3711864E−08 | −4.7680633E−08 |
| A8 | −3.4857621E−10 | −1.7529171E−10 | 4.0599221E−10 |
| A10 | 7.7327800E−13 | 5.3483700E−13 | −5.6663138E−13 |
| Sn | 24 | 25 | 26 |
| KA | 1.0000000E+00 | 1.0000000E+00 | 1.0000000E+00 |
| A4 | −4.4668603E−05 | −2.0061721E−05 | 9.9359233E−06 |
| A6 | 3.1140887E−09 | −1.8900165E−07 | −1.8867172E−07 |
| A8 | −1.3197401E−10 | 4.4765408E−10 | 9.1017984E−10 |
| A10 | 3.8190209E−13 | −1.7350767E−13 | −1.2095980E−12 |

Tables 64 to 67 show the corresponding values of Conditional Expressions (1), (3) to (10), (12) to (19), (21), and (22) of the imaging lenses of Examples 1 to 21. In a field of the corresponding values of Conditional Expressions (15) and (17) having a plurality of corresponding values, a reference numeral of a corresponding lens is added in parentheses under each corresponding value. The corresponding values of Conditional Expressions (2), (11), and (20) are shown in the table of the basic lens data of each example and thus, are not shown in Tables 64 to 67. Preferable ranges of the conditional expressions may be set using the corresponding values of the examples shown in Tables 64 to 67 as the upper limits and the lower limits of the conditional expressions.

TABLE 64

| Expression | | | | | | | |
|---|---|---|---|---|---|---|---|
| Number | | Example 1 | Example 2 | Example 3 | Example 4 | Example 5 | Example 6 |
| (1) | Bf/(f × tan ωm) | 0.469 | 0.441 | 0.424 | 0.397 | 0.446 | 0.530 |
| (3) | TL/f | 2.229 | 2.265 | 2.218 | 2.163 | 2.232 | 1.751 |
| (4) | Fno/tan ωm | 2.434 | 2.434 | 2.548 | 2.676 | 2.460 | 2.951 |
| (5) | dFSt/TL | 0.146 | 0.052 | 0.036 | 0.032 | 0.041 | 0.020 |
| (6) | dStR/TL | 0.050 | 0.012 | 0.015 | 0.102 | 0.010 | 0.017 |
| (7) | dSt/TL | 0.832 | 0.766 | 0.770 | 0.850 | 0.745 | 0.907 |
| (8) | (RL1r − RL1f)/(RL1r + RL1f) | −0.425 | −0.723 | −0.446 | −1.484 | −0.313 | −1.553 |
| (9) | dA1/TL | 0.250 | 0.229 | 0.217 | 0.198 | 0.235 | 0.295 |
| (10) | TL/(f × tan ωm) | 1.877 | 1.921 | 1.955 | 2.003 | 1.900 | 1.794 |
| (12) | f/fL1 | −0.850 | −0.674 | −0.678 | −1.014 | −0.400 | −0.700 |
| (13) | RA1y/RA1c | −1.399 | −1.685 | −1.796 | −1.999 | −1.656 | −1.985 |
| (14) | NdA1 + 0.01 × νdA1 | 2.093 | 2.093 | 2.093 | 2.105 | 2.093 | 2.105 |
| (15) | RA2c/RA2y | −0.235 | 0.208 | 0.543 | −0.301 | 0.408 | −0.050 |
| | | | | | | | (L23) |
| | | | | | | | 0.855 |
| | | | | | | | (L24) |
| (16) | dA2/TL | 0.449 | 0.378 | 0.361 | 0.350 | 0.369 | 0.426 |
| (17) | f/fLF | — | 0.290 | 0.138 | 0.581 | 0.053 | 0.191 |
| (18) | f/fF | −0.850 | −0.348 | −0.539 | −0.395 | −0.341 | −0.502 |
| (19) | \|β\| | 0.11 | 0.11 | 0.11 | 0.11 | 0.11 | 0.11 |
| (21) | Fno | 2.89 | 2.87 | 2.89 | 2.89 | 2.89 | 2.88 |
| (22) | f/RL1r | 2.497 | 1.657 | 2.302 | 1.734 | 1.773 | 1.176 |

TABLE 65

| Expression | | Example | Example | Example | Example | Example | Example |
|---|---|---|---|---|---|---|---|
| Number | | 7 | 8 | 9 | 10 | 11 | 12 |
| (1) | Bf/(f × tan ωm) | 0.390 | 0.379 | 0.385 | 0.369 | 0.362 | 0.388 |
| (3) | TL/f | 2.296 | 2.296 | 2.479 | 2.481 | 2.802 | 2.458 |
| (4) | Fno/tan ωm | 2.593 | 2.602 | 2.382 | 2.374 | 2.092 | 2.495 |
| (5) | dFSt/′TL | 0.022 | 0.027 | 0.039 | 0.033 | 0.031 | 0.028 |
| (6) | dStR/TL | 0.096 | 0.088 | 0.083 | 0.068 | 0.067 | 0.075 |
| (7) | dSt/TL | 0.764 | 0.729 | 0.718 | 0.730 | 0.698 | 0.729 |
| (8) | (RL1r − RL1f)/(RL1r + RL1f) | −0.846 | −0.744 | −1.153 | −0.896 | −0.800 | −0.878 |
| (9) | dA1/TL | 0.188 | 0.183 | 0.188 | 0.181 | 0.178 | 0.182 |
| (10) | TL/(f × tan ωm) | 2.068 | 2.068 | 2.043 | 2.038 | 2.028 | 2.129 |
| (12) | f/fL1 | −0.735 | −0.703 | −0.764 | −0.696 | −0.618 | −0.691 |
| (13) | RA1y/RA1c | −2.026 | −1.848 | −1.870 | −2.139 | −2.056 | −3.275 |
| (14) | NdA1 + 0.01 × νdA1 | 2.105 | 2.105 | 2.105 | 2.105 | 2.105 | 2.105 |
| (15) | RA2c/RA2y | −0.235 | −0.146 | 0.369 | 0.361 | 0.024 | 0.772 |
| | | | | (L24) | (L24) | (L24) | (L24) |
| | | | | 0.014 | −0.169 | −0.168 | −0.050 |
| | | | | (L25) | (L25) | (L25) | (L25) |
| (16) | dA2/TL | 0.334 | 0.322 | 0.291 | 0.298 | 0.293 | 0.289 |
| (17) | f/fLF | 0.719 | 0.811 | 1.051 | 0.882 | 0.763 | 0.900 |
| (18) | f/fF | 0.168 | 0.304 | 0.610 | 0.403 | 0.388 | 0.442 |
| (19) | \|β\| | 0.11 | 0.12 | 0.11 | 0.12 | 0.11 | 0.14 |
| (21) | Fno | 2.88 | 2.89 | 2.89 | 2.89 | 2.89 | 2.88 |
| (22) | f/RL1r | 1.649 | 1.696 | 1.461 | 1.513 | 1.430 | 1.519 |

TABLE 66

| Expression | | Example | Example | Example | Example | Example | Example |
|---|---|---|---|---|---|---|---|
| Number | | 13 | 14 | 15 | 16 | 17 | 18 |
| (1) | Bf/(f × tan ωm) | 0.648 | 0.668 | 0.494 | 0.470 | 0.508 | 0.683 |
| (3) | TL/f | 2.360 | 2.210 | 1.268 | 1.359 | 2.193 | 1.843 |
| (4) | Fno/tan ωm | 2.616 | 2.850 | 3.383 | 3.287 | 3.121 | 3.481 |
| (5) | dFSt/TL | 0.070 | 0.164 | 0.067 | 0.054 | 0.025 | 0.035 |
| (6) | dStR/TL | 0.020 | 0.018 | 0.061 | 0.056 | 0.107 | 0.044 |
| (7) | dSt/TL | 0.790 | 0.808 | 0.820 | 0.843 | 0.870 | 0.865 |
| (8) | (RL1r − RL1f)/(RL1r + RL1f) | −0.708 | −0.735 | 1.926 | 4.707 | −0.564 | −0.597 |
| (9) | dA1/TL | 0.302 | 0.309 | 0.214 | 0.218 | 0.214 | 0.306 |
| (10) | TL/(f × tan ωm) | 2.146 | 2.164 | 2.306 | 2.158 | 2.369 | 2.227 |
| (12) | f/fL1 | −0.867 | −0.865 | 1.155 | 1.198 | −0.852 | −0.586 |
| (13) | RA1y/RA1c | −4.170 | −1.528 | −0.118 | −0.101 | −1.430 | −1.250 |
| (14) | NdA1 + 0.01 × νdA1 | 2.093 | 2.093 | 2.105 | 2.105 | 2.105 | 1.870 |
| (15) | RA2c/RA2y | −0.548 | 0.566 | 0.288 | 0.088 | 0.509 | — |
| | | | | | | (L25) | |
| | | | | | | −0.859 | |
| | | | | | | (L26) | |
| (16) | dA2/TL | 0.420 | 0.420 | 0.429 | 0.432 | 0.340 | — |
| (17) | f/fLF | 0.028 | — | 0.624 | 0.474 | 0.802 | 1.693 |
| (18) | f/fF | −0.866 | −0.865 | 0.624 | 0.474 | 0.035 | 0.265 |
| (19) | \|β\| | 0.12 | 0.11 | 0.11 | 0.11 | 0.10 | 0.13 |
| (21) | Fno | 2.88 | 2.91 | 1.86 | 2.07 | 2.89 | 2.88 |
| (22) | f/RL1r | 2.166 | 2.110 | −0.585 | −1.133 | 1.558 | 1.673 |

TABLE 67

| Expression | | Example | Example | Example |
|---|---|---|---|---|
| Number | | 19 | 20 | 21 |
| (1) | Bf/(f × tan ωm) | 0.913 | 0.512 | 0.955 |
| (3) | TL/f | 2.513 | 1.209 | 2.929 |
| (4) | Fno/tan ωm | 2.656 | 3.604 | 2.676 |
| (5) | dFSt/TL | 0.018 | 0.126 | 0.029 |
| (6) | dStR/TL | 0.037 | 0.001 | 0.063 |
| (7) | dSt/TL | 0.801 | 0.823 | 0.548 |
| (8) | (RL1r − RL1f)/(RL1r + RL1f) | −0.393 | 0.442 | −2.916 |
| (9) | dA1/TL | 0.282 | 0.219 | 0.236 |
| (10) | TL/(f × tan ωm) | 3.240 | 2.343 | 4.780 |
| (12) | f/fL1 | −0.846 | 0.660 | −1.082 |
| (13) | RA1y/RA1c | −1.322 | −1.513 | −2.201 |
| (14) | NdA1 + 0.01 × νdA1 | 1.870 | 2.105 | 2.000 |
| (15) | RA2c/RA2y | — | −0.031 | — |
| | | | (L23) | |
| | | | 0.656 | |
| | | | (L25) | |
| (16) | dA2/TL | — | 0.374 | — |
| (17) | f/fLF | 0.238 | 0.660 | 0.436 |
| | | (L12) | | (L12) |
| | | 0.663 | | 0.757 |
| | | (L14) | | (LI5) |
| | | — | | 0.475 |
| | | | | (L16) |
| (18) | f/fF | −0.539 | 0.660 | 0.870 |
| (19) | \|β\| | 0.13 | 0.15 | 0.15 |
| (21) | Fno | 2.06 | 1.86 | 1.64 |
| (22) | f/RL1r | 1.981 | 0.539 | 0.957 |

The imaging lenses of Examples 1 to 21 favorably correct various aberrations while being configured to be reduced in size and thus, maintain high optical performance.

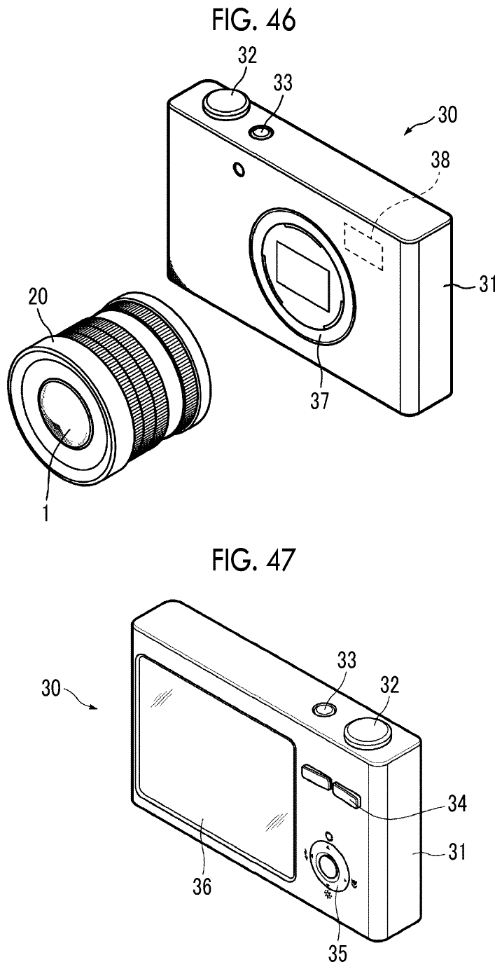

Next, an imaging apparatus according to the embodiment of the present disclosure will be described. FIGS. 46 and 47 illustrate external views of a camera 30 that is the imaging apparatus according to one embodiment of the present disclosure. FIG. 46 illustrates a perspective view of the camera 30 seen from its front surface side, and FIG. 47 illustrates a perspective view of the camera 30 seen from its rear surface side. The camera 30 is a so-called mirrorless type digital camera on which an interchangeable lens 20 can be attachably and detachably mounted. The interchangeable lens 20 is configured to include an imaging lens 1 according to one embodiment of the present disclosure accommodated in a lens barrel.

The camera 30 comprises a camera body 31. A shutter button 32 and a power button 33 are provided on an upper surface of the camera body 31. An operator 34, an operator 35, and a display unit 36 are provided on a rear surface of the camera body 31. The display unit 36 can display a captured image and an image within an angle of view before imaging.

An imaging aperture on which light from an imaging target is incident is provided in a center portion of a front surface of the camera body 31. A mount 37 is provided at a position corresponding to the imaging aperture, and the interchangeable lens 20 is mounted on the camera body 31 through the mount 37.

An imaging element 38 is provided in the camera body 31. The imaging element 38 outputs an imaging signal corresponding to a subject image formed by the interchangeable lens 20. For example, a charge coupled device (CCD) or a complementary metal oxide semiconductor (CMOS) is used as the imaging element 38. A signal processing circuit (not illustrated), a recording medium (not illustrated), and the like are provided in the camera body 31. The signal processing circuit generates an image by processing the imaging signal output from the imaging element 38. The generated image is recorded on the recording medium. In the camera 30, a static image or a video can be captured by pressing the shutter button 32, and image data obtained by this capturing is recorded on the recording medium.

While the disclosed technology has been described above using the embodiment and the examples, the disclosed technology is not limited to the embodiment and the examples and can be subjected to various modifications. For example, the curvature radius, the surface spacing, the refractive index, the Abbe number, and the aspherical coefficient of each lens are not limited to the values shown in each example and may have other values.

In addition, the imaging apparatus according to the embodiment of the present disclosure is not limited to the above example and can have various aspects of, for example, a camera of a type other than a mirrorless type, a film camera, a video camera, and a security camera.

The following appendices are further disclosed with respect to the embodiment and the examples described above.

### APPENDIX 1

An imaging lens consisting of, in order from an object side to an image side, a front group including one or more lenses, a stop, and a rear group including a plurality of lenses, in which the rear group includes at least one first aspherical lens that has a concave surface facing the image side in a paraxial region and that has, on a lens surface on the image side, an inflection point at which a convex or concave shape changes in a middle of the lens surface from a position on an optical axis to an edge part, and in a case where a back focus of an entire system as an air conversion distance in a state where an infinite distance object is in focus is denoted by Bf, a focal length of the entire system in the state where the infinite distance object is in focus is denoted by f, and a maximum half angle of view in the state where the infinite distance object is in focus is denoted by ωm, Conditional Expression (1) is satisfied, which is represented by

$$0.3 < Bf / ( f \times tan ω m ) < 1.5 , \qquad ( 1 )$$

in a case where a temperature coefficient of a refractive index with respect to a d line at 25° C. for a lens included in the entire system is denoted by (dN/dT)×10⁻⁶, and dN/dT is in units of ° C.⁻¹, the imaging lens includes at least one lens satisfying Conditional Expression (2) represented by

$$0 < \vert dN / dT \vert < 15. \qquad ( 2 )$$

### APPENDIX 2

The imaging lens according to Appendix 1, in which Conditional Expression (1-1) is satisfied, which is represented by

$$0.36 < Bf / ( f \times tan ω m ) < 1.2 . \qquad ( 1 - 1 )$$

### APPENDIX 3

The imaging lens according to Appendix 1 or 2, in which, in a case where a sum of Bf and a distance on the optical axis from a lens surface of the front group closest to the object side to a lens surface of the rear group closest to the image side in the state where the infinite distance object is in focus is denoted by TL, Conditional Expression (3) is satisfied, which is represented by

$$1.1 < TL / f < 3.5 . \qquad ( 3 )$$

### APPENDIX 4

The imaging lens according to Appendix 3, in which Conditional Expression (3-1) is satisfied, which is represented by

$$1.2 < TL / f < 3. \qquad ( 3 - 1 )$$

### APPENDIX 5

The imaging lens according to any one of Appendices 1 to 4, in which, in a case where an open F-number in the state where the infinite distance object is in focus is denoted by Fno, Conditional Expression (4) is satisfied, which is represented by

$$1.6 < Fno / tan ω m < 5. \qquad ( 4 )$$

### APPENDIX 6

The imaging lens according to Appendix 5, in which Conditional Expression (4-1) is satisfied, which is represented by

$$2 < Fno / tan ω m < 3.2 . \qquad ( 4 - 1 )$$

### APPENDIX 7

The imaging lens according to any one of Appendices 1 to 6, in which, in a case where a minimum value of a distance on the optical axis from a lens surface of the front group closest to the image side to the stop is denoted by dFSt, a sign of dFSt is positive in a case where the stop is closer to the image side than the lens surface of the front group closest to the image side, and is negative in a case where the stop is closer to the object side than the lens surface of the front group closest to the image side, a minimum value of a distance on the optical axis from the stop to a lens surface of the rear group closest to the object side is denoted by dStR, a sign of dStR is positive in a case where the lens surface of the rear group closest to the object side is closer to the image side than the stop, and is negative in a case where the lens surface of the rear group closest to the object side is closer to the object side than the stop, and a sum of Bf and a distance on the optical axis from a lens surface of the front group closest to the object side to a lens surface of the rear group closest to the image side in the state where the infinite distance object is in focus is denoted by TL, Conditional Expressions (5) and (6) are satisfied, which are represented by

$$0 < dFSt / TL < 0.8 \qquad ( 5 )$$

$$0 < dStR / TL < 0.8 . \qquad ( 6 )$$

### APPENDIX 8

The imaging lens according to any one of Appendices 1 To 7, in which, in a case where a sum of Bf and a distance on the optical axis from the stop to a lens surface of the rear group closest to the image side in the state where the infinite distance object is in focus is denoted by dSt, and a sum of Bf and a distance on the optical axis from a lens surface of the front group closest to the object side to the lens surface of the rear group closest to the image side in the state where the infinite distance object is in focus is denoted by TL, Conditional Expression (7) is satisfied, which is represented by

$$0.67 < dSt / TL < 0.93 . \qquad ( 7 )$$

### APPENDIX 9

The imaging lens according to any one of Appendices 1 to 7, in which, in a case where a paraxial curvature radius of a surface, on the object side, of a lens closest to the object side in the front group is denoted by RL1f, and a paraxial curvature radius of a surface, on the image side, of the lens closest to the object side in the front group is denoted by RL1r, Conditional Expression (8) is satisfied, which is represented by

$$- 3 < ( RL 1 r - RL 1 f ) / ( RL 1 r + RL 1 f ) < 0. \qquad ( 8 )$$

### APPENDIX 10

The imaging lens according to Appendix 9, in which Conditional Expression (8-1) is satisfied, which is represented by

$$- 1 < ( RL 1 r - RL 1 f ) / ( RL 1 r + RL 1 f ) < - 0.07 . \qquad ( 8 - 1 )$$

### APPENDIX 11

The imaging lens according to any one of Appendices 1 to 10, in which, in a case where a sum of Bf and a distance on the optical axis from a surface, on the image side, of the first aspherical lens closest to the image side among the first aspherical lenses included in the rear group to a lens surface of the rear group closest to the image side in the state where the infinite distance object is in focus is denoted by dA1, and a sum of Bf and a distance on the optical axis from a lens surface of the front group closest to the object side to the lens surface of the rear group closest to the image side in the state where the infinite distance object is in focus is denoted by TL, Conditional Expression (9) is satisfied, which is represented by

$$0.02 < dA 1 / TL < 0.6 . \qquad ( 9 )$$

### APPENDIX 12

The imaging lens according to Appendix 11, in which Conditional Expression (9-1) is satisfied, which is represented by

$$0.08 < dA 1 / TL < 0.35 . \qquad ( 9 - 1 )$$

### APPENDIX 13

The imaging lens according to any one of Appendices 1 to 12, in which the front group includes at least one lens satisfying Conditional Expression (2).

### APPENDIX 14

The imaging lens according to Appendix 13, in which a lens closest to the object side in the front group satisfies Conditional Expression (2).

### APPENDIX 15

The imaging lens according to any one of Appendices 1 to 14, in which the rear group includes at least one lens satisfying Conditional Expression (2).

### APPENDIX 16

The imaging lens according to any one of Appendices 1 to 15, in which, in a case where a sum of Bf and a distance on the optical axis from a lens surface of the front group closest to the object side to a lens surface of the rear group closest to the image side in the state where the infinite distance object is in focus is denoted by TL, Conditional Expression (10) is satisfied, which is represented by

$$1.2 < TL / ( f \times tan ω m ) < 3. \qquad ( 10 )$$

### APPENDIX 17

The imaging lens according to Appendix 16, in which Conditional Expression (10-1) is satisfied, which is represented by

$$1.7 < TL / ( f \times tan ω m ) < 2.5 . \qquad ( 10 - 1 )$$

### APPENDIX 18

The imaging lens according to any one of Appendices 1 to 17, in which, in a case where a refractive index with respect to a d line and an Abbe number based on the d line for a lens included in the entire system are denoted by Nd and νd, respectively, the front group includes at least one lens satisfying Conditional Expression (11), which is represented by

$$1.6 < Nd + 0.01 \times vd < 2.6 . \qquad ( 11 )$$

### APPENDIX 19

The imaging lens according to Appendix 18, in which a lens closest to the object side in the front group satisfies Conditional Expression (11).

### APPENDIX 20

The imaging lens according to any one of Appendices 1 to 19, in which, in a case where a focal length of a lens closest to the object side in the front group is denoted by fL1, Conditional Expression (12) is satisfied, which is represented by

$$- 1.5 < f / fL 1 < 0. \qquad ( 12 )$$

### APPENDIX 21

The imaging lens according to any one of Appendices 1 to 20, in which, in a case where a paraxial curvature radius of a surface, on the image side, of the first aspherical lens closest to the image side among the first aspherical lenses included in the rear group is denoted by RA1c, and a curvature radius, at a position of a maximum effective diameter, of the surface, on the image side, of the first aspherical lens closest to the image side among the first aspherical lenses included in the rear group is denoted by RA1y, Conditional Expression (13) is satisfied, which is represented by

$$- 100 < RA 1 y / RA 1 c < 0. \qquad ( 13 )$$

### APPENDIX 22

The imaging lens according to any one of Appendices 1 to 21, in which, in a case where a refractive index with respect to a d line and an Abbe number based on the d line for the first aspherical lens closest to the image side among the first aspherical lenses included in the rear group are denoted by NdA1 and νdA1, respectively, Conditional Expression (14) is satisfied, which is represented by

$$1.8 < NdA 1 + 0.01 \times vdA 1 < 2.14 . \qquad ( 14 )$$

### APPENDIX 23

The imaging lens according to any one of Appendices 1 to 22, in which the rear group includes at least one second aspherical lens that has a convex surface facing the image side in the paraxial region and that has, on the image side, a lens surface in which a refractive power at a position of a maximum effective diameter is shifted in a negative direction compared to a refractive power in the paraxial region.

### APPENDIX 24

The imaging lens according to Appendix 23, in which, in a case where a paraxial curvature radius of a surface, on the image side, of the second aspherical lens is denoted by RA2c, and a curvature radius, at the position of the maximum effective diameter, of the surface, on the image side, of the second aspherical lens is denoted by RA2y, all second aspherical lenses included in the rear group satisfy Conditional Expression (15) represented by

$$- 1 < RA 2 c / RA 2 y < 1. \qquad ( 15 )$$

### APPENDIX 25

The imaging lens according to Appendix 23 or 24, in which, in a case where a sum of Bf and a distance on the optical axis from a surface, on the image side, of the second aspherical lens closest to the image side among the second aspherical lenses included in the rear group to a lens surface of the rear group closest to the image side in the state where the infinite distance object is in focus is denoted by dA2, and a sum of Bf and a distance on the optical axis from a lens surface of the front group closest to the object side to the lens surface of the rear group closest to the image side in the state where the infinite distance object is in focus is denoted by TL, Conditional Expression (16) is satisfied, which is represented by

$$0.2 < dA 2 / TL < 0.6 . \qquad ( 16 )$$

### APPENDIX 26

The imaging lens according to any one of Appendices 23 to 25, in which a lens that is a second from the image side in the rear group is the second aspherical lens closest to the image side among the second aspherical lenses included in the rear group.

### APPENDIX 27

The imaging lens according to any one of Appendices 1 to 26, in which a lens that is a second from the image side in the rear group has, on a lens surface on the image side, the inflection point at which the convex or concave shape changes in the middle of the lens surface from the position on the optical axis to the edge part.

### APPENDIX 28

The imaging lens according to any one of Appendices 1 to 27, in which a lens closest to the image side in the rear group is the first aspherical lens.

### APPENDIX 29

The imaging lens according to any one of Appendices 1 to 28, in which a lens closest to the image side in the rear group has a convex surface facing the object side in the paraxial region and has, on a lens surface on the object side, the inflection point at which the convex or concave shape changes in the middle of the lens surface from the position on the optical axis to the edge part.

### APPENDIX 30

The imaging lens according to any one of Appendices 1 to 29, in which the rear group includes two first aspherical lenses.

### APPENDIX 31

The imaging lens according to any one of Appendices 23 to 26, in which the rear group includes two second aspherical lenses.

### APPENDIX 32

The imaging lens according to any one of Appendices 1 to 31, in which the imaging lens includes at least one cemented lens.

### APPENDIX 33

The imaging lens according to any one of Appendices 1 to 32, in which a lens closest to the object side in the front group satisfies Conditional Expression (2), and in a case where a sum of Bf and a distance on the optical axis from a lens surface of the front group closest to the object side to a lens surface of the rear group closest to the image side in the state where the infinite distance object is in focus is denoted by TL, an open F-number in the state where the infinite distance object is in focus is denoted by Fno, a sum of Bf and a distance on the optical axis from the stop to the lens surface of the rear group closest to the image side in the state where the infinite distance object is in focus is denoted by dSt, and a sum of Bf and a distance on the optical axis from a surface, on the image side, of the first aspherical lens closest to the image side among the first aspherical lenses included in the rear group to the lens surface of the rear group closest to the image side in the state where the infinite distance object is in focus is denoted by dA1, Conditional Expressions (3-2), (4-2), (7), and (9-1) are satisfied, which are represented by

$$1.2 < TL / f < 1.6 \qquad ( 3 ‐ 2 )$$

$$2.5 < Fno / tan ω m < 4 \qquad ( 4 ‐ 2 )$$

$$0.67 < dSt / TL < 0.93 \qquad ( 7 )$$

$$0.08 < dA 1 / TL < 0.35 . \qquad ( 9 ‐ 1 )$$

### APPENDIX 34

An imaging apparatus comprising the imaging lens according to any one of Appendices 1 to 33.

What is claimed is:

1. An imaging lens consisting of, in order from an object side to an image side, a front group including one or more lenses, a stop, and a rear group including a plurality of lenses,
wherein the rear group includes at least one first aspherical lens that has a concave surface facing the image side in a paraxial region and that has, on a lens surface on the image side, an inflection point at which a convex or concave shape changes, and
in a case where a back focus of the imaging lens as an air conversion distance in a state where an infinite distance object is in focus is denoted by Bf,
a focal length of the imaging lens in the state where the infinite distance object is in focus is denoted by f, and
a maximum half angle of view in the state where the infinite distance object is in focus is denoted by ωm,
Conditional Expression (1) is satisfied, which is represented by
$$0.3 < Bf / ( f \times tan ω m ) < 1.5 , \qquad ( 1 )$$
and
in a case where a temperature coefficient of a refractive index with respect to a d line at 25° C. for a lens included in the imaging lens is denoted by (dN/dT)×10⁻⁶, and
dN/dT is in units of ° C.⁻¹,
the imaging lens includes at least one lens satisfying Conditional Expression (2) represented by
$$0 < \vert dN / dT \vert < 15. \qquad ( 2 )$$

2. The imaging lens according to claim 1,
wherein, in a case where a sum of Bf and a distance on the optical axis from a lens surface of the front group closest to the object side to a lens surface of the rear group closest to the image side in the state where the infinite distance object is in focus is denoted by TL,
Conditional Expression (3) is satisfied, which is represented by
$$1 \text{.1} < TL / f < 3.5 . \qquad ( 3 )$$

3. The imaging lens according to claim 2,
wherein Conditional Expression (3-1) is satisfied, which is represented by
$$1.2 < TL / f < 3. \qquad ( 3 ‐ 1 )$$

4. The imaging lens according to claim 1,
wherein Conditional Expression (1-1) is satisfied, which is represented by
$$0.36 < Bf / ( f \times tan ω m ) < 1.2 . \qquad ( 1 ‐ 1 )$$

5. The imaging lens according to claim 1,
wherein, in a case where an open F-number in the state where the infinite distance object is in focus is denoted by Fno,
Conditional Expression (4) is satisfied, which is represented by
$$1.6 < Fno / tan ω m < 5. \qquad ( 4 )$$

6. The imaging lens according to claim 5,
wherein Conditional Expression (4-1) is satisfied, which is represented by
$$2 < Fno / tan ω m < 3.2 . \qquad ( 4 ‐ 1 )$$

7. The imaging lens according to claim 1,
wherein, in a case where a minimum value of a distance on the optical axis from a lens surface of the front group closest to the image side to the stop is denoted by dFSt,
a sign of dFSt is positive in a case where the stop is closer to the image side than the lens surface of the front group closest to the image side, and is negative in a case where the stop is closer to the object side than the lens surface of the front group closest to the image side,
a minimum value of a distance on the optical axis from the stop to a lens surface of the rear group closest to the object side is denoted by dStR,
a sign of dStR is positive in a case where the lens surface of the rear group closest to the object side is closer to the image side than the stop, and is negative in a case where the lens surface of the rear group closest to the object side is closer to the object side than the stop, and
a sum of Bf and a distance on the optical axis from a lens surface of the front group closest to the object side to a lens surface of the rear group closest to the image side in the state where the infinite distance object is in focus is denoted by TL,
Conditional Expressions (5) and (6) are satisfied, which are represented by
$$0 < dFSt / TL < 0.8 \qquad ( 5 )$$
$$0 < dStR / TL < 0.8 . \qquad ( 6 )$$

8. The imaging lens according to claim 1,
wherein, in a case where a sum of Bf and a distance on the optical axis from the stop to a lens surface of the rear group closest to the image side in the state where the infinite distance object is in focus is denoted by dSt, and
a sum of Bf and a distance on the optical axis from a lens surface of the front group closest to the object side to the lens surface of the rear group closest to the image side in the state where the infinite distance object is in focus is denoted by TL,
Conditional Expression (7) is satisfied, which is represented by
$$0.67 < dSt / TL < 0 \text{.93} . \qquad ( 7 )$$

9. The imaging lens according to claim 1,
wherein, in a case where a paraxial curvature radius of a surface, on the object side, of a lens closest to the object side in the front group is denoted by RL1f, and
a paraxial curvature radius of a surface, on the image side, of the lens closest to the object side in the front group is denoted by RL1r,
Conditional Expression (8) is satisfied, which is represented by
$$- 3 < ( RL 1 r - RL 1 f ) / ( RL 1 r + RL 1 f ) < 0. \qquad ( 8 )$$

10. The imaging lens according to claim 1,
wherein, in a case where a sum of Bf and a distance on the optical axis from a surface, on the image side, of the first aspherical lens closest to the image side among the first aspherical lenses included in the rear group to a lens surface of the rear group closest to the image side in the state where the infinite distance object is in focus is denoted by dA1, and
a sum of Bf and a distance on the optical axis from a lens surface of the front group closest to the object side to the lens surface of the rear group closest to the image side in the state where the infinite distance object is in focus is denoted by TL,
Conditional Expression (9) is satisfied, which is represented by
$$0.02 < dA 1 / TL < 0.6 . \qquad ( 9 )$$

11. The imaging lens according to claim 10,
wherein Conditional Expression (9-1) is satisfied, which is represented by
$$0.08 < dA 1 / TL < 0.3 5. \qquad ( 9 ‐ 1 )$$

12. The imaging lens according to claim 1,
wherein the front group includes at least one lens satisfying Conditional Expression (2).

13. The imaging lens according to claim 12,
wherein a lens closest to the object side in the front group satisfies Conditional Expression (2).

14. The imaging lens according to claim 13,
wherein the rear group includes at least one lens satisfying Conditional Expression (2).

15. The imaging lens according to claim 1,
wherein, in a case where a sum of Bf and a distance on the optical axis from a lens surface of the front group closest to the object side to a lens surface of the rear group closest to the image side in the state where the infinite distance object is in focus is denoted by TL,
Conditional Expression (10) is satisfied, which is represented by
$$1.2 < TL / ( f \times tan ω m ) < 3. \qquad ( 10 )$$

16. The imaging lens according to claim 15,
wherein Conditional Expression (10-1) is satisfied, which is represented by
$$1. 7 < TL / ( f \times tan ω m ) < 2.5 . \qquad ( 10 - 1 )$$

17. The imaging lens according to claim 16,
wherein Conditional Expression (3-1) is satisfied, which is represented by
$$1.2 < TL / f < 3. \qquad ( 3 - 1 )$$

18. The imaging lens according to claim 17,
wherein, in a case where an open F-number in the state where the infinite distance object is in focus is denoted by Fno,
Conditional Expression (4-1) is satisfied, which is represented by
$$2 < Fno / tan ω m < 3.2 . \qquad ( 4 - 1 )$$

19. The imaging lens according to claim 18,
wherein Conditional Expression (1-1) is satisfied, which is represented by
$$0.36 < Bf / ( f \times tan ω m ) < 1.2 . \qquad ( 1 - 1 )$$

20. The imaging lens according to claim 19,
wherein, in a case where a paraxial curvature radius of a surface, on the object side, of a lens closest to the object side in the front group is denoted by RL1f, and
a paraxial curvature radius of a surface, on the image side, of the lens closest to the object side in the front group is denoted by RL1r,
Conditional Expression (8-1) is satisfied, which is represented by
$$- 1 < ( RL 1 r - RL 1 f ) / ( RL 1 r + RL 1 f ) < - 0 \text{.07} . \qquad ( 8 - 1 )$$

21. The imaging lens according to claim 18,
wherein, in a case where a sum of Bf and a distance on the optical axis from the stop to the lens surface of the rear group closest to the image side in the state where the infinite distance object is in focus is denoted by dSt,
Conditional Expression (7) is satisfied, which is represented by
$$0.67 < dSt / TL < 0.93 . \qquad ( 7 )$$

22. The imaging lens according to claim 21,
wherein, in a case where a sum of Bf and a distance on the optical axis from a surface, on the image side, of the first aspherical lens closest to the image side among the first aspherical lenses included in the rear group to the lens surface of the rear group closest to the image side in the state where the infinite distance object is in focus is denoted by dA1,
Conditional Expression (9-1) is satisfied, which is represented by
$$0.08 < dA 1 / TL < 0 \text{.35} . \qquad ( 9 - 1 )$$

23. The imaging lens according to claim 22,
wherein the front group includes at least one lens satisfying Conditional Expression (2).

24. The imaging lens according to claim 23,
wherein a lens closest to the object side in the front group satisfies Conditional Expression (2).

25. The imaging lens according to claim 1,
wherein, in a case where a refractive index with respect to a d line and an Abbe number based on the d line for a lens included in the imaging lens are denoted by Nd and νd, respectively,
the front group includes at least one lens satisfying Conditional Expression (11), which is represented by
$$1.6 < Nd + 0.01 \times vd < 2.6 . \qquad ( 11 )$$

26. The imaging lens according to claim 25,
wherein a lens closest to the object side in the front group satisfies Conditional Expression (11).

27. The imaging lens according to claim 1,
wherein, in a case where a focal length of a lens closest to the object side in the front group is denoted by fL1, Conditional Expression (12) is satisfied, which is represented by
$$- 1.5 < f / fL 1 < 0. \qquad ( 12 )$$

28. The imaging lens according to claim 1,
wherein, in a case where a paraxial curvature radius of a surface, on the image side, of the first aspherical lens closest to the image side among the first aspherical lenses included in the rear group is denoted by RA1c, and
a curvature radius, at a position of a maximum effective diameter, of the surface, on the image side, of the first aspherical lens closest to the image side among the first aspherical lenses included in the rear group is denoted by RA1y,
Conditional Expression (13) is satisfied, which is represented by
$$- 100 < RA 1 y / RA 1 c < 0. \qquad ( 13 )$$

29. The imaging lens according to claim 1,
wherein, in a case where a refractive index with respect to a d line and an Abbe number based on the d line for the first aspherical lens closest to the image side among the first aspherical lenses included in the rear group are denoted by NdA1 and νdA1, respectively,
Conditional Expression (14) is satisfied, which is represented by
$$1.8 < NdA 1 + 0.01 \times vdA 1 < 2.14 . \qquad ( 14 )$$

30. The imaging lens according to claim 1,
wherein the rear group includes at least one second aspherical lens that has a convex surface facing the image side in the paraxial region and that has, on the image side, a lens surface in which a refractive power at a position of a maximum effective diameter is shifted in a negative direction compared to a refractive power in the paraxial region.

31. The imaging lens according to claim 30,
wherein, in a case where a paraxial curvature radius of a surface, on the image side, of the second aspherical lens is denoted by RA2c, and
a curvature radius, at the position of the maximum effective diameter, of the surface, on the image side, of the second aspherical lens is denoted by RA2y,
all second aspherical lenses included in the rear group satisfy Conditional Expression (15) represented by
$$- 1 < RA 2 c / RA 2 y < 1. \qquad ( 15 )$$

32. The imaging lens according to claim 30,
wherein, in a case where a sum of Bf and a distance on the optical axis from a surface, on the image side, of the second aspherical lens closest to the image side among the second aspherical lenses included in the rear group to a lens surface of the rear group closest to the image side in the state where the infinite distance object is in focus is denoted by dA2, and
a sum of Bf and a distance on the optical axis from a lens surface of the front group closest to the object side to the lens surface of the rear group closest to the image side in the state where the infinite distance object is in focus is denoted by TL,
Conditional Expression (16) is satisfied, which is represented by
$$0.2 < dA 2 / TL < 0.6 . \qquad ( 16 )$$

33. The imaging lens according to claim 32,
wherein a lens that is a second from the image side in the rear group is the second aspherical lens closest to the image side among the second aspherical lenses included in the rear group.

34. The imaging lens according to claim 33,
wherein the lens that is the second from the image side in the rear group has, on a lens surface on the image side, the inflection point at which the convex or concave shape changes.

35. The imaging lens according to claim 1,
wherein a lens closest to the image side in the rear group is the first aspherical lens.

36. The imaging lens according to claim 35,
wherein the lens closest to the image side in the rear group has a convex surface facing the object side in the paraxial region and has, on a lens surface on the object side, the inflection point at which the convex or concave shape changes.

37. The imaging lens according to claim 1,
wherein the rear group includes two first aspherical lenses.

38. The imaging lens according to claim 30,
wherein the rear group includes two second aspherical lenses.

39. The imaging lens according to claim 1,
wherein the imaging lens includes at least one cemented lens.

40. The imaging lens according to claim 1,
wherein a lens closest to the object side in the front group satisfies Conditional Expression (2), and
in a case where a sum of Bf and a distance on the optical axis from a lens surface of the front group closest to the object side to a lens surface of the rear group closest to the image side in the state where the infinite distance object is in focus is denoted by TL,
an open F-number in the state where the infinite distance object is in focus is denoted by Fno,
a sum of Bf and a distance on the optical axis from the stop to the lens surface of the rear group closest to the image side in the state where the infinite distance object is in focus is denoted by dSt, and
a sum of Bf and a distance on the optical axis from a surface, on the image side, of the first aspherical lens closest to the image side among the first aspherical lenses included in the rear group to the lens surface of the rear group closest to the image side in the state where the infinite distance object is in focus is denoted by dA1,
Conditional Expressions (3-2), (4-2), (7), and (9-1) are satisfied, which are represented by
$$1.2 < TL / f < 1.6 \qquad ( 3 - 2 )$$
$$2.5 < Fno / tan ω m < 4 \qquad ( 4 - 2 )$$
$$0.67 < dSt / TL < 0.93 \qquad ( 7 )$$
$$0.08 < dA 1 / TL < 0 \text{.35} . \qquad ( 9 - 1 )$$

41. An imaging apparatus comprising:
the imaging lens according to claim 1.
